(19) United States
(12) Patent Application Publication
(10) Pub. No.: US 2004/0038161 A1
(43) Pub. Date: Feb. 26, 2004

(54) Photothermographic material

(76) Inventor: Tomoyuki Ohzeki, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/635,486

(22) Filed: Aug. 7, 2003

(30) Foreign Application Priority Data
Aug. 12, 2002 (JP) 2002-234788
Nov. 18, 2002 (JP) 2002-333720
Jan. 29, 2003 (JP) 2003-19779

(51) Int. Cl. G03C 1/498; G03C 1/34; G03C 1/295

(52) U.S. Cl. 430/619; 430/264; 430/531; 430/567; 430/600; 430/603; 430/607; 430/611; 430/613; 430/620

(57) ABSTRACT

The present invention provides the photothermographic material including a photosensitive silver halide, a reducing agent for reducing silver ions, a binder and a non-photosensitive organic silver salt, wherein the photosensitive silver halide has a silver iodide content ranging from 40 mol % to 100 mol %, and has a particle size ranging from 5 nm to 80 nm, and wherein the non-photosensitive organic silver salt is prepared in the presence of the photosensitive silver halide which has been preformed, such that the non-photosensitive organic silver salt includes the photosensitive silver halide.

### CROSS-REFERENCE TO RELATED APPLICATION

This application claims priority under 35 USC 119 from Japanese Patent Application Nos. 2002-234788, 2002-333720, and 2003-19779, the disclosure of which is incorporated by reference herein.

### BACKGROUND OF THE INVENTION

1. Field of the Invention

The present invention relates to a photosensitive thermally developable material (hereinafter referred to as “photothermographic material”), and more specifically relates to a photothermographic material that exhibits high developing activity, high sensitivity and good image storability, with less fogging at non-image areas.

2. Description of the Related Art

In recent years, in the fields of films for medical diagnosis and photographic films for plate-making, it has been strongly desired, from the standpoints of environmental protection and space-saving, to reduce the volume of processing waste fluids. Thus, there is a need for technologies relating to photothermographic materials, as films for medical diagnosis or photographic films for plate-making which can be efficiently exposed by a laser image setter or a laser imager to form clear black images having high resolution and sharpness. These photothermographic materials are advantageous in providing customers with a thermal processing system that does not need liquid-type processing solutions, and which is simple and not harmful to the environment.

There is also a need for the same technologies in the field of ordinary image forming materials. In particular in the field of medical diagnosis, which requires detail depiction, high quality images excellent in sharpness and graininess are needed and blue black image tone is desired in view of diagnosing readiness. Currently, various types of hard copy systems using pigments and dyes, for example, ink-jet printers and electrophotographic systems are widely used as the ordinary imaging system. However, satisfactory systems for outputting images for use in medical diagnosis have never been developed.

On the other hand, thermally developable image forming systems using organic silver salts are described, for example, in U.S. Pat. Nos. 3,152,904 and 3,457,075, and in “Thermally Processed Silver Systems (Imaging Processes and Materials)” written by D. Klosterboer, Neblette, 8th Ed., edited by J. Sturge, V. Walworth & A. Shepp, Chap. 9, p. 279, 1989.

In general, photothermographic materials have a photosensitive layer (image-forming layer) produced by dispersing a catalytically active amount of a photocatalyst (e.g., silver halide), a reducing agent, a reducible silver salt (e.g., organic silver salt), and optionally a toning agent for adjusting silver color tone in a binder matrix.

Photothermographic materials are, after having been imagewise exposed, heated to an elevated temperature (for example, at 80° C. or higher) to form black silver images through redox reaction between a reducible silver salt (serving as an oxidizing agent) and a reducing agent. The redox reaction is accelerated by catalytic action of latent images which have been formed on silver halides exposed. Therefore, the black silver images are formed in the exposed area. This technique is disclosed in many references, such as U.S. Pat. No. 2,910,377 and Japanese Patent Application Publication (JP-B) No.43-4924.

Since the photothermographic material contains all of the chemical substances necessary for development, there has been a problem of “increased fogging” appearing in exposed areas of the photothermographic material during storage after its production until its use, or another problem associated with “print-out” in which unexposed areas gradually turn black after undergoning thermal development and are left exposed under weak illumination such as room light.

In order to alleviate the above-mentioned print-out problem, use of a halogen precursor compound or other developing stopper has been proposed. However, satisfactory effects cannot be obtained since use of these substances causes disturbances to suppress image formation itself, thereby leading to lowered sensitivity.

Particularly, when a coating method utilizing an organic solvent-based solution that contains polyvinyl butyral as a binder has been employed, there has arisen a problem of largely varied sensitivity generated during storage, as compared to the case where a coating method utilizing an aqueous solvent-based solution that contains a polymer latex as the binder has been employed. From a comparison between these two methods, it was presumed that a residual organic solvent aggravated the unstable sensitivity. Under such circumstances, techniques to produce a photothermographic material exhibiting high sensitization and good storability, especially when an organic solvent is used in a coating solution to prepare the material, are desired.

Since the aforementioned problems associated with print-out or fogging are critical issues when the photothermographic material is used, there exists a keen desire to solve those problems.

### SUMMARY OF THE INVENTION

The present invention was accomplished to solve the above-mentioned problems in the prior art. Therefore, an object of the invention is to provide a photothermographic material which exhibits high sensitivity, good print-out property, with less fogging at non-image areas.

The invention is directed to a photothermographic material which comprises a photosensitive silver halide, a reducing agent for reducing silver ions, a binder and a non-photosensitive organic silver salt, wherein the photosensitive silver halide has a silver iodide content ranging from 40 mol % to 100 mol %, and has a particle size ranging from 5 nm to 80 nm, and wherein the non-photosensitive organic silver salt is prepared in the presence of the photosensitive silver halide which has been preformed, such that the non-photosensitive organic silver salt includes the photosensitive silver halide.

### DETAILED DESCRIPTION OF THE INVENTION

According to the present invention, there is provided a photothermographic material which comprises a photosensitive silver halide, a reducing agent for reducing silver ions, a binder and a non-photosensitive organic silver salt, wherein the photosensitive silver halide has a silver iodide content ranging from 40 mol % to 100 mol %, and has a particle size ranging from 5 nm to 80 nm, and wherein the non-photosensitive organic silver salt is prepared in the presence of the photosensitive silver halide which has been preformed, such that the non-photosensitive organic silver salt includes the photosensitive silver halide.

It is preferred that in the photothermographic material of the invention, the non-photosensitive organic silver salt including the photosensitive silver halide is produced by adding an alkali metal salt to an organic acid to prepare an alkali metal soap of the organic acid, mixing the thus prepared alkali metal soap with the photosensitive silver halide, and thereafter admixing therewith a water-soluble silver salt.

It is preferred that in the photothermographic material of the invention, the non-photosensitive organic silver salt has a silver behenate content ranging from 40 mol % to 70 mol %.

It is preferred that in the photothermographic material of the invention, the binder is polyvinyl butyral.

It is preferred that in the photothermographic material of the invention, a solvent for preparing a coating solution is methyl ethyl ketone, and a residual amount of the methyl ethyl ketone ranges from 0.1 mg/m² to 150 mg/m².

It is preferred that in the photothermographic material of the invention, a particle size of the photosensitive silver halide is from 5 nm to 50 nm.

In addition, the photothermographic material of the invention preferably contains at least one compound selected from the compounds of the following types 1 to 5:

(Type 1)

a compound that can be one-electron oxidized to produce a one-electron oxidation product, which releases two or more electrons through a bond cleaving reaction;

(Type 2)

a compound that has two or more adsorptive groups to the silver halide in the same molecular structure and can be one-electron oxidized to produce a one-electron oxidation product which further releases one electron through a bond cleaving reaction;

(Type 3)

a compound that can be one-electron oxidized to produce a one-electron oxidation product, which releases additional one or more electrons after a bond forming process;

(Type 4)

a compound that can be one-electron oxidized to produce a one-electron oxidation product, which releases additional one or more electrons after an intra-molecular ring opening reaction; and

(Type 5)

a compound represented by X—Y, in which X represents a reducing group and Y represents a leaving group, wherein the reducing group X can be one-electron oxidized to produce a one-electron oxidation product, which leaves Y to produce X radical through an X—Y bond cleaving reaction, followed by releasing one more electrons from the X radical.

It is preferred that the photothermographic material of the invention contains a compound represented by formula (H):

Q-(Y)n-C(Z₁)(Z₂)X Formula (H)

wherein Q represents an alkyl group, an aryl group or a heterocyclic group; Y represents a bivalent linking group; n represents 0 or 1; Z₁ and Z₂ each represent a halogen atom; and X represents a hydrogen atom or an electron attractive group.

It is preferred that in the photothermographic material of the invention, the reducing agent is a bisphenol-type reducing agent.

It is preferred that the photothermographic material of the invention contains a compound represented by formula (J):

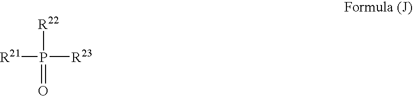

wherein R²¹ to R²³ each independently represent an alkyl group, an aryl group, an alkoxy group, an aryloxy group, an amino group or a heterocyclic group.

It is preferred that the photothermographic material of the invention contains a development accelerator.

It is preferred that in the photothermographic material of the invention, the development accelerator is a hydrazine-based or naphthol-based compound.

It is preferred that in the photothermographic material of the invention, the photosensitive silver halide has a silver iodide content ranging from 80 mol % to 100 mol %.

It is preferred that in the photothermographic material of the invention, the photosensitive silver halide has a silver iodide content ranging from 85 mol % to 100 mol %.

It is preferred that in the photothermographic material of the invention, the photosensitive silver halide has a silver iodide content ranging from 90 mol % to 100 mol %.

Hereinafter, the present invention will be described in detail.

1. Photosensitive Silver Halide

The invention is characterized in that the photosensitive silver halide has a silver iodide content ranging from 40 mol % to 100 mol %, and that the silver halide is mixed in the step of preparing the non-photosensitive organic silver salt. Further, the invention is characterized in that the photosensitive silver halide has a particle size ranging from 5 nm to 80 nm. This photosensitive silver halide is explained in more detail below.

1) Halogen Composition

It is important that the photosensitive silver halide used in the invention has a composition of a high silver iodide content ranging from 40 mol % to 100 mol %. The remaining portion is not particularly limited, in sofar as it contains the silver salts selected from silver chloride, silver bromide or an organic silver salt such as silver thiocyanate, silver phosphate or the like. Silver bromide or silver chloride is particularly preferred. By using the silver halide having such a high silver iodide content, a preferable photothermographic material may be designed from the standpoints of good image storability after the development processing, in particular, suppressed increase in fogging caused by light irradiation.

Moreover, the silver iodide content is preferably 80 mol % or higher and 100 mol % or less, still preferably 85 mol % or higher and 100 mol % or less, and particularly preferably 90 mol % or higher and 100 mol % or less, from the standpoint of image storability against light irradiation after processing.

The halogen composition of the photosensitive silver halide grains for use in the present invention is not specifically limited, and there may be used silver chloride, silver chlorobromide, silver bromide, silver iodobromide, silver iodochlorobromide. Regarding the halide distribution in individual grains, the halide may be uniformly distributed throughout the grain, or may stepwise distributed, or may continuously distributed. Silver halide grains having a core/shell structure are preferably used. Preferably, the core/shell structure of the grains has 2 to 5 layers, more preferably 2 to 4 layers. Also a technique to epitaxially localize silver bromide on the surface of silver chloride or silver chlorobromide grains is preferably employed.

2) Process for Forming Particles

Methods of forming photosensitive silver halides are well known in the art and may be employed in the present invention, for example, as described in Research Disclosure No. 17029 (June 1978), and U.S. Pat. No. 3,700,458. More specifically, a silver source-supplying compound and a halogen source-supplying compound are added to a solution of gelatin or any other polymer to prepare a photosensitive silver halide, followed by admixing with an organic silver salt.

It is particularly preferred that particles of the photosensitive silver halide according to the invention are formed in the absence of a non-photosensitive organic silver salt and subjected to chemical sensitization.

3) Mixing of Silver Halide and Organixc Silver Salt

According to the invention, it is important that the silver halide is mixes in a step of preparing the non-photosensitive organic silver salt. The organic silver salt is produced by adding an alkali metal salt (e.g., sodium hydroxide, potassium hydroxide or the like) to an organic acid so that at least a part of the organic acid is converted to an alkali metal soap, followed by mixing with a water-soluble silver salt (e.g., silver nitrate). And, the silver halide may be mixed in any of the above steps. Examples of the major process for mixing include 3 steps of: A) a silver halide is previously added to an organic acid, and an alkali metal salt is added thereto followed by mixing with a water-soluble silver salt; B) an alkali metal soap of an organic acid is mixed with a silver halide, and thereafter a water-soluble silver salt is mixed therewith; C) a part of an alkali metal soap is first converted to a silver salt and a silver halide is mixed therewith, followed by the conversion to a silver salt of the remaining part; and D) a silver halide is mixed in a step following the completion of preparing the organic silver salt. A preferable process is B) or C), and particularly preferable process is B).

In general, examples of the process for mixing the silver halide with the organic silver salt include the following processes.

(1) a process in which a photosensitive silver halide and an organic silver salt, which were separately prepared, are mixed using a high-speed stirrer, a ball mill, a sand mill, a colloid mill, a vibrating mill, a homogenizer or the like. This process involved problems of long time period of development, and in addition, difficulty in forming images due to a low development activity.

(2) a process in which a compound for supplying silver and a compound for supplying halogen are added during the preparation of the organic silver salt so that the photosensitive silver halide is included in the organic silver salt.

This process is a so-called conversion process. In this process, the photosensitive silver halide is not previously produced, as a result, a treatment such as chemical sensitization cannot be performed on the silver halide. Accordingly, it is difficult to achieve high sensitivity.

Thus, according to the invention, there is provided a process in which the prepared photosensitive silver halide is mixed at any time point during the preparation of the organic silver salt. If the organic silver salt including the silver halide prepared by this process is used, the developing activity is not deteriorated and satisfactory sensitivity is also achieved.

Any process for the production may be employed insofar as the silver halide, which has been prepared in advance, is mixed in the step of preparing the non-photosensitive organic silver salt. In particular, the aforementioned properties become favorable when it is produced at the temperature of 20 to 70° C., preferably 30 to 65° C., and more preferably 35 to 60° C., with the time period of stirring for the mixing being 1 to 30 min, preferably 1 to 20 min, and more preferably 3 to 8 min.

4) Particle Size

A particle size is particularly important for the silver halide having a high silver iodide for use in the invention. When the size of the silver halide is too large, the coating amount of the silver halide required for attaining necessary maximum density may be elevated. The present inventor found that when the coating amount of the silver halide having a high silver iodide content which is preferably used in the invention was large, the development was markedly suppressed leading to lowered sensitization, accompanied by deterioration of density stability depending on the development time, which is not preferred. Thus, the particle size which is greater than the specified value did not result in maximum density within a predetermined time period of the development. On the contrary, it was found that when the amount to be added is limited, sufficient development property could be achieved even though silver iodide was used.

When the high silver iodide content is used in such a manner, it is necessary that the size of silver halide particles be small enough as compared to a conventional silver bromide or silver iodobromide having a low content of iodide in order to attain a sufficient maximum optical density. A preferable particle size of silver halide is 5 nm or greater and 80 nm or less, and it is more preferred to be 5 nm or greater and 50 nm or less. Particularly preferably, the particle size is 5 nm or greater and 45 nm or less. The particle size used herein refers to a mean diameter of a converted circle image having the same area with the projected area which was obtained through observation with an electron microscope.

5) Coating Amount

The coating amount of such a silver halide is 0.5 mol % or greater and 15 mol % or less, preferably 0.5 mol % or greater and 12 mol % or less, and more preferably 10 mol % or less, per mol of silver in the non-photosensitive organic silver salt described below. It is more preferred that the coating amount be 1 mol % or greater and 9 mol % or less, and particularly preferably 1 mol % or greater and 7 mol % or less. Selection of this amount is extremely important in order to constrain remarkable suppression of development resulting from the silver halide having a high silver iodide content, which was found by the present inventor.

6) Shape of Particle

Silver halide grains may have various shapes including, for example, cubic grains, octahedral grains, tetradecahedral grains, dodecahedral grains, tabular grains, spherical grains, rod-like grains, and potato-like grains. Cubic silver halide grains are especially preferred for use in the present invention. Although the silver halide having a high silver iodide content according to the invention can have a complicated form, examples of preferable form include conjugated particles as illustrated in R. L. Jenkins et al., J. of Phot. Sci. Vol. 28 (1980),.pp164, FIG. 1. Also preferred are roundish silver halide grains with their corners rounded. The surface index (Miller index) of the outer surface of the photosensitive silver halide grains for use in the present invention is not specifically limited, but it is preferred that the proportion of {100} plane, which ensures higher spectral sensitization when it has adsorbed a color-sensitizing dye, in the outer surface is large. Preferably, the proportion of {100} plane is at least 50%, more preferably at least 65%, and even more preferably at least 80%. The Miller index expressed by the proportion of {100} plane can be obtained according to the method described in J. Imaging Sci., written by T. Tani, 29, 165 (1985), based on the adsorption dependency of {111} plane and {100} plane for sensitizing dyes.

7) Heavy Metal

The photosensitive silver halide grains for use in the present invention may contain a metal or metal complex of Groups VIII to X of the Periodic Table (including Groups I to XVIII). As the metal or the central metal of metal complex of Groups VIII to X, preferably used is rhodium, ruthenium or iridium. In the present invention, one metal complex may be used alone, or two or more metal complexes of the same species or different species of metals may be used in combination. The metal or metal complex content of the grains preferably falls between 1×10⁻⁹ mols and 1×10⁻³ mols per mol of silver. Such heavy metals and metal complexes, and methods of adding them to silver halide grains are described in, for example, Japanese Patent Application Laid-Open (JPA) No.7-225449, JP-A No.11-65021, paragraphs [0018] to [0024], and JP-A No. 11-119374, paragraphs [0227] to [0240].

Silver halide grains having a hexacyano-metal complex in their outermost surface are preferred for use in the present invention. The hexacyano-metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano-Fe complexes are preferably used in the present invention.

As hexacyano-metal complexes exist in the form of ions in their aqueous solutions, their counter cations are of no importance. However, it is preferable to use as the counter cation any of alkali metal ions such as sodium ion, potassium ion, rubidium ion, cesium ion and lithium ion; ammonium ion, and alkylammonium ion (e.g., tetramethylammonium ion, tetraethylammonium ion, tetrapropylammonium ion and tetra(n-butyl)ammonium ion) due to good water miscibility and easy handling of silver halide emulsion sedimentation.

The hexacyano-metal complex may be added in the form of a solution thereof in water or in a mixed solvent of water and an organic solvent miscible with water (for example, alcohols, ethers, glycols, ketones, esters, amides), or in the form of a mixture with gelatin.

The addition amount of the hexacyano-metal complex is 1×10⁻⁵ mol or greater and 1×10⁻² mol or less, and more preferably 1×10⁻⁴ mol or greater and 1×10⁻³ mol or less, per mol of silver.

In order to make the hexacyano-metal complex exist in the outermost surface of silver halide grains, addition of the complex is conducted in the charging step, i.e., after an aqueous silver nitrate solution to form silver halide grains has been added to a reaction system but before the grains having formed are subjected to chemical sensitization such as chalcogen sensitization with sulfur, selenium or tellurium or noble metal sensitization with gold or the like, or alternatively the complex is directly added to the grains in the step of rinsing, dispersing or prior to conducting chemical sensitization. In order to prevent the silver halide grains from excessively growing, it is desirable to add the hexacyano-metal complex to the grains immediately after they are formed, and preferably before the charging step is completed.

Addition of the hexacyano-metal complex to silver halide grains may be started after 96% by mass of the total of silver nitrate for forming the grains has been added to a reaction system, but is preferably started after 98% by mass of silver nitride has been added thereto, more preferably after 99% by mass thereof has been added thereto.

The hexacyano-metal complex, when added to silver halide grains after an aqueous solution of silver nitrate has been added to the reaction system but just before the grains are completely formed, can be adsorbed by the grains formed to exist on the outermost surface thereof. Most of the complex thus added can form hardly-soluble salts with the silver ions present on the surface of the grains. Since the silver salt of hexacyano-iron(II) is more hardly soluble than AgI, fine grains are prevented from re-dissolving. Consequently, fine silver halide grains having a small grain size can be produced.

The metal atoms that may be included to the silver halide grains for use in the present invention, as well as the methods of desalting or chemical sensitization of the silver halide emulsions are described, for example, in JP-A No. 1 1-84574, paragraphs [0046] to [0050], JP-A No.11-65021, paragraphs [0025] to [0031], and JP-A No.11-119374, paragraphs [0242] to [0250].

8) Gelatin

As gelatin included in the photosensitive silver halide emulsion used in the invention, any of various gelatin can be used. To use low molecular weight gelatin having a molecular weight of 500-60,000 is preferred in order to maintain good dispersion state of the photosensitive silver halide emulsion in a coating solution containing the organic silver salt. The molecular weight herein refers to a number average molecular weight derived from conversion of styrene on a gel permeation chromatography (GPC). The low molecular weight gelatin may be used when the particles are formed, or when dispersion is effected after the desalting treatment. However, it is preferably used when dispersion is effected after the desalting treatment.

9) Chemical Sensitization

The photosensitive silver halide used in the invention may be not yet chemically sensitized, however, it is preferably chemically sensitized by at least one method of: a chalcogen sensitization method; a gold sensitization method; and a reducing sensitization method. Examples of the chalcogen sensitization method include sulfur sensitization method, selenium sensitization method and tellurium sensitization method.

For the sulfur sensitization, an unstable sulfur compound is used, and in particular, an unstable sulfur compound described in P. Grafkides, Chimie et Physique Photographique (published by Paul Momtel, 1987, the 5th edition), Research Disclosure magazine, Vol. 307, No. 307105 or the like can be used.

Specifically, known sulfur compounds such as thiosulfate (e.g., hypo), thioureas (e.g., diphenylthiourea, triethylthiourea, N-ethyl-N⁻-(4-methyl-2-thiazolyl)thiourea, carboxymethyltrimethylthiourea), thioamides (e.g., thioacetamide), rhodanines (e.g., diethylrhodanine, 5-benzylidene-N-ethylrhodanine), phosphinesulfides (e.g., trimethylpho sphinesulfide), thiohydantoins, 4-oxo-oxazolidine-2-tions, disulfides or polysulfides (e.g., dimorpholinedisulfide, cystine, hexathiocane-thione), polythionate and sulfur in an element form, active gelatin or the like may be also used. In particular, thiosulfate, thiureas and rhodanines are preferred.

For the selenium sensitization, an unstable selenium compound is used. Examples of the selenium compound which ca be used are described in JP-B Nos. 43-13489 and 44-15748, JP-A Nos. 4-25832, 4-109340, 4-271341, 5-40324 and 5-11385, Japanese Patent Application Nos. 4-202415, 4-330495, 4-333030, 5-4203, 5-4204, 5-106977, 5-236538, 5-241642 and 5-286916, and the like.

Specifically, colloidal metal selenium, selenoureas (e.g., N,N-dimethylselenourea, trifluoromethylcarbonyl-trimethylselenourea, acetyl-trimethylselenourea), selenoamides (e.g., selenoamide, N,N-diethylphenylselenoamide), phosphineselenides (e.g., triphenylpho sphineselenide, pentafluorophenyltriphenylphosphineselenide), selenophosphates (e.g., tri-ptolylselenophosphate, tri-n-butylselenophosphate), selenoketones (e.g., selenobenzophenone), isoselenocyanates, selenocarboxylic acids, selenoesters, diacylselenides or the like may be used. Furthermore, unstable selenium compounds, for example, selenious acid, selenocyanate, selenazols, selenides or the like which are described in JP-B Nos. 46-4553, 52-34492 and the like can also be used. In particular, phosphineselenides, selenoureas, and selenocyanate are preferred.

For the tellurium sensitization, an unstable tellurium compound is used. Examples of the tellurium compound which can be used are described in JP-A Nos. 4-224595, 4-271341, 4-333043, 5-303157, 6-27573,6-175258, 6-180478, 6-208186, 6-208184, 6-317867, 7-140579, 7-301879, 7-301880 and the like.

Specifically, phosphinetellurides (e.g., butyl-diisopropylphosphinetelluride, tributylphosphinetelluride, tributoxyphosphinetelluride, ethoxy-diphenylphosphinetelluride), diacyl(di)telluride s (e.g., bis(diphenylcarbamoyl)ditelluride, bis(N-phenyl-N-methylcarbamoyl)ditelluride, bis(N-phenyl-N-methylcarbamoyl)telluride, bis(N-phenyl-N-benzylcarbamoyl)telluride, bis(ethoxycarbonyl) telluride), telluroureas (e.g., N,N′-dimethylethylenetellurourea and N,N′-diphenylethylenetellurourea), telluroamides, telluroesters or the like may be used. In particular, diacyl(di)tellurides and phosphinetellurides are preferred, and particularly, compounds described in JP-A No. 11-65021, paragraph 0030, and compounds represented by the general formulae (II), (III) and (IV) in JP-A No. 5-313284 are more preferred.

Particularly, among the chalcogen sensitization in the invention, selenium sensitization and tellurium sensitization are preferred, and in particular, tellurium sensitization is preferred.

For the gold sensitization, a gold sensitizer described in P. Grafkides, Chimie et Physique Photographique (published by Paul Momtel, 1987, the 5th edition), and Research Disclosure magazine, Vol. 307, No.307105 or the like can be used. Specifically, chloroauric acid, potassium chloroaurate, potassium aurithiocyanate, gold sulfide or gold selenide may be used, and in addition thereto, gold compounds described in U.S. Pat. Nos. 2,642,361, 5,049,484, 5,049,485, 5,169,751 and 5,252,455, Belgian Patent No. 691857 and the like can be also used. Further, noble metal salts such as of platinum, palladium or iridium other than gold which are described in P. Grafkides, Chimie et Physique Photographique (published by Paul Momtel, 1987, the 5th edition), and Research Disclosure magazine, Vol. 307, No. 307105 can be also used.

Gold sensitization can be employed alone, however, it is preferably employed in combination with the chalcogen sensitization described above. Specifically, gold sulfur sensitization, gold selenium sensitization, gold tellurium sensitization, gold sulfur selenium sensitization, gold sulfur tellurium sensitization, gold selenium tellurium sensitization or gold sulfur selenium tellurium sensitization may be employed.

According to the invention, the chemical sensitization can be performed at any time as long as it is after the formation of the particles and prior to the coating, and possible timing may be after the desaltation and: (1) before the spectral sensitization; (2) simultaneously with the spectral sensitization; (3) after the spectral sensitization; (4) just before the coating, and the like.

The amount of chalcogen sensitizer used in the invention varies depending on the silver halide particles, conditions for chemical aging and the like which are employed, however, approximately 10⁻⁸ to 10⁻¹ mol, and preferably 10⁻⁷ to 10⁻² mol per mol of silver halide may be used.

Although the amount of the gold sensitizer used in the invention similarly varies depending on various conditions, it is 10⁻⁷ to 10⁻² mol, and more preferably 10⁻⁶ to 5×10⁻³ mol per mol of silver halide as an indication. The environmental condition for the chemical sensitization of this emulsion may be selected from any condition, which condition may be: the pAg of 8 or less, preferably 7.0 or less, more preferably 6.5 or less, and particularly 6.0 or less, and the pAg of 1.5 or greater, preferably 2.0 or greater, and particularly preferably 2.5 or greater; the pH of 3 to 10, and preferably 4 to 9; and the temperature of approximately 20 to 95° C., and preferably 25 to 80° C.

In the invention, reduction sensitization can be further used in combination, in addition to the chalcogen sensitization and gold sensitization. In particular, a combined use with the chalcogen sensitization is preferred.

Specific examples of the compound preferably for use in the reduction sensitization process include ascorbic acid, thiourea dioxide and dimethylamineborane, and in addition, stannous chloride, aminoiminomethanesulfinic acid, hydrazine derivative, borane compound, silane compound, polyamine compound or the like may be preferably used. The addition of the reduction sensitizer may be performed at any process during the manufacturing step of the photosensitive emulsion starting from the crystal growth until the preparation step just prior to the coating. In addition, it is also preferred that the reduction sensitization is performed by aging while maintaining the emulsion to give the pH of 8 or greater, or the pAg of 4 or less. Alternatively, it is also preferred that the reduction sensitization is performed by introducing a single addition part of the silver ion during formation of the particles.

Although the amount of the reduction sensitizer to be added similarly varies depending on various conditions, it may be 10⁻⁷ to 10⁻¹ mol, and more preferably 10⁻⁶ to 5×10⁻² mol per 1 mol of silver halide as an indication.

To the silver halide emulsion used in the invention may be added a thiosulfinic acid compound by a method shown in EP-A No. 293,917.

The photosensitive silver halide particle in the invention may be chemically unsensitized, however, it is preferably chemically sensitized by at least one process of gold sensitization and chalcogen sensitization, in light of designing of a highly sensitive photothermographic material.

10) Compound Which can Additionally Release One Electron or More Electrons by Subsequent Reaction of One-Electron Oxidized Form

The photothermographic material of the invention preferably contains a compound which can additionally release one electron or more electrons by subsequent reaction of one-electron oxidized form produced by one-electron oxidation.

The compound which can additionally release one electron or more electrons by subsequent reaction of one-electron oxidized form produced by one-electron oxidation may be a compound selected from the compounds of the following types 1 to 5.

(Type 1): a compound that can be one-electron oxidized to produce a one-electron oxidation product, which releases two or more electrons through a subsequent bond cleaving reaction;

(Type 2) : a compound that has two or more adsorptive groups to the silver halide in the same molecular structure and can be one-electron oxidized to produce a one-electron oxidation product which further releases one electron through a subsequent bond cleaving reaction;

(Type 3) : a compound that can be one-electron oxidized to produce a one-electron oxidation product, which releases additional one or more electrons after a subsequent bond forming process;

(Type 4) : a compound that can be one-electron oxidized to produce a one-electron oxidation product, which releases additional one or more electrons after a subsequent intra-molecular ring opening reaction; and

(Type 5) : a compound represented by X—Y, in which X represents a reducing group and Y represents a leaving group, wherein the reducing group X can be one-electron oxidized to produce a one-electron oxidation product, which leaves Y to produce X radical through a subsequent X—Y bond cleaving reaction, followed by releasing one more electrons from the X radical;

Among the compounds of type 1 and types 3 to 5, preferred may be “a compound having an adsorptive group to a silver halide within the molecule”, or “a compound having a moiety of a spectral sensitizing dye within the molecule”.

More preferably, the compound is “a compound having an adsorptive group to a silver halide within the molecule”.

Compounds of types 1 to 5 are explained in more detail below.

In the compound of type 1, “a bond cleaving reaction” specifically means the cleavage of the binding between each element of: carbon-carbon, carbon-silicon, carbon-hydrogen, carbon-boron, carbon-tin, or carbon-germanium. In addition, the cleavage of a carbon-hydrogen binding may be accompanied therewith.

The type 1 compound is a compound which is one-electron oxidized to produce a one-electron oxidation product, which releases two or more electrons (preferably, three or more electrons) through a subsequent bond cleaving reaction. In other words, this is a compound which can be further oxidized by two or more electrons (preferably, three or more electrons).

Among the compounds of type 1, preferable compounds are represented by formula (A), formula (B), formula (1), formula (2) or formula (3).

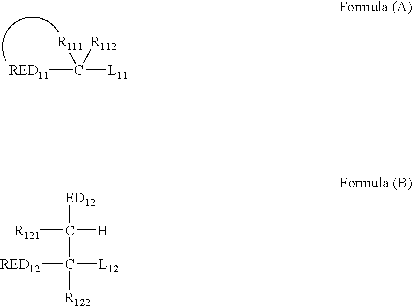

In formula (A), RED₁₁ represents a reducing group which can be oxidized at one electron, and L₁₁ represents a leaving group.

R₁₁₂ represents a hydrogen atom or a substituent.

R₁₁₁ represents a non-metal atomic group which can form a specified 5-membered or 6-membered cyclic structure together with the carbon atom (C) and RED₁₁.

The specified 5-membered or 6-membered cyclic structure herein means a cyclic structure corresponding to tetrahydro form, hexahydro form, or octahydro form having a 5-membered or 6-membered aromatic ring (including aromatic heterocycle).

In formula (B), RED₁₂ represents a reducing group which can be oxidized at one electron, and L₁₂ represents a leaving group.

R₁₂₁ and R₁₂₂ each represent a hydrogen atom or a substituent. ED₁₂ represents an electron-donating group.

In formula (B), R₁₂, and RED₁₂, R₁₂, and R₁₂₂, or ED₁₂ and RED₁₂ may form a cyclic structure through binding, respectively.

These compounds are those which can release additional two or more electrons, preferably 3 or more electrons, through spontaneous leaving of L₁₁ or L₁₂ by the reaction of cleavage of binding, in other words, through cleavage of the C (carbon atom)-L₁₁ binding or of the C (carbon atom)-L₁₂ binding, after the reducing group represented by RED₁₁ or RED₁₂ in formula (A) or formula (B) was oxidized at one electron.

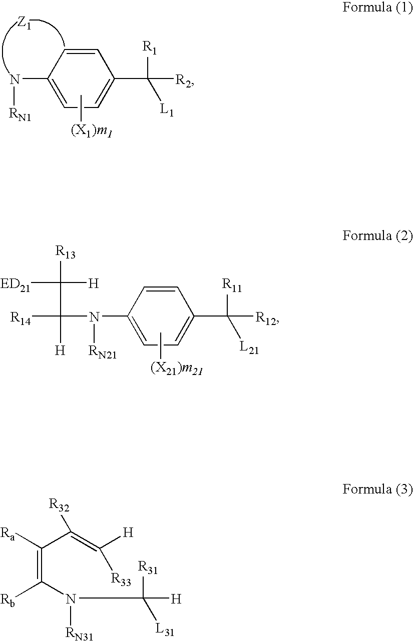

In formula (1), Z, represents an atomic group which can form a 6-membered ring together with a nitrogen atom and two carbon atoms of a benzene ring; R₁, R₂ and R_{N1} each represent a hydrogen atom or a substituent; X₁ represents a substituent which can be substituted with a benzene ring; m₁ represents an integer of 0 to 3; and L₁ represents a leaving group.

In formula (2), ED₂₁ represents an electron-donating group, R₁₁, R₁₂, R_{N21}, R₁₃ and R₁₄ each represent a hydrogen atom or a substituent; X₂₁ represents a substituent which can be substituted with a benzene ring; m₂₁ represents an integer of 0 to 3; and L₂₁ represents a leaving group.

R_{N21}, R₁₃, R₁₄, X₂₁ and ED₂₁ may bind with each other to form a cyclic structure.

In formula (3), R₃₂, R₃₃, R₃₁, R_{N31}, Rₐ and R_{b} each represent a hydrogen atom or a substituent; and L₃₁ represents a leaving group.

Provided, however that when R_{N31} represents a group other than an aryl group, Rₐ and R_{b} bind with each other to form an aromatic ring.

These compounds are those which can release additional two or more electrons, preferably 3 or more electrons, through spontaneous desorption of L₁, L₂₁ or L₃₁ by the reaction of cleavage of binding, in other words, through cleavage of the C (carbon atom)-L₁ binding, of the C (carbon atom)-L₂₁ binding or of the C (carbon atom)-L₃₁ binding, after being oxidized at one electron.

The compounds represented by formula (A) are first explained in detail below.

The reducing group which can be oxidized at one electron represented by RED₁₁ in formula (A) is a group which can form a specified ring through binding with R₁₁₁ described below, and specific examples thereof include bivalent groups which are originated from the following monovalent groups through removing one hydrogen atom at a site that is suitable for the ring formation.

Examples of such a reducing group include an alkylamino group, an arylamino group (anilino group, naphthylamino group and the like), a heterocyclic amino group (benzthiazolylamino group, pyrrolylamino group and the like), an alkylthio group, an arylthio group (phenylthio group and the like), a heterocyclic thio group, an alkoxy group, an aryloxy group (phenoxy group and the like), a heterocyclic oxy group, an aryl group (phenyl group, naphthyl group, anthranil group and the like), an aromatic or nonaromatic heterocyclic group (a heterocycle which is a 5-membered through 7-membered monocyclic or condensed ring including at least one hetero atom among a nitrogen atom, a sulfur atom, an oxygen atom and a selenium atom, and specific examples thereof include for example, a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzoimidazole ring, a benzoimidazoline ring, a benzooxazoline ring, a methylenedioxyphenyl ring and the like) (hereinafter, RED₁₁ is expediently described as a monovalent group). These may have a substituent.

Examples of the substituent include for example, a halogen atom, an alkyl group (including aralkyl group, cycloalkyl group, active methine group and the like), an alkenyl group, an alkynyl group, an aryl group, a heterocyclic group (may be substituted at any position), a heterocyclic group including a quarternarized nitrogen atom (e.g., pyridinio group, imidazolio group, quinolinio group, isoquinolinio group), an acyl group, an alkoxycarbonyl group, an aryloxycarbonyl group, a carbamoyl group, a carboxy group or a salt thereof, a sulfonylcarbamoyl group, an acylcarbamoyl group, a sulfamoylcarbamoyl group, a carbazoyl group, an oxalyl group, an oxamoyl group, a cyano group, a carbonimidoyl group, a thiocarbamoyl group, a hydroxy group, an alkoxy group (including a group having recurring ethyleneoxy group or propyleneoxy group units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an acylamino group, a sulfonamide group, an ureido group, a thioureido group, an imide group, an (alkoxy or aryloxy)carbonylamino group, a sulfamoylamino group, a semicarbazide group, a thiosemicarbazide group, a hydrazino group, an ammonio group, an oxamoylamino group, an (alkyl or aryl)sulfonylureido group, an acylureido group, an acylsulfamoylamino group, a nitro group, a mercapto group, an (alkyl, aryl, or heterocyclic)thio group, an (alkyl or aryl)sulfonyl group, an (alkyl or aryl)sulfinyl group, a sulfo group or a salt thereof, a sulfamoyl group, an acylsulfamoyl group, a sulfonylsulfamoyl group or a salt thereof, and a group including an amide phosphate or phosphate ester moiety.

These substituents may be further substituted with any of these substituents.

In formula (A), L₁₁ represents a leaving group which can be desorbed upon cleavage of the binding only after one-electron oxidization of the reducing group represented by RED₁₁. Specifically, it represents a carboxy group or a salt thereof, a silyl group, a hydrogen atom, a triarylboron anion, a trialkylstanyl group, a trialkylgermyl group, or a —CR_{C1}R_{C2}R_{C3} group.

When L₁₁ represents a salt of a carboxy group, specific examples of a counter ion to form the salt include an alkali metal ion (Li⁺, Na⁺, K⁺, Cs⁺), an alkaline earth metal ion (Mg²⁺, Ca²⁺, Ba²⁺), a heavy metal ion (Ag⁺, Fe^{2+/3+}), an ammonium ion, a phosphonium ion and the like.

When L₁₁ represents a silyl group, specific examples of the silyl group include a trialkylsilyl group, an aryldialkylsilyl group, a triarylsilyl group and the like, wherein examples of the alkyl group include a methyl, ethyl, benzyl, t-butyl group and the like, whilst examples of the aryl group include a phenyl group and the like.

When L₁₁ represents a triarylboron anion, preferable examples of the aryl group include a substituted or unsubstituted phenyl group, and examples of the substituent include similar substituents to those which may be carried by RED₁₁.

When L₁₁ represents a trialkylstanyl group or a trialkylgermyl group, the alkyl group herein is a straight chain, branched, or cyclic alkyl group having 1 to 24 carbon atoms, which may have a substituent, and examples of the substituent include similar substituents to those which may be carried by RED₁₁.

When L₁₁ represents a —CR_{C1}R_{C2}R_{C3} group, R_{C1}, R_{C2} and R_{C3} herein each independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. These may form a cyclic structure through binding with each other, and any of these may further have a substituent.

Examples of the substituent include similar substituents to those which may be carried by RED₁₁.

However, when one of the R_{C1}, R_{C2} and R_{C3} represents a hydrogen atom or an alkyl group, neither of the remaining two represents a hydrogen atom or an alkyl group.

Preferable examples of R_{C1}, R_{C2} and R_{C3} each independently include an alkyl group, an aryl group (particularly phenyl group), an alkylthio group, an arylthio group, an alkylamino group, an arylamino group, a heterocyclic group, an alkoxy group, a hydroxy group, and specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group and the like.

In addition, examples of the illustrative groups of forming a cyclic structure through binding thereof with each other include a 1,3-dithiolane-2-yl group, a 1,3-dithiane-2-yl group, an N-methyl-1,3-thiazolizine-2-yl group, an N-benzyl-benzothiazolizine-2-yl group and the like.

Preferable examples of the —CR_{C1}R_{C2}R_{C3} group include a trityl group, a tri-(p-hydroxyphenyl)methyl group, a 1,1-diphenyl-1-(p-dimethylaminophenyl)methyl group, a 1,1-diphenyl-1-(methylthio)methyl group, a 1-phenyl-1,1-(dimethylthio)methyl group, a 1,3-dithiorane-2-yl group, a 2-phenyl-1,3-dithiorane-2-yl group, a 1,3-dithiane-2-yl group, a 2-phenyl-1,3-ditlhiane-2-yl group, a 2-methyl-1,3-dithiane-2-yl group, an N-methyl-1,3-thiazolizine-2-yl group, a 2methyl-3-methyl-1,3-thiazolizine-2-yl group, an N-benzyl-benzothiazolizine-2-yl group, a 1,1-diphenyl-1-dimethylaminomethyl group, a 1,1-diphenyl-1-morpholinomethyl group and the like.

Additionally, it is also preferred that as a result of selection of R_{C1}, R_{C2} and R_{C3} in the —CR_{C1}R_{C2}R_{C3} group so that they comply with the scope described above, the group represents the identical group to the residue yielded by removal of L₁₁ from formula (A).

In formula (A), R₁₁₂ represents a substituent which can be substituted with a hydrogen atom or a carbon atom. When R₁₁₂ represents a substituent which can be substituted with a carbon atom, specific examples of the substituent herein include similar examples of the substituent to those for the substituent which may be carried by RED₁₁.

However, the identical group is not represented by both R₁₁₂ and L₁₁.

In formula (A), R₁₁₁ represents a nonmetal atomic group which can form a specified 5-membered or 6-membered cyclic structure together with a carbon atom (C) and RED₁₁. The specified 5-membered or 6-membered cyclic structure formed by R₁₁₁ as used herein means a cyclic structure corresponding to a tetrahydro form, a hexahydro form or an octahydro form of a 5-membered or 6-membered aromatic ring (including an aromatic heterocycle).

The hydro form herein means a cyclic structure with the carbon-carbon double bonds (or carbon-nitrogen double bond) which intrinsically exist in the aromatic ring (including aromatic hetero ring) being partially hydrogenated. The tetrahydro form herein means a structure in which two carbon-carbon double bonds (or carbon-nitrogen double bonds) are hydrogenated. The hexahydro form herein means a structure in which three carbon-carbon double bonds (or carbon-nitrogen double bonds) are hydrogenated. The octahydro form herein means a structure in which four carbon-carbon double bonds (or carbon-nitrogen double bonds) are hydrogenated. Through being hydrogenated, the aromatic ring turns into a partially hydrogenated non-aromatic cyclic structure.

Specific examples in the case of monocyclic 5-membered ring include a pyrrolidine ring, an imidazolizine ring, a thiazolizine ring, a pyrazolidine ring, an oxazolidine ring and the like which correspond to a tetrahydro form of the aromatic ring of a pyrrole ring, an imidazole ring, a thiazole ring, a pyrazole ring, an oxazole ring and the like.

Examples in the case of monocycle of the 6-membered ring include a tetrahydro form or a hexahydro form of an aromatic ring of a pyridine ring, a pyridazine ring, a pyrimidine ring, a pyrazine ring and the like, and for example, may include a piperidine ring, a tetrahydropyridine ring, a tetrahydropyrimidine ring, a piperazine ring and the like.

Examples in the case of condensed ring of the 6-membered ring include a tetralin ring, a tetrahydroquinoline ring, a tetrahydroisoquinoline ring, a tetrahydroquinazoline ring, a tetrahydroquinoxaline ring and the like which correspond to a tetrahydro form of an aromatic ring of a naphthalene ring, a quinoline ring, an isoquinoline ring, a quinazoline ring, a quinoxaline ring and the like.

Examples in the case of tricyclic compound include a tetrahydrocarbazole ring which is a tetrahydro form of a carbazole ring, an octahydrophenanthridine ring which is an octahydro form of a phenanthridine ring.

These cyclic structures may be further substituted, and the examples of the substituent include similar ones exemplified for the substituents which may be carried by RED₁₁.

Substituents of these cyclic structures may further link with each other to form a ring, and thus newly formed ring is a non-aromatic carbocyclic ring or heterocyclic ring.

Next, preferable range of the compounds represented by formula (A) in the invention is explained.

In formula (A), L₁₁ is preferably a carboxy group or a salt thereof, and a hydrogen atom. More preferably, L₁₁ is a carboxy group or a salt thereof.

A counter ion of the salt is preferably an alkali metal ion or an ammonium ion, and most preferred is an alkali metal ion (in particular, Li⁺, Na⁺, K⁺ ion).

When L₁₁ represents a hydrogen atom, the compound represented by formula (A) preferably has a base moiety which intrinsically exists within the molecule.

Owing to the action of this base moiety, the hydrogen atom represented by L₁₁ is deprotonated after the oxidation of the compound represented by formula (A), and thus, an additional electron is herefrom released.

The base herein refers to a conjugate base of an acid which specifically presents the pKa of about 1 to about 10. Examples of the base include nitrogen-containing heterocycles (pyridines, imidazoles, benzoimidazoles, thiazoles and the like), anilines, trialkylamines, amino groups, carbon acids (active methylene anion and the like), thioacetic acid anion, carboxylate (—COO⁻), sulfate (—SO₃⁻), amineoxide (>N⁺(O⁻)—) and the like.

Preferably, the base is a conjugate base of an acid which presents the pKa of about 1 to about 8, more preferably is carboxylate, sulfate or amineoxide, and particularly preferably is carboxylate.

When such a base has an anion, it may have a counter cation, and examples thereof include an alkali metal ion, an alkaline earth metal ion, a heavy metal ion, an ammonium ion, a phosphonium ion and the like.

The base is linked to the compound represented by formula (A) at an arbitrary position. The position to which the base moiety binds may be any one of RED₁₁, R₁₁₁ and R₁₁₂ in formula (A), or may link to any substituent of these groups.

When L₁₁ represents a hydrogen atom, the hydrogen atom and the base moiety are preferably linked via 8 or less atomic groups. It is more preferred that they are linked via 5 or more and 8 or less atomic groups.

The linking atomic group which may be included in the counting is an atomic group which links between a central atom of the base moiety (i.e., an atom having an anion or an atom having a lone electron pair) and the hydrogen atom via a covalent bond, and thus in the instance of carboxylate, two atoms of —C—O⁻ are counted, whilst in the instance of sulfate, two atoms of S—O⁻ are counted. Furthermore, the carbon atom represented by C in formula (A) is also added to the number.

In formula (A), when L₁₁ represents a hydrogen atom; RED₁₁ represents any of anilines; and the nitrogen atom thereof forms a 6-membered monocyclic and saturated cyclic structure (piperidine ring, piperazine ring, morpholine ring, thiomorpholine ring, selenomorpholine ring or the like) with R₁₁₁, the compound preferably has an adsorptive group to the silver halide within the molecule. In addition, it is more preferred that the compound concomitantly has a base moiety which intrinsically exists within the molecule, and that the base moiety and the hydrogen atom are linked via 8 or less atomic groups.

In formula (A), RED₁₁ may preferably be an alkylamino group, an arylamino group, a heterocyclic amino group, an aryl group, or an aromatic or nonaromatic heterocyclic group. Among these, with regard to the heterocyclic group, a tetrahydroquinolinyl group, a tetrahydroquinoxalinyl group, a tetrahydroquinazoliny group, an indolyl group, an indoleyl group, a carbazolyl group, a phenoxazinyl group, a phenothiazinyl group, a benzothiazolinyl group, a pyrrolyl group, an imidazolyl group, a thiazolizinyl group, a benzoimidazolyl group, a benzoimidazolinyl group, a 3,4-methylenedioxyphenyl-1-yl group or the like is preferred.

More preferably, the heterocyclic group is an arylamino group (particularly anilino group), or an aryl group (particularly phenyl group).

When RED₁₁ herein represents an aryl group, it is preferred that the aryl group has at least one electron-donating group (the number of the electron-donating group is preferably 4 or less, and more preferably 1 to 3).

Examples of the electron-donating group herein include a hydroxy group, an alkoxy group, a mercapto group, a sulfonamide group, an acylamino group, an alkylamino group, an arylamino group, a heterocyclic amino group, an active methine group, an aromatic heterocyclic group with electrons in excess (e.g., indolyl group, pyrrolyl group, imidazolyl group, benzimidazolyl group, thiazolyl group, benzthiazolyl group, indazolyl group and the like), and a nonaromatic and nitrogen-containing heterocyclic group substituted with a nitrogen atom (pyrrolidinyl group, indolinyl group, piperidinyl group, piperazinyl group, morpholino group and the like).

The active methine group herein means a methine group substituted with 2 electron-attractive groups. The electron-attractive group herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Two electron-attractive groups herein may bind with each other to form a cyclic structure.

When RED₁₁ represents an aryl group, substituent of the aryl group is more preferably an alkylamino group, a hydroxy group, an alkoxy group, a mercapto group, a sulfonamide group, an active methine group, or a nonaromatic and nitrogen-containing heterocyclic group substituted with a nitrogen atom, and still more preferably, is an alkylamino group, a hydroxy group, an active methine group, or a nonaromatic and nitrogen-containing heterocyclic group substituted with a nitrogen atom, and most preferably is an alkylamino group, or a nonaromatic and nitrogen-containing heterocyclic group substituted with a nitrogen atom.

In formula (A), R₁₁₂ is preferably a hydrogen atom, an alkyl group, an aryl group (phenyl group and the like), an alkoxy group (methoxy group, ethoxy group, benzyloxy group and the like), a hydroxy group, an alkylthio group (methylthio group, butylthio group and the like), an amino group, an alkylamino group, an arylamino group or a heterocyclic amino group, and more preferably, is a hydrogen atom, an alkyl group, an alkoxy group, a hydroxy group, a phenyl group or an alkylamino group.

In formula (A), R₁₁₁ is preferably a non-metal atomic group which can form the following specified 5-membered or 6-membered cyclic structure together with a carbon atom (C) and RED₁₁. In other words, examples thereof include a pyrrolidine ring, an imidazolizine ring or the like corresponding to a tetrahydro form of a pyrrole ring, an imidazole ring or the like which is a monocyclic 5-membered aromatic ring; a tetrahydro form or a hexahydro form of a pyridine ring, a pyridazine ring, a pyrimidine ring or a pyrazine ring which is a monocyclic 6-membered aromatic ring (e.g., piperidine ring, tetrahydropyridine ring, tetrahydropyrimidine ring, piperazine ring or the like); a tetralin ring, a tetrahydroquinoline ring, a tetrahydroisoquinoline ring, a tetrahydroquinazoline ring, a tetrahydroquinoxaline ring or the like corresponding to a tetrahydro form of a naphthalene ring, a quinoline ring, an isoquinoline ring, a quinazoline ring, a quinoxaline ring or the like which is a condensed 6-membered aromatic ring; a tetrahydrocarbazole ring which is a tetrahydro form of a carbazole ring which is a tricyclic aromatic ring; or an octahydrophenanthridine ring which is an octahydro form of a phenanthridine ring.

The cyclic structure formed by RI I may be more preferably a pyrrolidine ring, an imidazolizine ring, a piperidine ring, a tetrahydropyridine ring, a tetrahydropyrimidine ring, a piperazine ring, a tetrahydroquinoline ring, a tetrahydroquinazoline ring, a tetrahydroquinoxaline ring or a tetrahydrocarbazole ring, particularly preferably, a pyrrolidine ring, a piperidine ring, a piperazine ring, a tetrahydroquinoline ring, a tetrahydroquinazoline ring, a tetrahydroquinoxaline ring, or a tetrahydrocarbazole ring, and most preferably, a pyrrolidine ring, a piperidine ring, or a tetrahydroquinoline ring.

Next, formula (B) is explained in detail.

In formula (B), RED₁₂ and L₁₂ represent a group defined similarly to RED₁₁ and L₁₁ in the general formula (A), respectively, and the preferable scope thereof is also identical.

However, RED₁₂ is a monovalent group except for the case in which it forms a cyclic structure described below, and hence, specific examples thereof include the groups named as the monovalent group described for RED₁₁.

R₁₂₁ and R₁₂₂ represent a group defined similarly to R₁₁₂ in formula (A), and the preferable scope thereof is also identical. ED₁₂ represents an electron-donating group.

R₁₂₁ and RED₁₂, R₁₂₁ and R₁₂₂, or ED12 and RED₁₂ may be connected to each other to form a cyclic structure.

In formula (B), the electron-donating group represented by ED₁₂ refers to a hydroxy group, an alkoxy group, a mercapto group, an alkylthio group, an arylthio group, a heterocyclic thio group, a sulfonamide group, an acylamino group, an alkylamino group, an arylamino group, a heterocyclic amino group, an active methine group, an aromatic heterocyclic group with electrons in excess (e.g., indolyl group, pyrrolyl group, indazolyl group), a nonaromatic and nitrogen-containing heterocyclic group substituted with a nitrogen atom (pyrrolidinyl group, piperidinyl group, indolinyl group, piperazinyl group, morpholino group and the like), and an aryl group substituted with any of these electron-donating groups (e.g., p-hydroxyphenyl group, p-dialkylaminophenyl group, o,p-dialkoxyphenyl group, 4-hydroxynaphthyl group and the like).

The active methine group as used herein is similar to those explained as a substituent in the case when RED₁₁ represents an aryl group.

Examples of ED₁₂ include preferably, a hydroxy group, an alkoxy group, a mercapto group, a sulfonamide group, an alkylamino group, an arylamino group, an active methine group, an aromatic heterocyclic group with electrons in excess, a nonaromatic and nitrogen-containing heterocyclic group substituted with a nitrogen atom, and a phenyl group substituted with any of these electron-donating groups, and more preferably, a hydroxy group, a mercapto group, a sulfonamide group, an alkylamino group, an arylamino group, an active methine group, a nonaromatic and nitrogen-containing heterocyclic group substituted with a nitrogen atom, and a phenyl group substituted with any of these electron-donating groups (e.g., p-hydroxyphenyl group, p-dialkylaminophenyl group, o,p-dialkoxyphenyl group and the like).

In formula (B), R₁₂, and RED₁₂, R₁₂₂ and R₁₂₁, or ED₁₂ and RED₁₂ may be connected to each other to form a cyclic structure.

The cyclic structure formed herein refers to a non-aromatic carbon ring or hetero ring, which is a 5-membered through 7-membered monocycle or condensed ring, having a substituted or unsubstituted cyclic structure. When R₁₂₁ and RED₁₂ form a cyclic structure, specific examples thereof include a pyrrolidine ring, a pyrroline ring, an imidazolizine ring, an imidazoline ring, a thiazolizine ring, a thiazoline ring, a pyrazolidine ring, a pyrazoline ring, an oxazolidine ring, an oxazoline ring, an indane ring, a piperidine ring, a piperazine ring, a morpholine ring, a tetrahydropyridine ring, a tetrahydropyrimidine ring, an indoline ring, a tetralin ring, a tetrahydroquinoline ring, a tetrahydroisoquinoline ring, a tetrahydroquinoxaline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, a 2,3-dihydrobenzothiophene ring and the like.

When ED₁₂ and RED₁₂ form a cyclic structure, ED₁₂ preferably represents an amino group, an alkylamino group, or an arylamino group, and specific examples of the cyclic structure formed include a tetrahydropyrazine ring, a piperazine ring, a tetrahydroquinoxaline ring, tetrahydroisoquinoline ring and the like.

When R₁₂₂ and R₁₂₁ form a cyclic structure, specific examples thereof include a cyclohexane ring, a cyclopentane ring and the like.

Among the compounds represented by formula (A) according to the invention, more preferred are those represented by the following formulae (10) through (12), and among the compounds represented by the following formula (B), more those preferred are represented by the following formulae (13) and (14).

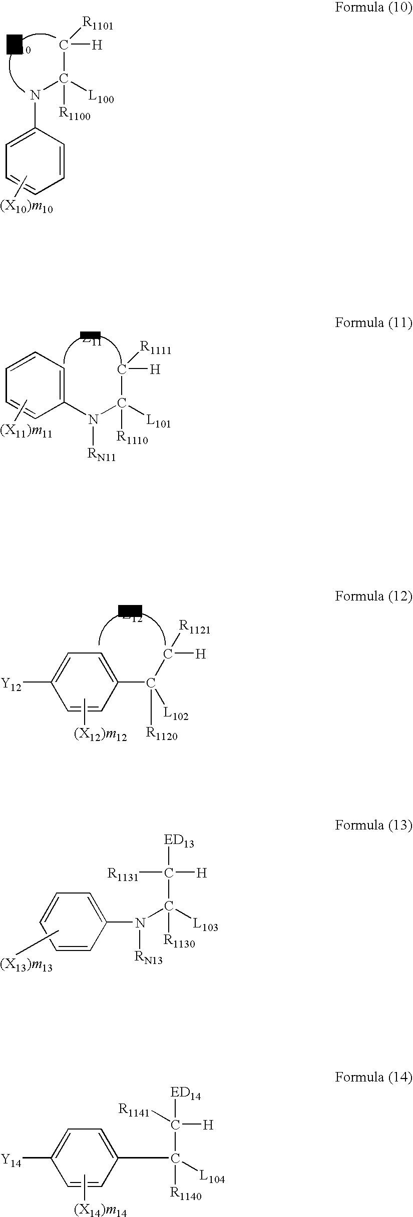

In formulae (10) through (14), L₁₀₀, L₁₀₁, L₁₀₂, L₁₀₃, and L₁₀₄ are similar groups to those as defined for L₁₁ in formula (A), and the preferable scope thereof is also identical.

R₁₁₀₀ and R₁₁₀₁, R₁₁₁₀ and R₁₁₁₁, R₁₁₂₀ and R₁₁₂₁, R₁₁₃₀ and R₁₁₃₁, R₁₁₄₀ and R₁₁₄₁, are similar groups to those as defined for R₁₂₂ and R₁₂₁ in formula (B) respectively, and the preferable scope thereof is also identical.

ED₁₃ and ED₁₄ each represent a similar group to those as defined for ED₁₂ in formula (B), and the preferable scope thereof is also identical.

X₁₀, X₁₁, X₁₂, X₁₃ and X₁₄ each represent a substituent which may be substituted with a benzene ring; m₁₀, m₁₁, m₁₂, m₁₃ and m₁₄ each represent integer of 0 to 3, and when these represent any plural number, plural number of X₁₀, X₁₁, X₁₂, X₁₃ and X₁₄ may be the same or different.

Y₁₂ and Y₁₄ represent an amino group, an alkylamino group, an arylamino group, a nonaromatic and nitrogen-containing heterocyclic group substituted with a nitrogen atom (pyrrolyl group, piperidinyl group, indolinyl group, piperazino group, morpholino group and the like), a hydroxy group, or an alkoxy group.

Z₁₀, Z₁₁ and Z₁₂ represent a nonmetal atomic group which may form a specific cyclic structure.

The specific cyclic structure formed by Z₁₀ may be a cyclic structure corresponding to a tetrahydro form or a hexahydro form of a 5-membered or 6-membered, and monocyclic or condensed nitrogen-containing aromatic hetero ring. Specific examples thereof include a pyrrolidine ring, an imidazolizine ring, a thiazolizine ring, a pyrazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring, and the like.

Specific cyclic structure formed by Z₁₁ refers to a tetrahydroquinoline ring, or a tetrahydroquinoxaline ring.

Specific cyclic structure formed by Z₁₂ refers to a tetralin ring, a tetrahydroquinoline ring, or a tetrahydroisoquinoline ring.

R_{N11} and R_{N13} each represent a hydrogen atom, or a substituent which can be substituted with a nitrogen atom. Specific examples of the substituent include an alkyl group, an alkenyl group, an alkynyl group, an aryl group, a heterocyclic group and an acyl group, and preferably, they are each an alkyl group or an aryl group.

Specific examples of the substituent which can be substituted with a benzene ring represented by X₁₀, X₁₁, X₁₂, X₁₃ and X₁₄ include similar ones exemplified for the substituents which may be carried by RED₁₁ in formula (A).

Preferably, they are a halogen atom, an alkyl group, an aryl group, a heterocyclic group, an acyl group, an alkoxycarbonyl group, an aryloxycarbonyl group, a carbamoyl group, a cyano group, an alkoxy group (including groups having a repetitive ethyleneoxy group or propyleneoxy group units), an (alkyl, aryl, or heterocyclic)amino group, an acylamino group, a sulfonamide group, an ureido group, a thioureido group, an imide group, an (alkoxy or aryloxy)carbonylamino group, a nitro group, an (alkyl, aryl, or heterocyclic)thio group, an (alkyl or aryl)sulfonyl group, a sulfamoyl group or the like.

m₁₀, m₁₁, m₁₂, m₁₃ and m₁₄ are preferably 0 to 2, and more preferably 0 or 1.

Y₁₂ and Y₁₄ are preferably an alkylamino group, an arylamino group, a non-aromatic and nitrogen-containing heterocyclic group substituted with a nitrogen atom, a hydroxy group or an alkoxy group, more preferably an alkylamino group, a 5 to 6-membered non-aromatic and nitrogen-containing heterocyclic group substituted with a nitrogen atom or a hydroxy group, and most preferably an alkylamino group (particularly dialkylamino group) or a 5 to 6-membered non-aromatic and nitrogen-containing heterocyclic group substituted with a nitrogen atom.

In formula (13), R₁₁₃₁ and X₁₃, R₁₁₃₁ and R_{N13}, R₁₁₃₀ and X₁₃, or R₁₁₃₀ and R_{N13} may be connected to each other to form a cyclic structure.

Additionally, in formula (14), R₁₁₄₁ and X₁₄, R₁₁₄₁ and R₁₁₄₀, ED₁₄ and X₁₄, or R₁₁₄₀ and X₁₄ may be connected to each other to form a cyclic structure.

The cyclic structure as used herein refers to a non-aromatic carbocyclic ring or heterocyclic ring, which is a 5-membered through 7-membered monocycle or condensed ring, having a substituted or unsubstituted cyclic structure. In formula (13), when R₁₁₃₁ and X₁₃ bind to form a cyclic structure, and when R₁₁₃₁ and R_{N13} are connected to form a cyclic structure, they are included in preferable examples of the compound represented by formula (13) similarly to the cases in which any cyclic structure is not formed.

Specific examples of the cyclic structure formed by R₁₁₃₁ and X₁₃ in formula (13) include an indoline ring (in this instance, R₁₁₃₁ consequently represents a single bond), a tetrahydroquinoline ring, a tetrahydroquinoxaline ring, a 2,3-dihydrobenzo-1,4-oxazine ring, a 2,3-dihydrobenzo-1,4-thiazine ring and the like.

Particularly preferable examples include an indoline ring, a tetrahydroquinoline ring, and a tetrahydroquinoxaline ring.

Specific examples of the cyclic structure formed by R₁₁₃₁ and R_{N13} in formula (13) include a pyrrolidine ring, a pyrroline ring, an imidazolizine ring, an imidazoline ring, a thiazolizine ring, a thiazoline ring, a pyrazolidine ring, a pyrazoline ring, an oxazolidine ring, an oxazoline ring, a piperidine ring, a piperazine ring, a morpholine ring, a tetrahydropyridine ring, a tetrahydropyrimidine ring, an indoline ring, a tetrahydroquinoline ring, a tetrahydroisoquinoline ring, a tetrahydroquinoxaline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, 2,3-dihydrobenzothiophene ring and the like.

Particularly preferable examples include a pyrrolidine ring, a piperidine ring, a tetrahydroquinoline ring and a tetrahydroquinoxaline ring.

In formula (14), when R₁₁₄₁ and X₁₄ bind to form a cyclic structure, and when ED₁₄ and X₁₄ are connected to each other to form a cyclic structure, they are included in preferable examples of the compound represented by formula (14) similarly to the cases in which any cyclic structure is not formed.

Examples of the cyclic structure formed by R₁₁₄₁ and X₁₄ in formula (14) include an indane ring, a tetralin ring, a tetrahydroquinoline ring, a tetrahydroisoquinoline ring, an indoline ring and the like.

Examples of the cyclic structure formed by ED₁₄ and X₁₄ include a tetrahydroisoquinoline ring, a tetrahydrocinnoline ring and the like.

Next, the general formulae (1) through (3) are explained.

In formulae (1) through (3), R₁, R₂, R₁₁, R₁₂ and R₃₁ each independently represent a hydrogen atom or a substituent, and these are a similar group to that as defined for R₁₁₂ in formula (A), and the preferable scope thereof is also identical.

L₁, L₂₁ and L₃₁ each independently represent a leaving group, and these represent a group which is similar to the groups included in the specific examples referred to in the description for L₁₁ in formula (A), and the preferable scope thereof is also identical.

X₁ and X₂₁ represent a substituent which may be substituted with a benzene ring, and examples thereof each independently include similar ones exemplified for the substituents which may be carried by RED₁₁ in formula (A).

m₁ and m₂₁ represent integer of 0 to 3, preferably represent 0 to 2, and are more preferably 0 or 1.

R_{N1}, R_{N21} and R_{N31} represent a hydrogen atom or a substituent which may be substituted with a nitrogen atom. Preferable examples of the substituent include an alkyl group, an aryl group and a heterocyclic group, which may further have a substituent. Examples of the substituent include similar substituents which may be carried by RED₁₁ in formula (A).

R_{N1}, R_{N21} and R_{N31} are preferably a hydrogen atom, an alkyl group or an aryl group, and more preferably a hydrogen atom or an alkyl group.

R₁₃, R₁₄, R₃₂, R₃₃, Rₐ and R_{b} each independently represent a hydrogen atom or a substituent which can be substituted with a carbon atom.

Examples of the substituent include similar substituents which may be carried by RED₁₁ in formula (A).

Preferable examples include an alkyl group, an aryl group, an acyl group, an alkoxycarbonyl group, a carbamoyl group, a cyano group, an alkoxy group, an acylamino group, a sulfonamide group, an ureido group, a thioureido group, an alkylthio group, an arylthio group, an alkylsulfonyl group, an arylsulfonyl group, a sulfamoyl group and the like.

In formula (1), Z₁ represents an atomic group which may form a 6-membered ring together with a nitrogen atom and two carbon atoms in the benzene ring.

The 6-membered ring formed by Z₁ is a non-aromatic heterocycle which condensed with the benzene ring in formula (1). Specific examples of the cyclic structure that also involves a benzene ring to be condensed include a tetrahydroquinoline ring, a tetrahydroquinoxaline ring and a tetrahydroquinazoline ring, which may have a substituent.

Examples of the substituent include similar ones exemplified for the substituents represented by R₁₁₂ in formula (A), and the preferable scope thereof is also identical.

In formula (1), Z₁ preferably represents an atomic group which forms a tetrahydroquinoline ring or a tetrahydroquinoxaline ring together with a nitrogen atom and two carbon atoms in the benzene ring.

In formula (2), ED₂₁ represents an electron-donating group, which is a similarly defined group to ED₁₂ in formula (B), and the preferable scope thereof is also identical.

In formula (2), each two of R_{N21}, R₁₃, R₁₄, X₂₁ and ED₂₁ may be connected to each other to forma a cyclic structure.

The cyclic structure as used herein formed by binding of R_{N21} and X₂₁ is preferably a 5-membered through 7-membered nonaromatic carbon ring or hetero ring condensed with a benzene ring. Specific examples thereof include a tetrahydroquinoline ring, a tetrahydroquinoxaline ring, an indoline ring, a 2,3-dihydro-5,6-benzo-1,4-thiazine ring and the like.

Preferable examples include a tetrahydroquinoline ring, a tetrahydroquinoxaline ring and an indoline ring.

In formula (3), when R_{N31} represents a group other than aryl groups, Rₐ and R_{b} may be connected to each other to form an aromatic ring.

The aromatic ring as used herein refers to an aryl group (e.g., phenyl group, naphthyl group) or an aromatic heterocyclic group (e.g., pyridine ring group, pyrrole ring group, quinoline ring group, indole ring group and the like), and is preferably an aryl group.

The aromatic ring group may have a substituent. Examples of the substituent include similar substituents exemplified for the case in which X₁ represents a substituent in formula (1), and the preferable scope thereof is also identical.

In formula (3), it is preferred that Rₐ and R_{b} may be connected to each other to form an aromatic ring (particularly phenyl group).

In formula (3), R₃₂ is preferably a hydrogen atom, an alkyl group, an aryl group, a hydroxy group, an alkoxy group, a mercapto group, an amino group or the like. Preferable examples also include the case in which R₃₂ represents a hydroxy group herein, and R₃₃ concomitantly represents an electron-attractive group.

The electron-attractive group as used herein refers to an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbon imidoyl group, and preferably, is an acyl group, an alkoxycarbonyl group, a carbamoyl group or a cyano group.

Next, compounds of type 2 are explained

The type 2 compound is a compound that is one-electron oxidized to produce a one-electron oxidation product, then, when the resultant compound in one-electron oxidized form is subjected to a carbon-carbon bond cleaving reaction, it releases one or more electron, in other words, it is a compound that can be one-electron oxidized. The term “bond cleaving reaction” as used herein is intended to mean a carbon-carbon, carbon-silicon, carbon-hydrogen, carbon-boron, carbon-tin and carbon-germanium bond cleaving reaction which may be followed by a carbon-hydrogen bond cleaving reaction.

The reaction of cleavage of a binding herein means the cleavage of the binding between each element of: carbon-carbon. In addition, the cleavage of a carbon-hydrogen binding may be accompanied therewith.

However, the compound of type 2 is a compound that has two or more (preferably, 2 to 6, and more preferably 2 to 4) adsorptive groups to a silver halide within the molecule. More preferably, it is a compound having a nitrogen-containing heterocyclic group substituted with a mercapto group as an adsorptive group.

Number of the adsorptive group is preferably 2 to 6, and more preferably 2 to 4. The adsorptive group is explained hereinafter.

Preferable compounds among the compounds of type 2 are represented by formula (C).

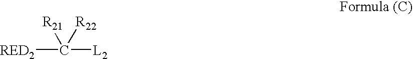

The compound represented by formula (C) herein is a compound which can additionally release one electron, in other words, through cleavage of the C (carbon atom)-L₂ binding through spontaneous leaving of L₂ by the reaction of cleavage of binding, after the reducing group represented by RED₂ is oxidized at one electron.

In formula (C), RED₂ represents a group defined similarly to RED₁₂ in formula (B), and the preferable scope thereof is also identical.

L₂ represents represent a group defined similarly to L₁₁ in formula (A), and the preferable scope thereof is also identical.

When L₂ represents a silyl group, the compound shall be a compound having a nitrogen-containing heterocyclic group substituted with two or more mercapto groups within the molecule as an adsorptive group.

R₂₁ and R₂₂ represent a hydrogen atom or a substituent, and these are a group defined similarly to R₁₁₂ in formula (A), and the preferable scope thereof is also identical.

RED₂ and R₂₁ may be connected to each other to form a cyclic structure.

The cyclic structure herein formed is a 5-membered through 7membered, monocyclic or condensed-ring, nonaromatic carbon ring or hetero ring, which may have a substituent.

However, the cyclic structure is never a cyclic structure corresponding to a tetrahydro form, a hexahydro form or an octahydro form of an aromatic ring or aromatic hetero ring.

Examples of the substituent include similar substituents which may be carried by RED₁₁ in formula (A).

The cyclic structure is preferably a cyclic structure corresponding to a dihydro form of an aromatic ring or aromatic hetero ring, and specific examples thereof include for example, a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzooxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring and the like.

Preferable examples of the cyclic structure include a 2-imidazoline ring, a 2-thiazoline ring, an indoline ring, a benzoimidazoline ring, a benzothiazoline ring, a benzooxazoline ring, a 1,2-dihydropyridine ring, a 1,2-dihydroquinoline ring, a 1,2-dihydroquinazoline ring, a 1,2-dihydroquinoxaline ring and the like, and an indoline ring, a benzoimidazoline ring, a benzothiazoline ring, or a 1,2-dihydroquinoline ring is more preferred, with an indoline ring being most preferred.

Next, compounds of type 3 are explained.

The type 3 compound is a compound that is one-electron oxidized to produce a one-electron oxidation product, which releases additional one or more electrons after a subsequent bond-forming step whereupon the term “bond-forming step” as used herein is intended to mean formation of an inter-atomic bond such as a carbon-carbon bond, a carbon-nitrogen bond, a carbon-sulfur bond or a carbon-oxygen bond.

The type 3 compound is preferably a compound characterized in that a one-electron oxidized product by subjecting the compound to a one-electron oxidization reaction subsequently reacts with a carbon-carbon double-bond portion or a carbon-carbon triple-bond portion to form a bond and, thereafter, can further release one or more electrons.

The one-electron oxidized form to be generated by subjecting the compound of the type 3 compound to a one-electron oxidation reaction is also referred to as a cationic radical species which can occasionally be changed into a neutral radical species along with deprotonation therefrom. The one-electron oxidized form (a cationic radical species or neutral radical species) generates a chemical reaction generally referred to as “addition cyclization reaction” in a carbon-carbon double-bond portion or a carbon-carbon triple-bond portion which is simultaneously present in the same molecule to form an inter-atomic bond such as a carbon-carbon bond, a carbon-nitrogen bond, a carbon-sulfur bond or a carbon-oxygen bond and, then, to form a new ring structure in the molecule. It is the characteristics of the type 3 compound that, at the same time of or after forming the new ring structure as described above, one or more electrons can further be released.

The compound type 3 is preferably a compound characterized in that a one-electron oxidized form produced by one-electron oxidation can release additional one electron or more electrons after forming a binding through a subsequent reaction with a reactive group moiety (a carbon-carbon double bond moiety, a carbon-carbon triple bond moiety, an aromatic group moiety, or a nonaromatic heterocyclic group moiety of a benzo-condensed ring) which coexists within the molecule.

Referring to more particularity, although the compound of type 3 newly produces a radical species having a cyclic structure through this reaction to form a binding after being oxidized at one electron, the compound is characterized in that additional second electron is released and oxidized, either directly from this radical species or with accompanying proton desorption.

Compounds of type 3 further include those having an ability to be oxidized through releasing one or more electrons, usually two or more electrons, through causing a tautomerization reaction accompanied by transfer of the proton of thus resulting two electrons-oxidized form, directly in some instances thereafter, or after hydrolysis reaction in other instances.

Alternatively, also included may be those having an ability to be oxidized without passing such a tautomerization reaction, through releasing one or more electrons, usually two or more electrons directly from the two electrons-oxidized form.

The compound of type 3 is preferably represented by formula (D).

RED₃-L₃-Y₃ Formula (D)

In formula (D), RED₃ represents a reducing group which can be oxidized at one electron, Y₃ represents a reactive group moiety which reacts following the one-electron oxidation of RED₃, and specifically represents an organic group including a carbon-carbon double bond moiety, a carbon-carbon triple bond moiety, an aromatic group moiety, or a nonaromatic heterocyclic group moiety of a benzo-condensed ring.

L₃ represents a linking group which connects RED₃ and Y₃.

In formula (D), RED₃ represents a similar group to that as defined for RED₁₂ in formula (B).

In formula (D), RED₃ is preferably an arylamino group, a heterocyclic amino group, an aryloxy group, an arylthio group, an aryl group, or an aromatic or nonaromatic heterocyclic group (in particular, a nitrogen-containing heterocyclic group is preferred), and more preferably, an arylamino group, a heterocyclic amino group, an aryl group, or an aromatic or nonaromatic heterocyclic group. Among these, with regard to the heterocyclic group, a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzoimidazole ring group, a benzoimidazoline ring group, a benzothiazoline ring group, a 3,4-methylenedioxyphenyl-1-yl group or the like is preferred.

RED₃ is particularly preferably an arylamino group (in particular, anilino group), an aryl group (in particular, phenyl group), or an aromatic or nonaromatic heterocyclic group.

When RED₃ as used herein represents an aryl group, the aryl group preferably has at least one electron-donating group.

The electron-donating group as used herein refers to a hydroxy group, an alkoxy group, a mercapto group, an alkylthio group, a sulfonamide group, an acylamino group, an alkylamino group, an arylamino group, a heterocyclic amino group, an active methine group, an aromatic heterocyclic group with electrons in excess (e.g., indolyl group, pyrrolyl group, indazolyl group), or a nonaromatic and nitrogen-containing heterocyclic group substituted with a nitrogen atom (pyrrolidinyl group, indolinyl group, piperidinyl group, piperazinyl group, morpholino group, thiomorpholino group and the like).

The active methine group as used herein refers to a methine group substituted with two electron-attractive groups. The electron-attractive group herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group.

The two electron-attractive groups as used herein may be connected to each other to form a cyclic structure.

When RED₃ represents an aryl group, the substituent of the aryl group is more preferably an alkylamino group, a hydroxy group, an alkoxy group, a mercapto group, a sulfonamide group, an active methine group, or a nonaromatic and nitrogen-containing heterocyclic group substituted with a nitrogen atom, more preferably an alkylamino group, a hydroxy group, an active methine group, or a nonaromatic and nitrogen-containing heterocyclic group substituted with a nitrogen atom, and most preferably an alkylamino group, or a nonaromatic and nitrogen-containing heterocyclic group substituted with a nitrogen atom.

In formula (D), when the reactive group represented by Y₃ represents an organic group including a carbon-carbon double bond or a carbon-carbon triple bond having a substituent, the substituent is preferably, an alkyl group (preferably having 1 to 8 carbon atoms), an aryl group (preferably having 6 to 12 carbon atoms), an alkoxycarbonyl group (preferably having 2 to 8 carbon atoms), a carbamoyl group, an acyl group, an electron-donating group or the like.

The electron-donating group as used herein refers to, an alkoxy group (preferably having 1 to 8 carbon atoms), a hydroxy group, an amino group, an alkylamino group (preferably having 1 to 8 carbon atoms), an arylamino group (preferably having 6 to 12 carbon atoms), a heterocyclic amino group (preferably having 2 to 6 carbon atoms), a sulfonamide group, an acylamino group, an active methine group, a mercapto group, an alkylthio group (preferably having 1 to 8 carbon atoms), an arylthio group (preferably having 6 to 12 carbon atoms), and an aryl group (carbon number of the aryl moiety being preferably 6 to 12) having any of these groups as a substituent.

The hydroxy group may be protected with a silyl group, including for example, a trimethylsilyloxy group, a t-butyldimethylsilyloxy group, a triphenylsilyloxy group, a triethylsilyloxy group, a phenyldimethylsilyloxy group or the like. Examples of the carbon-carbon double bond moiety and carbon-carbon triple bond moiety include a vinyl group, ethinyl group and the like.

When Y₃ represents an organic group including a carbon-carbon double bond moiety having a substituent, the substituent is more preferably an alkyl group, a phenyl group, an acyl group, a cyano group, an alkoxycarbonyl group, a carbamoyl group, an electron-donating group or the like, and the electron-donating group herein preferably refers to an alkoxy group, a hydroxy group (which may be protected by a silyl group), an amino group, an alkylamino group, an arylamino group, a sulfonamide group, an active methine group, a mercapto group, an alkylthio group, and a phenyl group having any of these electron-donating groups as a substituent.

When the organic group including a carbon-carbon double bond moiety herein has a hydroxy group as a substituent, Y₃ may include the following moiety: >C₁═C₂(—OH)—, however, this structure may be changed to the following moiety: >C₁H—C₂(═O)—, by way of tautomerization.

Additionally, in this instance, it is also preferred that the substituent substituted to the C₁ carbon is an electron-attractive group. In such a case, Y₃ shall have a moiety of an “active methylene group” or an “active methine group”.

The electron-attractive group which can yield such a moiety of an active methylene group or active methine group is identical to those exemplified in the above description for “active methine group”.

When Y₃ represents an organic group including a carbon-carbon triple bond having a substituent, the substituent is preferably an alkyl group, a phenyl group, an alkoxycarbonyl group, a carbamoyl group, an electron-donating group or the like. The electron-donating group as used herein preferably refers to an alkoxy group, an amino group, an alkylamino group, an arylamino group, a heterocyclic amino group, a sulfonamide group, an acylamino group, an active methine group, a mercapto group, an alkylthio group or a phenyl group having any of these electron-donating groups as a substituent.

When Y₃ represents an organic group including an aromatic group moiety, the aromatic group is preferably an indole ring group or an aryl group (in particular, a phenyl group is preferred) having an electron-donating group as a substituent, and the electron-donating group herein preferably refers to a hydroxy group (which may be protected by a silyl group), an alkoxy group, an amino group, an alkylamino group, an active methine group, a sulfonamide group or a mercapto group.

When Y₃ represents an organic group including a benzo-condensed nonaromatic heterocyclic group moiety, it is preferably a group inherently having an aniline structure as a partial structure, and examples thereof include an indoline ring group, a 1,2,3,4-tetrahydroquinoline ring group, a 1,2,3,4-tetrahydroquinoxaline ring group, a 4-quinolone ring group and the like.

In formula (D), the reactive group represented by Y₃ is more preferably, a carbon-carbon double bond moiety, an aromatic group moiety, or an organic group including a benzo-condensed nonaromatic heterocyclic group.

More preferably, it is a carbon-carbon double bond moiety, a phenyl group having an electron-donating group as a substituent, an indole ring group, or a benzo-condensed nonaromatic heterocyclic group intrinsically having an aniline structure as a partial structure.

It is more preferred that the carbon-carbon double bond moiety herein has at least one electron-donating group as a substituent.

Preferable examples of the compound represented by formula (D) also include the case in which the reactive group represented by Y₃ in formula (D) has a similar partial structure to the reducing group represented by RED₃ in formula (D) as a consequence of selection from the scope as explained hereinabove.

In formula (D), L₃ represents a linking group which links between RED₃ and Y₃, and specifically, represents a single bond, any group of an alkylene group, an arylene group, a heterocyclic group, —O—, —S—, —NR_{N}—, —C(═O)—, —SO₂—, —SO—, —P(═O)—, alone or any combination of these groups.

R_{N} herein represents a hydrogen atom, an alkyl group, an aryl group, or a heterocyclic group. The linking group represented by L₃ may have a substituent.

Examples of the substituent include similar ones explained as the substituent which may be carried by RED₁₁ in the general formula (A).

The linking group represented by L₃ may be linked at an arbitrary position of the groups represented by RED₃ and Y₃, in a manner to substitute with one arbitrary hydrogen atom, respectively.

Regarding the group represented by L₃ in formula (D), it is preferred that when the reactive group represented by Y₃ in formula (D) react with a cation radical species (X⁺) produced by oxidization of RED₃ in formula (D) or a radical species (X.) produced upon desorption of a proton therefrom to form a binding, the atomic groups participant thereto form a 3- through 7-membered cyclic structure involving L₃.

For this purpose, it is preferred that the radical species (X⁺. or X.), the reactive group represented by Y₃, and L₃ are linked via 3 to 7 atomic groups.

Preferable examples of L₃ include a single bond, an alkylene group (in particular, methylene group, ethylene group, propylene group), an arylene group (in particular, phenylene group), a —C(═O)-group, an —O-group, an —NH-group, an —N(alkyl group)-group, and a bivalent linking group comprising any combination of these groups.

Among the compounds represented by formula (D), preferred compounds are represented by the following formulae (D-1) through (D-4).

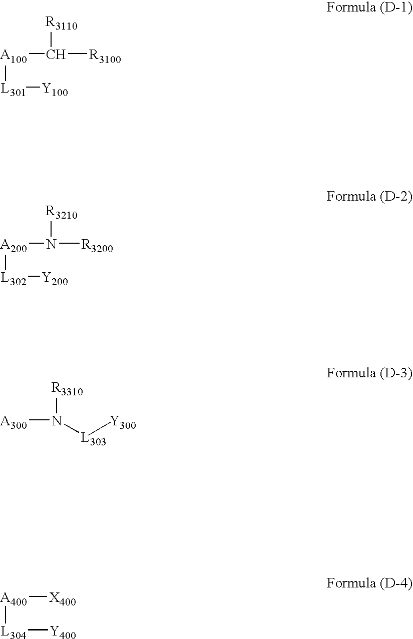

In formulae (D-1) through (D-4), A₁₀₀, A₂₀₀ and A₄₀₀ represent an arylene group or a bivalent heterocyclic group, and A₃₀₀ represents an aryl group or a heterocyclic group.

Preferable ring groups are similar to the preferable examples of RED₃ in formula (D).

L₃₀₁, L₃₀₂, L₃₀₃ and L₃₀₄ represent a linking group, which is similarly defined to L₃ in formula (D), and the preferable example thereof is also identical.

Y₁₀₀ , Y₂₀₀, Y₃₀₀ and Y₄₀₀ represent a reactive group, which is similarly defined to Y₃ in formula (D), and the preferable example thereof is also identical.

R₃₁₀₀, R₃₁₁₀, R₃₂₀₀, R₃₂₁₀ and R₃₃₁₀ represent a hydrogen atom or a substituent. R₃₁₀₀ and R₃₁₁₀ are preferably a hydrogen atom, an alkyl group or an aryl group.

R₃₂₀₀ and R₃₃₁₀ are preferably a hydrogen atom.

R₃₂₁₀ is preferably a substituent, and the substituent preferably refers to an alkyl group or an aryl group.

R₃₁₁₀ and A₁₀₀, R₃₂₁₀ and A₂₀₀, and R₃₃₁₀ and A₃₀₀ may respectively bind with each other to form a cyclic structure.

The cyclic structure formed herein is preferably a tetralin ring, an indane ring, a tetrahydroquinoline ring, an indoline ring or the like.

X₄₀₀ represents a hydroxy group, a mercapto group or an alkylthio group, and is preferably a hydroxy group or a mercapto group, more preferably a mercapto group.

Among the compounds of formulae (D-1) through (D-4), more preferred are the compounds represented by formulae (D-2), (D-3) and (D-4). Still more preferred are compounds represented by formula (D-2) or (D-3).

Next, compounds of type 4 are explained.

The type 4 compound is a compound which has a ring structure substituted by a reducing group and, along with a cleavage reaction to be performed on a ring structure after the reducing group is one-electron oxidized, can further release one or more electrons.

The type 4 compound is subjected to a one-electron oxidation reaction and, thereafter, the ring structure is subjected to a cleaving reaction. This cleaving reaction denotes a model represented by the following formulas:

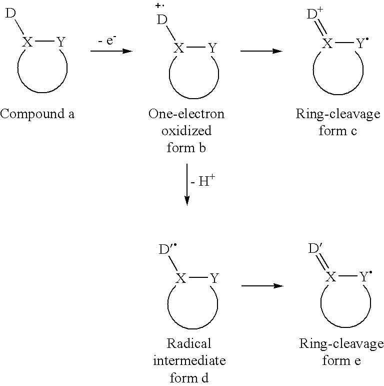

In the formulas, a compound a shows the type 4 compound. In the compound a, D represents a reducing group, while X and Y each independently represent an atom in a ring structure that forms a bond which undergoes cleavage at a one-electron oxidation reaction.

Firstly, the compound a is subjected to a one-electron oxidation reaction to produce a one-electron oxidized form b thereof. From this step, a single bond of D-X becomes a double bond and, at the same time, a bond of X—Y is opened to produce a ring-cleavage form c. Alternatively, there is sometimes provided another path in which the one-electron oxidized form b is deprived of a proton to generate a radical intermediate form d and, then, via thus-generated radical intermediate form d, a ring-cleavage form body e is generated in the same manner. It is the characteristics of the compound according to the invention that one or more electrons are subsequently released from the thus-generated ring-cleavage form c or e.

A ring structure which the type 4 compound has denotes a 3- to 7-membered carbon ring or a heterocycle, that is, a saturated or unsaturated non-aromatic ring which is a single ring or a condensed ring. The ring structure is preferably a saturated ring structure and more preferably a 3- or 4-membered ring. Examples of such preferable ring structures include a cyclopropane ring, a cyclobutane ring, an oxirane ring, an oxetane ring, an aziridine ring, an azetidine ring, an episulfide ring and a thietane ring whereupon a cyclopropane ring, a cyclobutane ring, an oxirane ring, an oxetane ring and azetidine ring are more preferable; and a cyclopropane ring, a cyclobutane ring and an azetidine ring are particularly preferable. Any one of these ring structures may have a substituent.

The compound of type 4 is preferably represented by formula (E) or (F).

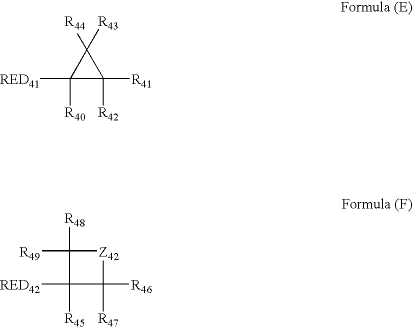

In formulae (E) and (F), RED₄₁ and RED₄₂ each represent a group similarly defined to RED₁₂ in formula (B), and the preferable scope thereof is also identical. R₄₀ through R₄₄ and R₄₅ through R₄₉ each represent a hydrogen atom or a substituent. Examples of the substituent include similar substituents which may be carried by RED₁₂.

In formula (F), Z₄₂ represents —CR₄₂₀R₄₂₁—, —NR₄₂₃—, or —O—. R₄₂₀ and R₄₂₁ each represent herein a hydrogen atom or a substituent, and R₄₂₃ represents a hydrogen atom, an alkyl group, an aryl group or a heterocyclic group.

In formula (E), R₄₀ preferably represents a hydrogen atom, an alkyl group, an alkenyl group, an alkynyl group, an aryl group, a heterocyclic group, an alkoxy group, an amino group, an alkylamino group, an arylamino group, a heterocyclic amino group, an alkoxycarbonyl group, an acyl group, a carbamoyl group, a cyano group or a sulfamoyl group, and is more preferably, a hydrogen atom, an alkyl group, an aryl group, a heterocyclic group, an alkoxy group, an alkoxycarbonyl group, an acyl group or a carbamoyl group, particularly preferably, is a hydrogen atom, an alkyl group, an aryl group, a heterocyclic group, an alkoxycarbonyl group or a carbamoyl group.

It is preferred that at least one of R₄₁ through R₄₄ is a donating group, or otherwise that R₄₁ and R₄₂, or R₄₃ and R₄₄ are both electron-attractive groups. It is more preferred that at least one of R₄₁ through R₄₄ is a donating group. It is even more preferred that at least one of R₄₁ through R₄₄ is a donating group, while the groups that are not a donating group among R₄₁ through R₄₄ being a hydrogen atom or an alkyl group.

The donating group herein refers to a hydroxy group, an alkoxy group, an aryloxy group, a mercapto group, an acylamino group, a sulfonylamino group, an active methine group, or a group selected from the group of preferable groups as RED₄₁ and RED₄₂.

Examples of the donating group which may be preferably used include an alkylamino group, an arylamino group, a heterocyclic amino group, a 5-membered aromatic heterocyclic group (which may be either monocyclic or condensed ring) having one nitrogen atom within the ring, a non-aromatic and nitrogen-containing heterocyclic group substituted with a nitrogen atom, and a phenyl group substituted with at least one electron-donating group (The electron-donating group herein represents a hydroxy group, an alkoxy group, an aryloxy group, an amino group, an alkylamino group, an arylamino group, a heterocyclic amino group, or a non-aromatic and nitrogen-containing heterocyclic group substituted with a nitrogen atom).

More preferably, an alkylamino group, an arylamino group, a 5-membered aromatic heterocyclic group having a nitrogen atom within the ring (The aromatic hetero ring herein represents an indole ring, a pyrrole ring or a carbazole ring), or a phenyl group substituted with an electron-donating group (herein particularly represents a phenyl group substituted with 3 or more alkoxy groups, or a phenyl group substituted with a hydroxy group or an alkylamino group or an arylamino group) may be used.

Particularly preferably, an arylamino group, a 5-membered aromatic heterocyclic group having a nitrogen atom within the ring (herein represents a 3-indolyl group), or a phenyl group substituted with an electron-donating group (herein particularly represents a trialkoxyphenyl group, or a phenyl group substituted with an alkylamino group or an arylamino group) may be used.

The electron-attractive group is similar to those exemplified in the above description for the active methine group.

In formula (F), preferable example of R₄₅ is identical to that of R₄₀ in formula (E) as described above.

R₄₆ through R₄₉ are preferably a hydrogen atom, an alkyl group, an alkenyl group, an alkynyl group, an aryl group, a heterocyclic group, a hydroxy group, an alkoxy group, an amino group, an alkylamino group, an arylamino group, a heterocyclic amino group, a mercapto group, an arylthio group, an alkylthio group, an acylamino group or a sulfoneamino group, and more preferably, a hydrogen atom, an alkyl group, an aryl group, a heterocyclic group, an alkoxy group, an alkylamino group, an arylamino group or a heterocyclic amino group.

Particularly preferable R₄₆ through R₄₉ are a hydrogen atom, an alkyl group, an aryl group, a heterocyclic group, an alkylamino group or an arylamino group in the instance of Z₄₂ being a group represented by —CR₄₂₀R₄₂₁—; a hydrogen atom, an alkyl group, an aryl group or a heterocyclic group in the instance of Z₄₂ representing —NR₄₂₃—; or a hydrogen atom, an alkyl group, an aryl group or a heterocyclic group in the instance of Z₄₂ representing —O—.

Z₄₂ is preferably —CR₄₂₀R₄₂₁— or —NR₄₂₃—, and more preferably —NR₄₂₃—.

R₄₂₀ and R₄₂₁ are preferably a hydrogen atom, an alkyl group, an alkenyl group, an alkynyl group, an aryl group, a heterocyclic group, a hydroxy group, an alkoxy group, an amino group, a mercapto group, an acylamino group or a sulfoneamino group, and more preferably, a hydrogen atom, an alkyl group, an aryl group, a heterocyclic group, an alkoxy group or an amino group.

R₄₂₃ preferably represents a hydrogen atom, an alkyl group, an aryl group or an aromatic heterocyclic group, and more preferably, is a methyl group, an ethyl group, an isopropyl group, a t-butyl group, a tamyl group, a benzyl group, a diphenylmethyl group, an allyl group, a phenyl group, a naphthyl group, a 2-pyridyl group, a 4-pyridyl group or a 2-thiazolyl group.

In instances of each group of R₄₀ through R₄₉ and R_{420,} R₄₂₁ and R₄₂₃ is a substituent, it preferably has total carbon number of 40 or less, more preferably total carbon number of 30 or less, and particularly preferably total carbon number of 15 or less, respectively.

In addition, these substituents may bind with each other, or bind to other site (RED₄₁, RED₄₂ or Z₄₂) within the molecule to form a ring.

It is preferred that the compounds of types 1, 3 and 4 in the invention are “a compound having an adsorptive group to silver halide within the molecule” or “a compound having a partial structure of spectral sensitizing dye within the molecule”.

The compounds of types 1, 3 and 4 in the invention are more preferably “a compound having an adsorptive group to silver halide within the molecule”.

The compound of type 2 is “a compound having two or more adsorptive groups to silver halide within the molecule”.

The compounds of types 1 to 4 are still more preferably “a compound having a nitrogen-containing heterocyclic group substituted with two or more mercapto groups as an adsorptive group”.

In the compounds of types 1 to 4 in the invention, the adsorptive group to silver halide refers to a group which directly adsorbs to silver halide, or a group which accelerates the adsorption to silver halide, and specifically, is a mercapto group (or a salt thereof), a thione group (—C(═S)—), a heterocyclic group including at least one atom selected from a nitrogen atom, a sulfur atom, a selenium atom and a tellurium atom, a sulfide group, a cationic group, or an ethinyl group.

However, in the compound of type 2 in the invention, a sulfide group is not included as an adsorptive group.

The mercapto group (or a salt thereof) as an adsorptive group means the mercapto group (or a salt thereof) itself, and in addition, more preferably represents a heterocyclic group or aryl group or alkyl group substituted with at least one mercapto group (or a salt thereof).

The heterocyclic group herein is a 5-membered through 7-membered monocyclic or condensed, aromatic or nonaromatic heterocyclic group, and examples thereof include for example, an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like.

Furthermore, it may be a heterocyclic group including a quarternarized nitrogen atom, and in this instance, the substituted mercapto group may dissociate to form a meso ion. Examples of such a heterocyclic group include an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group and the like, and among these, a triazolium ring group (e.g., 1,2,4-triazolium-3-thiolate ring group) is preferred.

Examples of the aryl group include a phenyl group or a naphthyl group.

Examples of the alkyl group include a straight or branched or cyclic alkyl group having 1 to 30 carbon atoms.

When the mercapto group forms a salt, examples of the counter ion include cations such of alkali metal, alkaline earth metal, heavy metal and the like (Li⁺, Na⁺, K⁺, Mg²⁺, Ag⁺, Zn²⁺ and the like), an ammonium ion, a heterocyclic group including a quarternarized nitrogen atom, a phosphonium ion and the like.

Moreover, the mercapto group as an adsorptive group may tautomerize to form a thione group. Specific examples thereof include a thioamide group (herein refers to a —C(═S)—NH— group), and a group including a partial structure of the thioamide group, i.e., a linear or cyclic thioamide group, thioureido group, thiourethane group or dithio carbamate ester group, and the like.

Examples of the cyclic group include a thiazolizine-2-thione group, an oxazolidine-2-thione group, a 2-thiohydantoin group, a rhodanine group, an isorhodanine group, a thiobarbituric acid group, a 2-thioxo-oxazolidine-4-one group and the like.

The thione group as an adsorptive group may also include a linear or cyclic thioamide group, a thioureido group, a thiourethane group, or a dithiocarbamate ester group which can not be tautomerized to a mercapto group (without having a hydrogen atom at α-position of a thione group), in addition to the thione groups resulted from tautomerization of the aforementioned mercapto group.

The heterocyclic group including at least one atom selected from a nitrogen atom, a sulfur atom, a selenium atom and a tellurium atom as an adsorptive group may be a nitrogen-containing heterocyclic group having an —NH— group which can form imino silver (>NAg) as a partial structure, or a heterocyclic group having a “—S—” group or a “—Se—” group or a “—Te—” group or an “═N—” group as a partial structure of the heterocycle, which can coordinate with silver ion through a coordinate bond. Examples of the former include a benzotriazole group, a triazole group, an indazole group, a pyrazole group, a tetrazole group, a benzimidazole group, an imidazole group, a purine group and the like, while examples of the latter include a thiophene group, a thiazole group, an oxazole group, a benzothiazole group, a benzooxazole group, a thiadiazole group, an oxadiazole group, a triazine group, a selenoazole group, a benzselenoazole group, a telluriumazole group, a benztelluriumazole group and the like. The former ones are preferred.

Although the sulfide group as an adsorptive group may include any group having a partial structure of “—S—”, it is preferably a group having a partial structure of alkyl (or alkylene)-S-alkyl (or alkylene), aryl (or arylene)-S-alkyl (or alkylene), aryl (or arylene)-S-aryl (or arylene).

In addition, these sulfide groups may form a cyclic structure, or may be an —S—S— group.

Specific examples of the sulfide group that forms a cyclic structure include groups having a thiorane ring, a 1,3-dithiorane ring or a 1,2-dithiorane ring, a thiane ring, a dithiane ring, a tetrahydro-1,4-thiazine ring (thiomorpholine ring) or the like.

The sulfide group is particularly preferably a group having a partial structure of alkyl (or alkylene)-S-alkyl (or alkylene).

The cationic group as an adsorptive group means a group including a quarternarized nitrogen atom, and specific examples thereof include a group having a nitrogen-containing heterocyclic group including an ammonio group or a quarternarized nitrogen atom.

However, the cationic group never becomes a part of an atomic group which forms a pigment structure (e.g., a cyanine chromophore).

The ammonio group herein may be a trialkylammonio group, a dialkylarylammonio group, an alkyldiarylammonio group or the like, and for example, a benzyldimethylammonio group, a trihexylammonio group, a phenyldiethylammonio group and the like can be exemplified.

Examples of the nitrogen-containing heterocyclic group including a quarternarized nitrogen atom include for example, a pyridinio group, a quinolinio group, an isoquinolinio group, an imidazolio group and the like. A pyridinio group and an imidazolio group are preferred, and in particular, a pyridinio group is preferred.

Although these nitrogen-containing heterocyclic group including a quarternarized nitrogen atom may have an arbitrary substituent, in instances of the pyridinio group and imidazolio group, examples of the substituent preferably include an alkyl group, an aryl group, an acylamino group, a chlor atom, an alkoxycarbonyl group, a carbamoyl group and the like, and in instances of the pyridinio group, the substituent is particularly preferably a phenyl group.

The ethinyl group as an adsorptive group means a —C≡CH group, wherein the hydrogen atom may be substituted.

The aforementioned adsorptive groups may have an arbitrary substituent.

Specific examples of the adsorptive group include those described in JP-A No. 11-95355, pages 4 to 7.

The adsorptive group preferred in the invention is a mercapto-substituted nitrogen-containing heterocyclic group (e.g., 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzthiazole group, 1,5dimethyl-1,2,4-triazolium-3-thiolate group and the like), or a nitrogen-containing heterocyclic group having an —NH— group which can form imino silver (>NAg) as a partial structure of the heterocycle (e.g., benzotriazole group, benzimidazole group, indazole group and the like).

A 5-mercaptotetrazole group, a 3-mercapto-1,2,4-triazole group, and a benzotriazole group are particularly preferred, and a 3-mercapto-1,2,4-triazole group, and a 5-mercaptotetrazole group are most preferred.

Among these compounds, compounds having two or more mercapto groups as a partial structure within the molecule are also particularly preferred.

The mercapto group (—SH) herein may be a thione group in instances in which tautomerization is enabled.

Examples of such a compound may be compounds having two or more adsorptive group including the aforementioned mercapto group or thione group as a partial structure (e.g., ring-forming thioamide group, alkylmercapto group, arylmercapto group, heterocyclic mercapto group and the like) within the molecule, and otherwise, may have one or more adsorptive groups having two or more mercapto groups or thione groups as a partial structure (e.g., dimercapto-substituted nitrogen-containing heterocyclic group) among the adsorptive groups.

Examples of the adsorptive group having two or more mercapto groups as a partial structure (a moiety) (dimercapto-substituted nitrogen-containing heterocyclic group and the like) include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, 2,7-dimercapto-5-methyl-striazolo(1,5-A)-pyrimidine, 2,6,8-trimercaptopurine, 6,8-dimercaptopurine, 3,5,7-trimercapto-s-triazolotriazine, 4,6-dimercaptopyrazolopyrimidine, 2,5-dimercaptoimidazole and the like, and a 2,4-dimercaptopyrimidine group, a 2,4-dimercaptotriazine group and a 3,5-dimercapto-1,2,4-triazole group are particularly preferred.

The adsorptive group may be substituted at any position in formulae (A) through (F) and formulae (1) through (3), however, it is preferred that substitution is executed at RED₁₁, RED₁₂, RED₂ or RED₃ in formulae (A) through (D); at RED₄₁, R₄₁, RED₄₂ or R₄₆ to R₄₈ in formulae (E) and (F); at an arbitrary position other than R₁, R₂, R₁₁, R₁₂, R₃₁, L₁, L₂₁ and L₃₁ in formulae (1) through (3), and moreover, substitution at any position of RED₁₁ through RED₄₂ in all of formulae (A) through (F) is more preferred.

The moiety of the spectral sensitizing dye refers to a group including a chromophore of a spectral sensitizing dye, and may correspond to a residue yielded by removing a hydrogen atom or a substituent from the spectral sensitizing dye compound.

The moiety of the spectral sensitizing dye may be substituted at any position in formulae (A) through (F) and in formulae (1) through (3), however, it is preferred that substitution is executed at RED₁₁, RED₁₂, RED₂ or RED₃ in formulae (A) through (D); at RED₄₁, R₄₁, RED₄₂ or R₄₆ to R₄₈ in formulae (E) and (F); at an arbitrary position other than R₁, R₂, R₁₁, R₁₂, R₃₁, L₁, L₂₁ and L₃₁ in formulae (1) through (3), and moreover, substitution at an position of RED₁₁ through RED₄₂ in all of formulae (A) through (F) is more preferred.

Preferable spectral sensitizing dye is a spectral sensitizing dye which is typically used in color sensitizing techniques, and examples thereof include for example, cyanine pigments, composite cyanine pigments, melocyanine pigments, composite melocyanine pigments, homopolar cyanine pigments, styryl pigments and hemicyanine pigments.

Typical spectral sensitizing dye is disclosed in Research Disclosure, Item 36544, September, 1994.

Persons skilled in the art can synthesize these pigments by any of the procedures described in the above-mentioned Research Disclosure, or F. M. Hamer, The Cyanine dyes and Related Compounds (Interscience Publishers, New York, 1964).

In addition, all pigments described in JP-A No. 11-95355 (U.S. Pat. No. 6,054,260), pages 7 to 14 may entirely apply thereto.

The compounds of types 1 to 4 of the invention are preferably those having total carbon number in the range of 10 to 60. The carbon number is more preferably 10 to 50, still more preferably 11 to 40, and particularly preferably 12 to 30.

The compound of types 1 to 4 of the invention is oxidized at one electron upon light exposure of the silver halide photographic sensitive material as a trigger in which the compound is used, and following the subsequent reaction, additional one electron, or two or more electrons depending on the type are released to perfect the oxidization. The oxidation potential of the first electron is preferably about 1.4 V or less, more preferably 1.0 V or less.

This oxidation potential is preferably 0 V or greater, and more preferably 0.3 V or greater. Therefore, the oxidation potential is preferably about 0 to about 1.4 V, more preferably in the range of about 0.3 to about 1.0 V.

The oxidation potential herein can be measured with a technique of cyclic voltammetry. Specifically, a sample is dissolved in a solution of acetonitrile:water (containing 0.1 M lithium perchlorate)=80%:120% (% by volume), followed by bubbling nitrogen gas for 10 minutes, and thereafter, the oxidation potential is measured using a glass carbon disc as a working electrode, using a platinum wire as a counter electrode, and using a calomel electrode (SCE) as a reference electrode, at 25° C. with the and potential scanning speed of 0.1 V/sec. Oxidation potential for SCE is determined at the peak potential of the cyclic voltammetry wave.

In instances of the compound of types 1 to 4 of the invention being oxidized at one electron, which additionally releases one electron following the subsequent reaction, the oxidation potential in the latter stage is preferably −0.5 V to −2 V, more preferably −0.7 V to 2 V, and even more preferably −0.9 V to −1.6 V.

In instances of the compound of types 1 to 4 of the invention being oxidized at one electron, which additionally releases two or more electrons to be oxidized following the subsequent reaction, the oxidation potential in the latter stage is not particularly limited.

This results from frequently raised difficulties in discrimination through accurate measurement of the oxidation potential in effect, in light of the impossibility of definite discrimination between the oxidation potential of the second electron, and the oxidation potential of the third and the following electrons.

Specific examples of the compound of types 1 to 4 are listed below, however, the invention is not limited thereto.

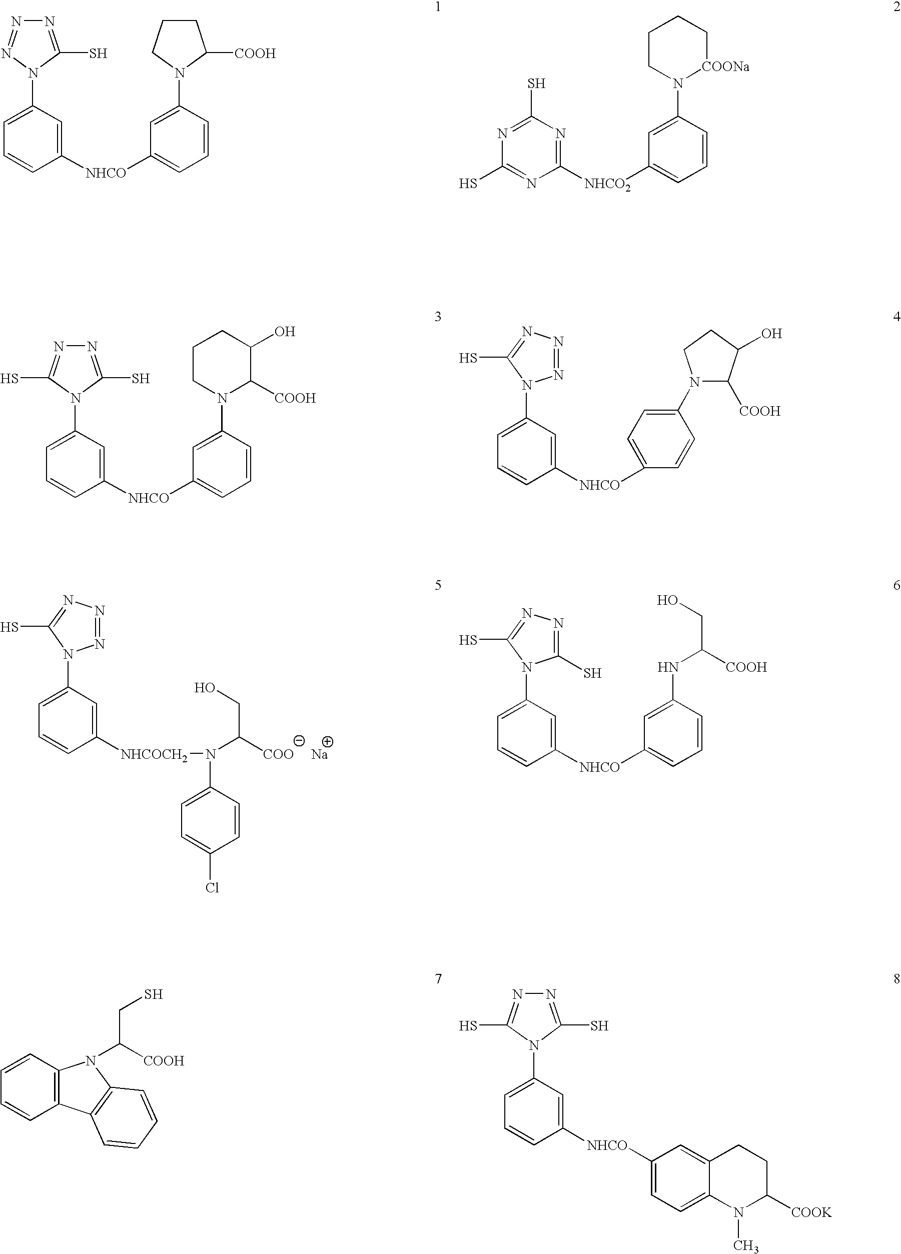

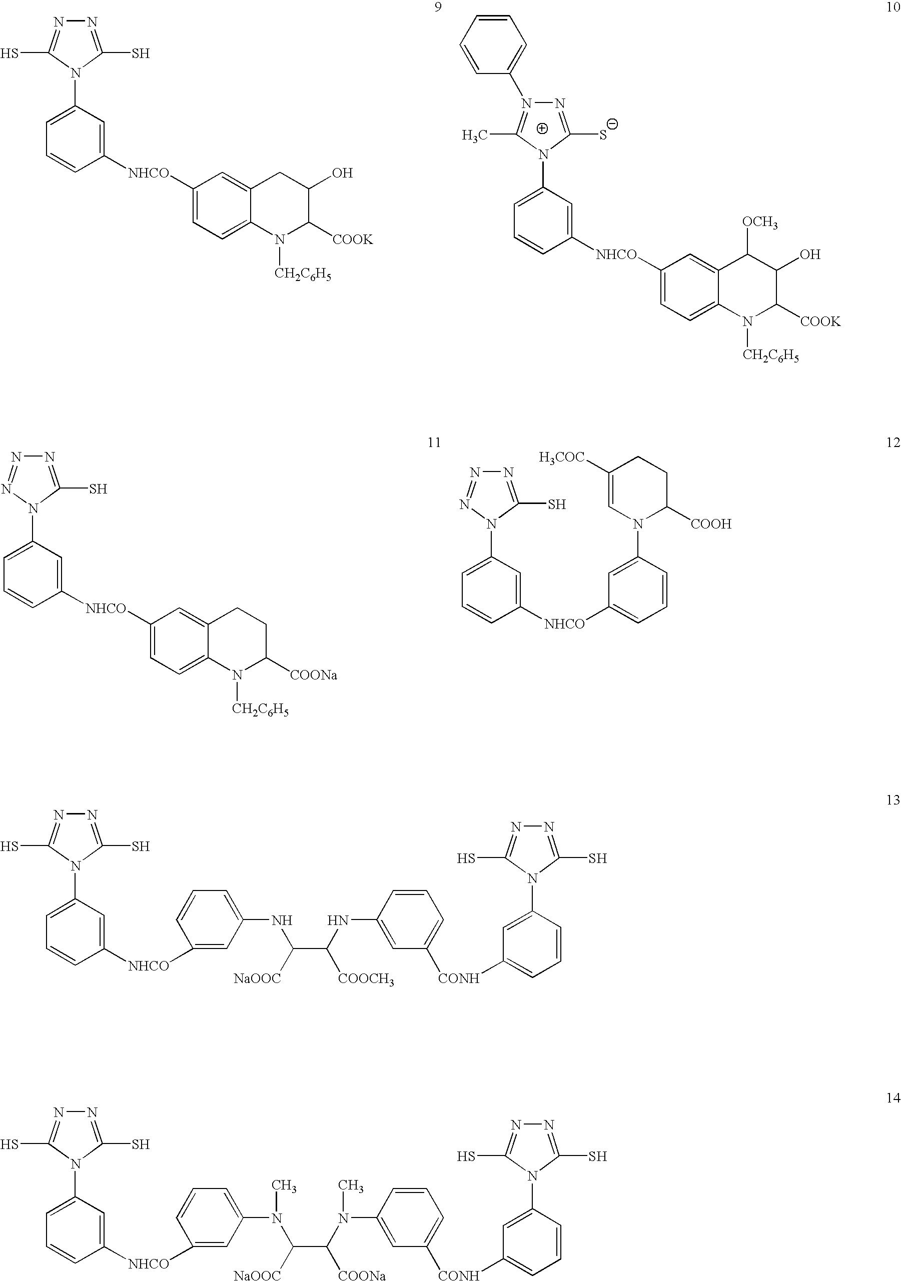

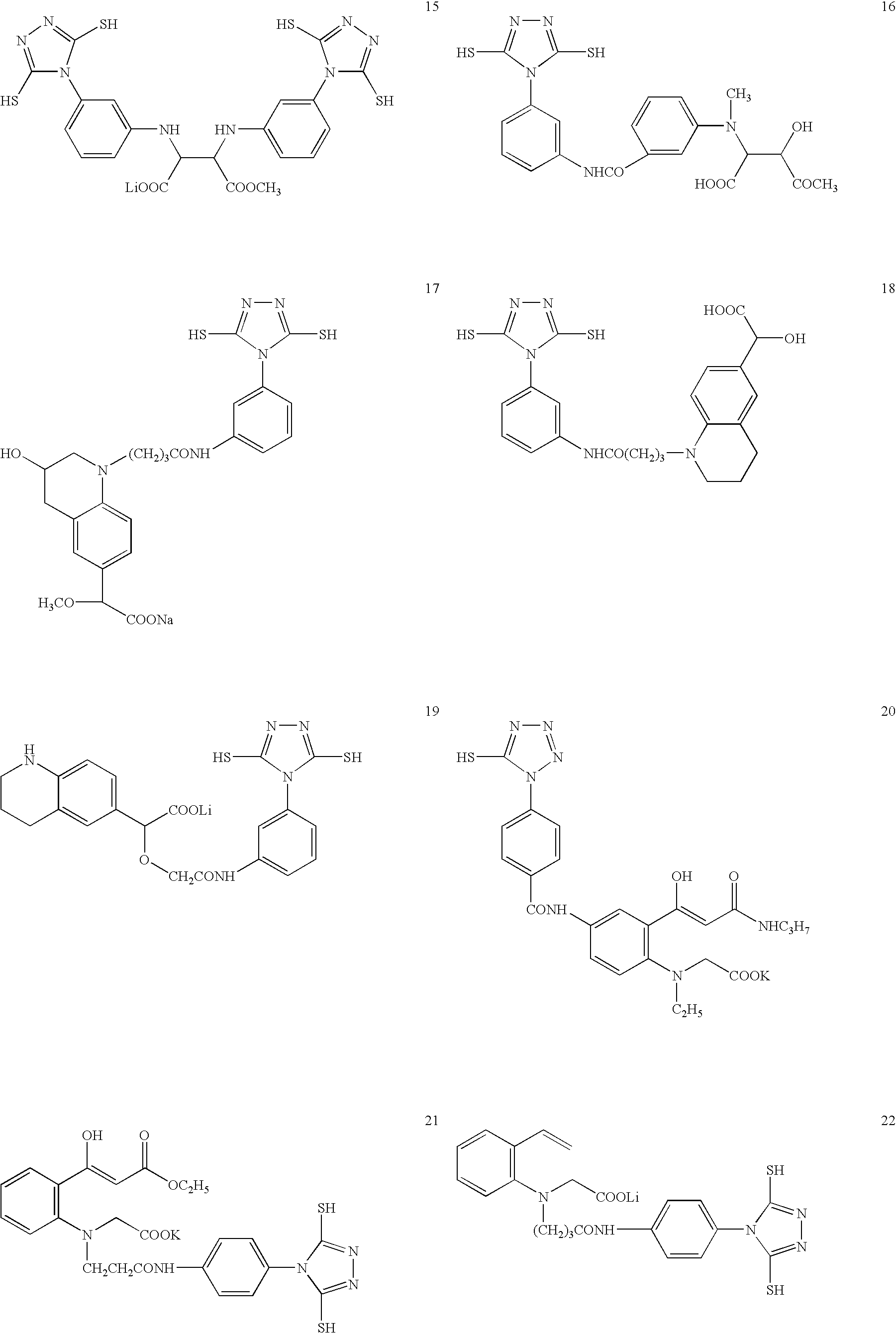

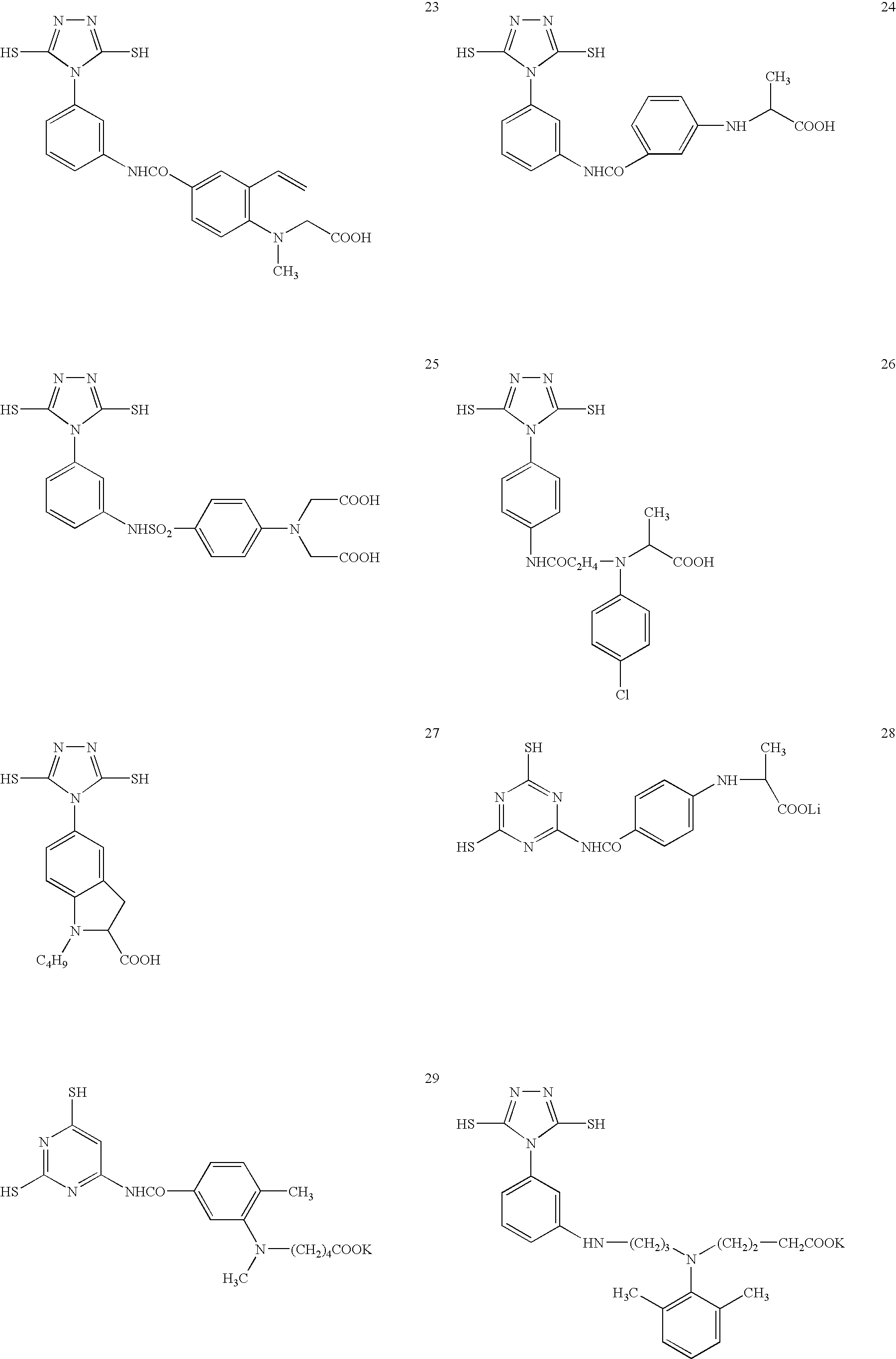

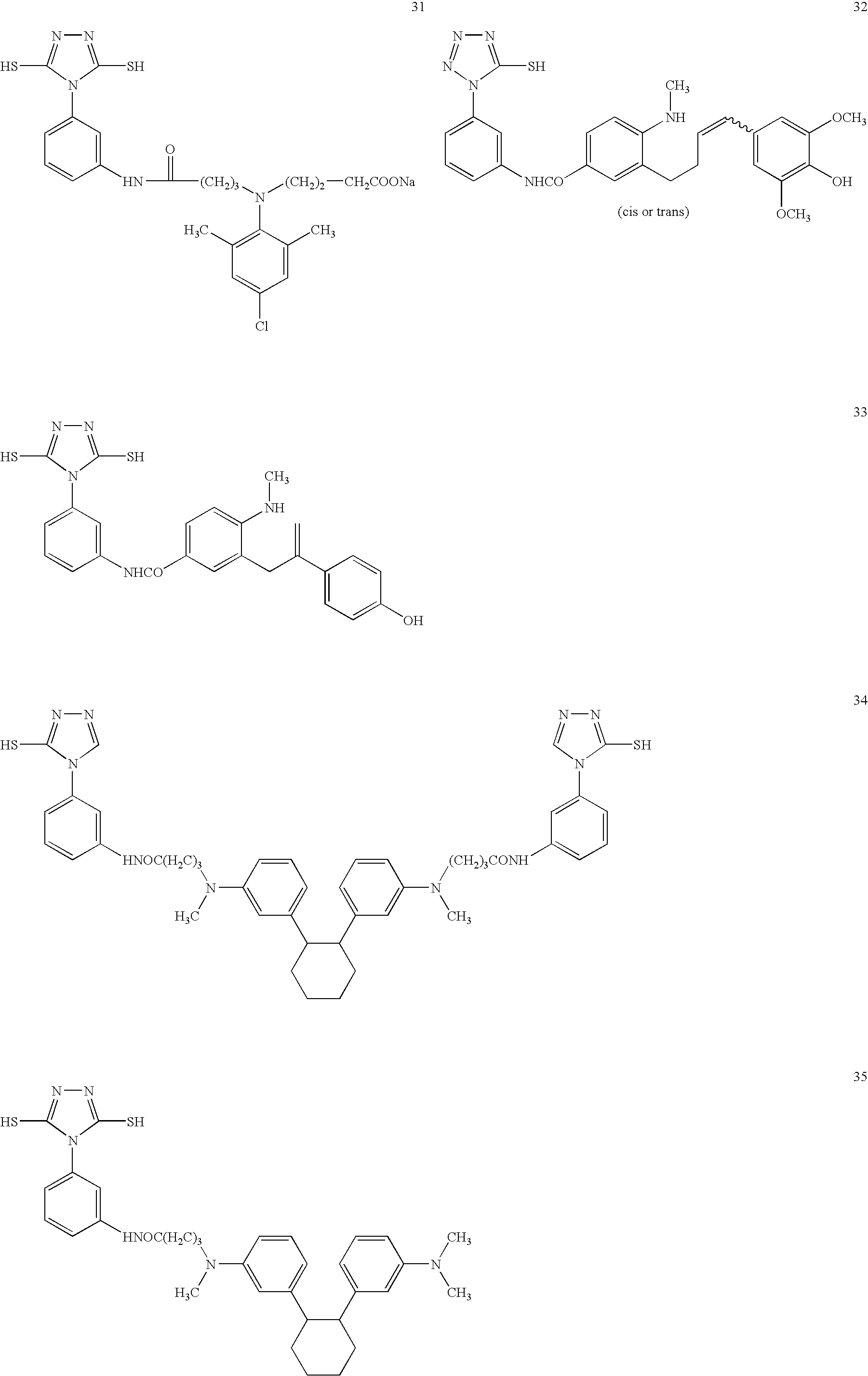

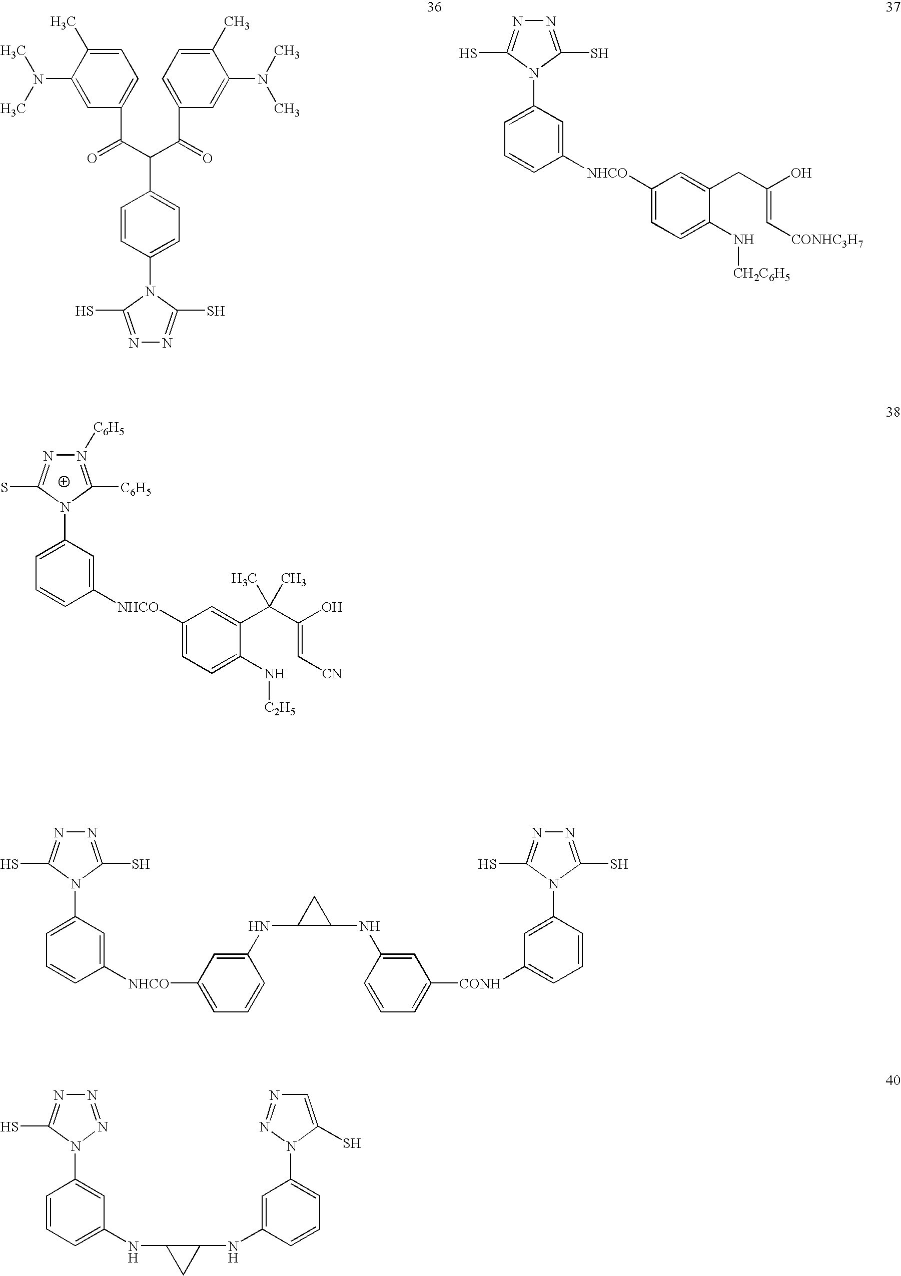

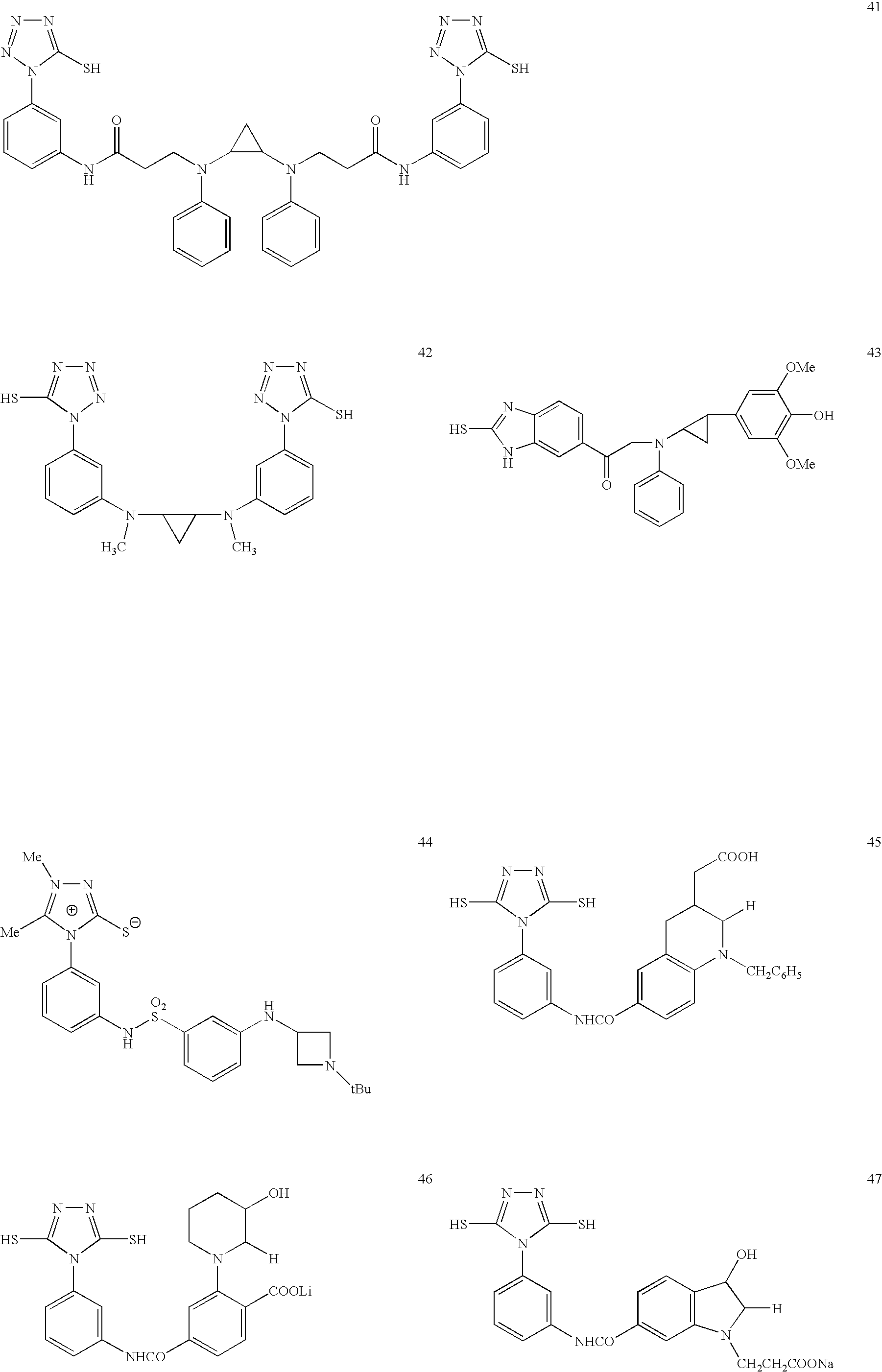

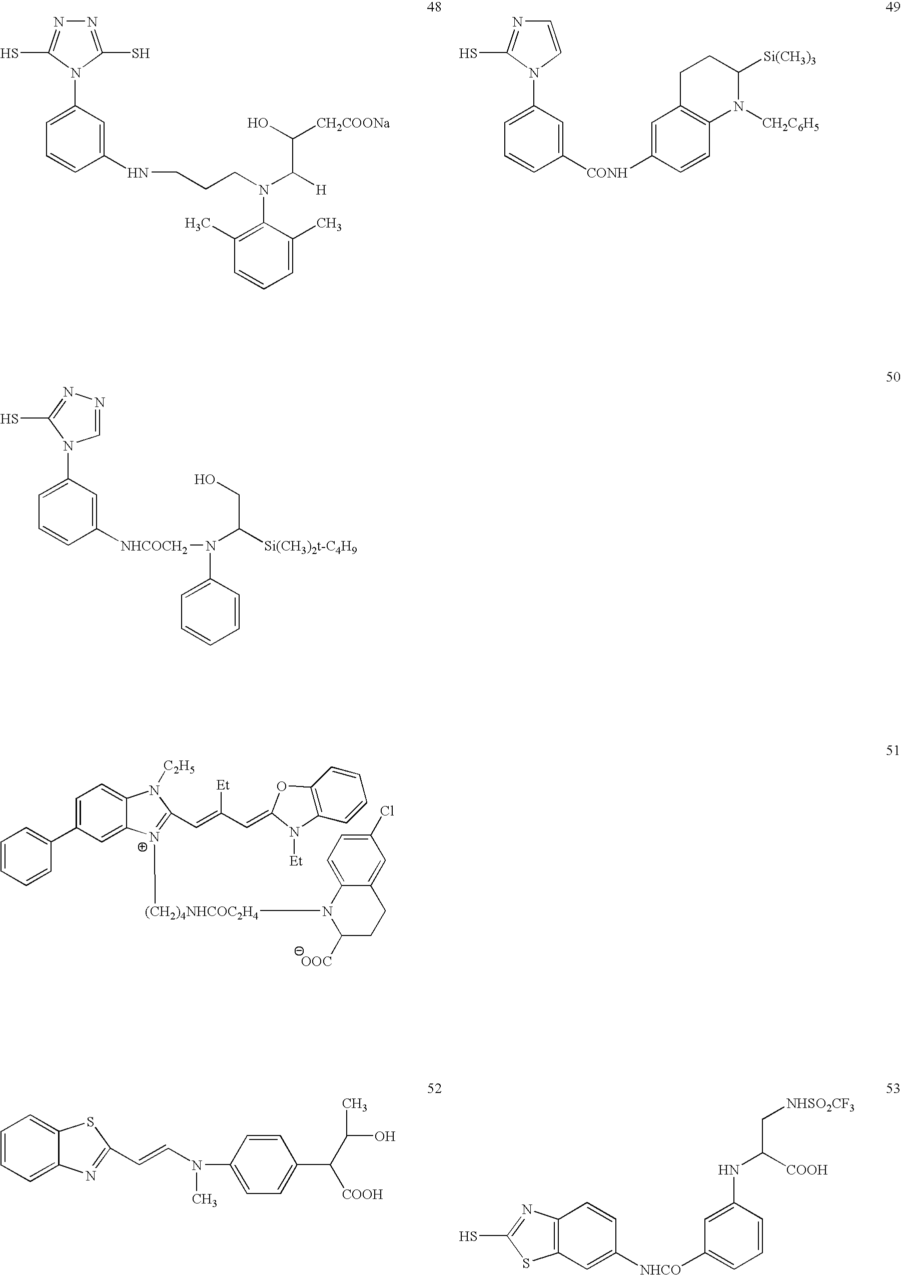

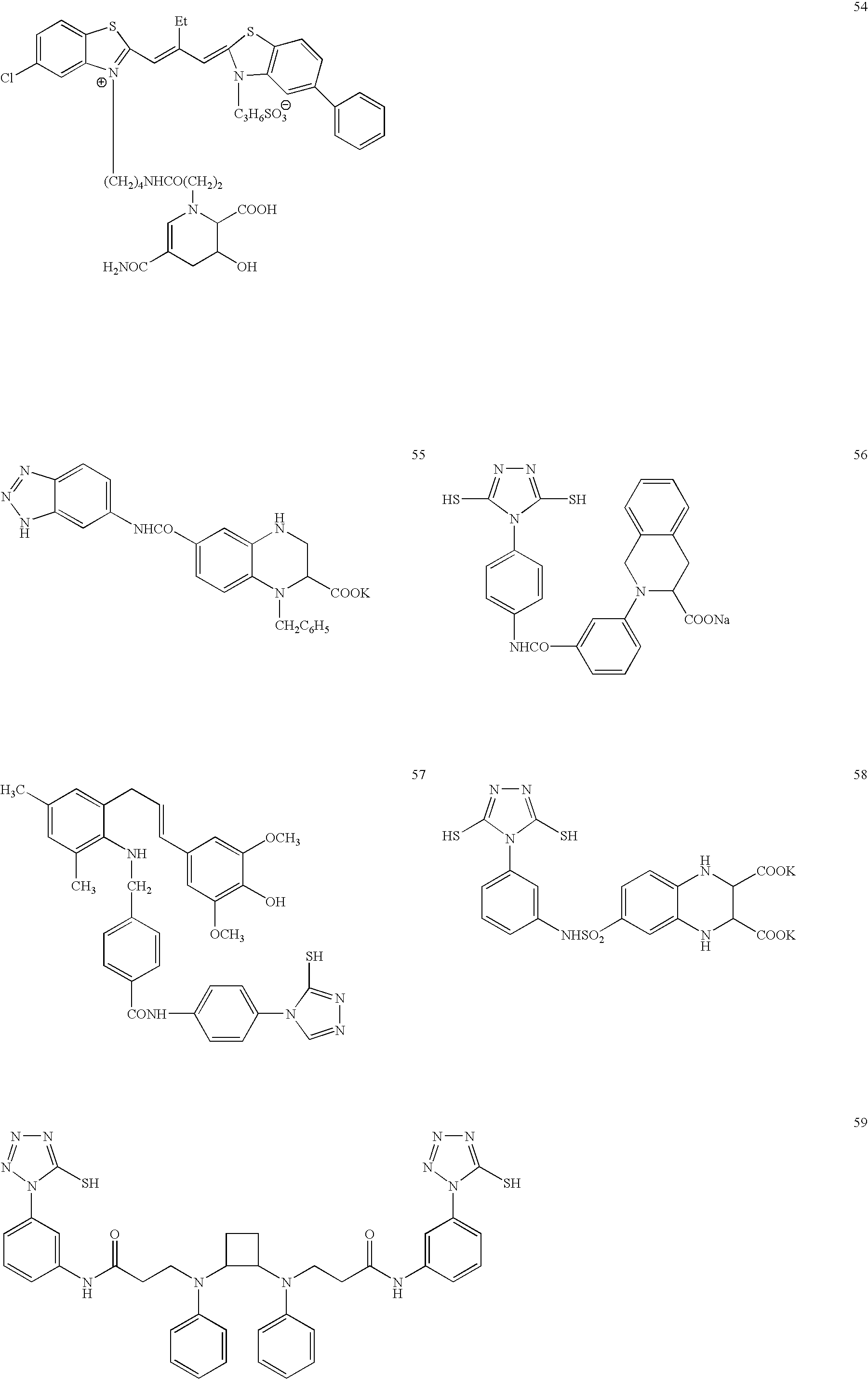

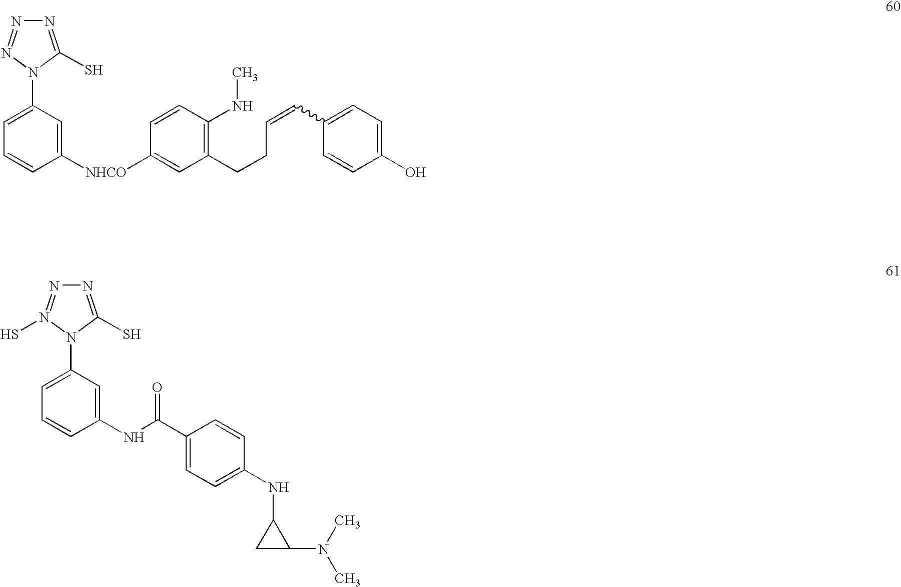

The compounds of types 1 to 4 are similar ones to compounds described in detail in Japanese Patent Application Nos. 2002-192373, 2002-188537, 2002-188536 and 2001-272137, respectively.

Specific exemplary compounds described in the specification of these patent applications are also included as specific examples of the compound of types 1 to 4 in the invention.

Moreover, synthesis examples for compounds of types 1 to 4 of the invention are also similar to those described in these patent applications.

Next, compounds of type 5 are explained.

The type 5 compound denotes a compound which is represented by X—Y, in which X represents a reducing group; and Y represents a leaving group, wherein the reducing group represented by X is one-electron oxidized to produce a one-electron oxidation product and, subsequently, the thus-produced one-electron oxidized product leaves Y to produce X radical through a subsequent X—Y bond cleaving reaction and, thereafter, one more electron can further be released from the thus-generated X radical. The reaction at a time when the compound of the type A is oxidized can be represented by the following formula:

oxidation (−e⁻) bond cleavage one-electron release (−e⁻)

X—Y→(X—Y)^{+·}→X^{·}+Y⁺→X⁺

The compound of type 5 preferably has the oxidation potential of 0 to 1.4 V, more preferably 0.3 V to 1.0 V.

In addition, the oxidation potential of the radical X. produced through the above reaction formula is preferably −0.7 V to −2.0 V, and more preferably −0.9 V to −1.6 V.

The compound of type 5 is preferably represented by formula (G).

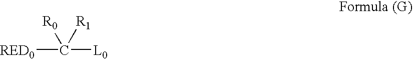

In formula (G), RED₀ represents a reducing group, L₀ represents a leaving group, and R₀ and R₀₀ represent a hydrogen atom or a substituent.

RED₀ and R₀, and R₀ and R₀₀ may bind with each other to form a cyclic structure.

RED₀ represents a group similarly defined to RED₂ in formula (C), and the preferable scope thereof is also identical.

R₀ and R₀₀ are groups similarly defined to R₂, and R₂₂ in formula (C), and the preferable scope thereof is also identical. However, R₀ and R₀₀ never represent a group similarly defined to L₀ except for a hydrogen atom.

RED₀ and R₀ may also bind with each other to form a cyclic structure, and examples of the cyclic structure herein include similar examples in instances of RED₂ and R₂₁ in formula (C) to link and form a cyclic structure, and the preferable scope thereof is also identical.

Examples of the cyclic structure formed by linking of R₀ and R₀₀ with each other include a cyclopentane ring, a tetrahydrofuran ring and the like.

L₀ in formula (G) is a group similarly defined to L₂ in formula (C), and the preferable scope thereof is also identical.

The compound represented by formula (G) preferably has an adsorptive group to silver halide, or a partial structure of a spectral sensitizing dye within the molecule, however, two or more adsorptive groups are never included concomitantly within the molecule when L₀ represents a group other than a silyl group.

However, two or more sulfide groups as the adsorptive group herein may be included irrespective of L₀.

Examples of the adsorptive group to silver halide carried in the compound represented by formula (G) include similar adsorptive groups which may be carried by the compound of types 1 to 4, however, a selenooxo group (—C═Se—), a telluroxo group (—C═Te—), a seleno group (—Se—), a telluro group (—Te—), or an active methine group may be further included in addition thereto.

The selenooxo group (—C═Se—) and the telluroxo group (—C═Te—) herein refer to a Se or Te derivative of the compound having a thione group (—C═S—), and as set forth for the thione group, they may be a group including a selenoamide group (—C═Se—NH—) or a telluriumamide group (—C═Te—NH—).

The seleno group (—Se—) and the telluro group (—Te—) also refer to a Se or Te derivative of the compound having a sulfide group (—S—), and examples thereof equally include Se or Te-substituted forms of the compound having a sulfide group. The active methine group means a methine group substituted with two electron-attractive groups, and the electron-attractive group herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group.

The two electron-attractive groups herein may bind with each other to form a cyclic structure.

The adsorptive group included in the compound represented by formula (G) is preferably a mercapto group (or a salt thereof), a thione group (—C═S—), a heterocyclic group including at least one atom selected from a nitrogen atom, a sulfur atom, a selenium atom and a tellurium atom, or a sulfide group, and more preferably, a mercapto-substituted nitrogen-containing heterocyclic group, or a nitrogen-containing heterocyclic group having an —NH— group which can form imino silver (>NAg) as a partial structure of the heterocycle. These are similar to those explained for the preferable scope of the adsorptive group which may be included in the compound of types 1 to 4.

The adsorptive group may be substituted at any position in formula (G), however, substitution at RED₀ or R₀ is preferred, and substitution at RED₀ is more preferred.

The moiety of a spectral sensitizing dye which may be included in the compound represented by formula (G) is similar to the moiety of the spectral sensitizing dye which may be included in the compound of types 1 to 4 in the invention.

Specific examples of the compound represented by formula (G) are listed below, but not limited thereto.

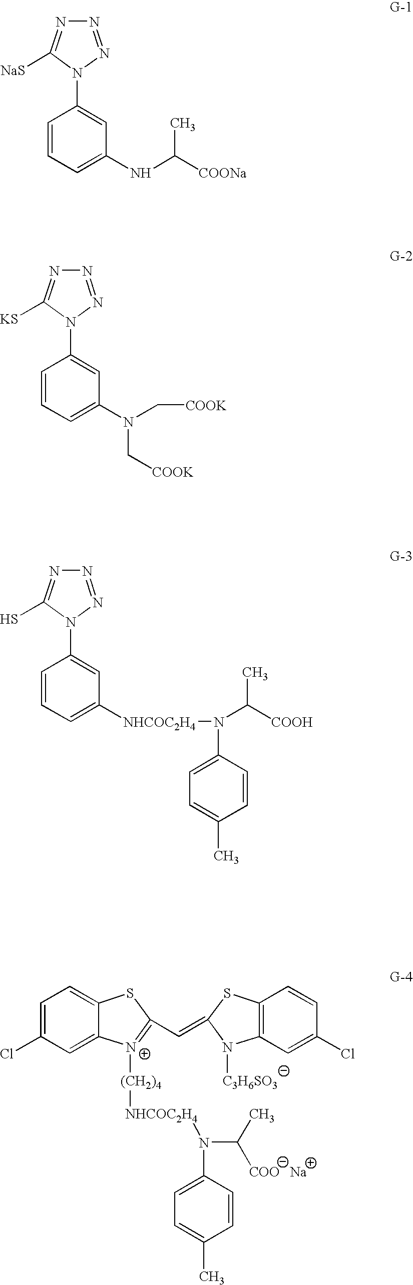

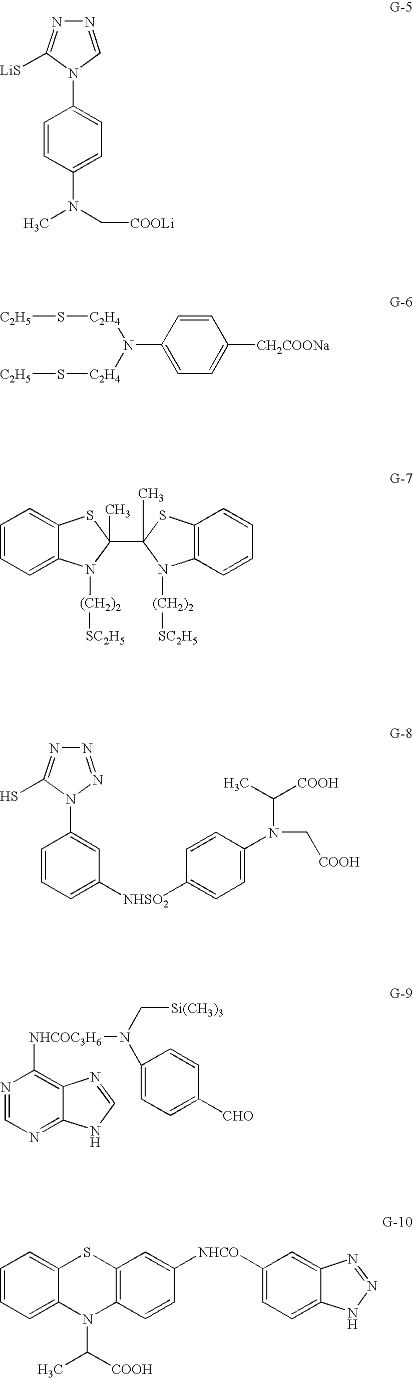

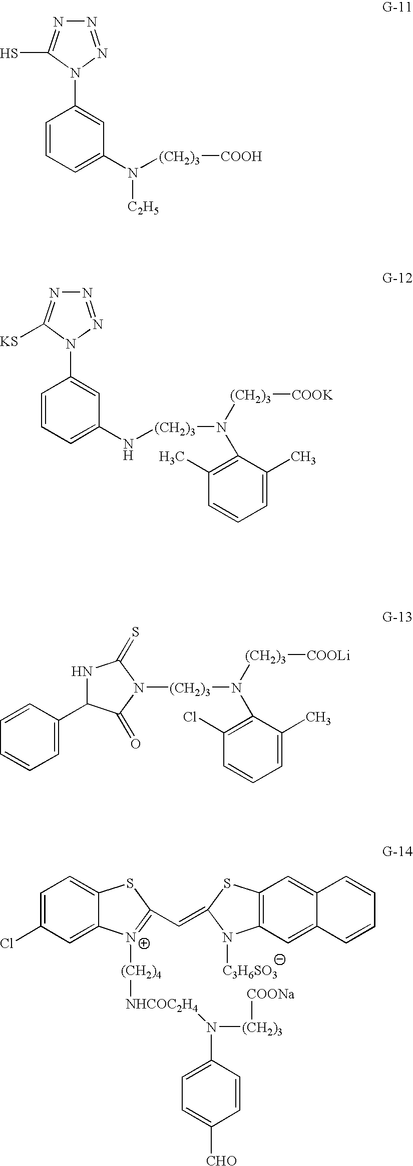

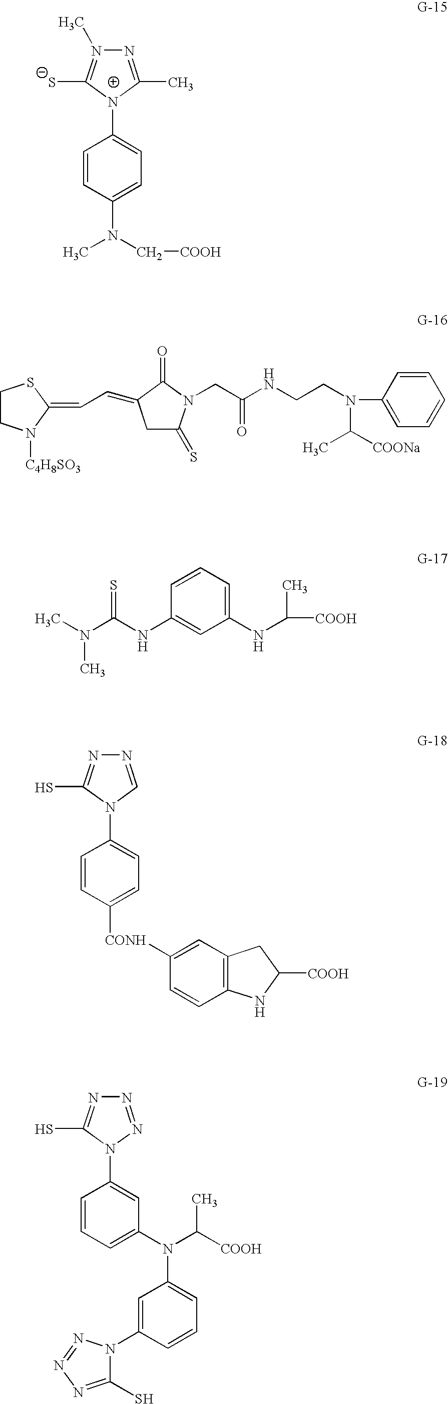

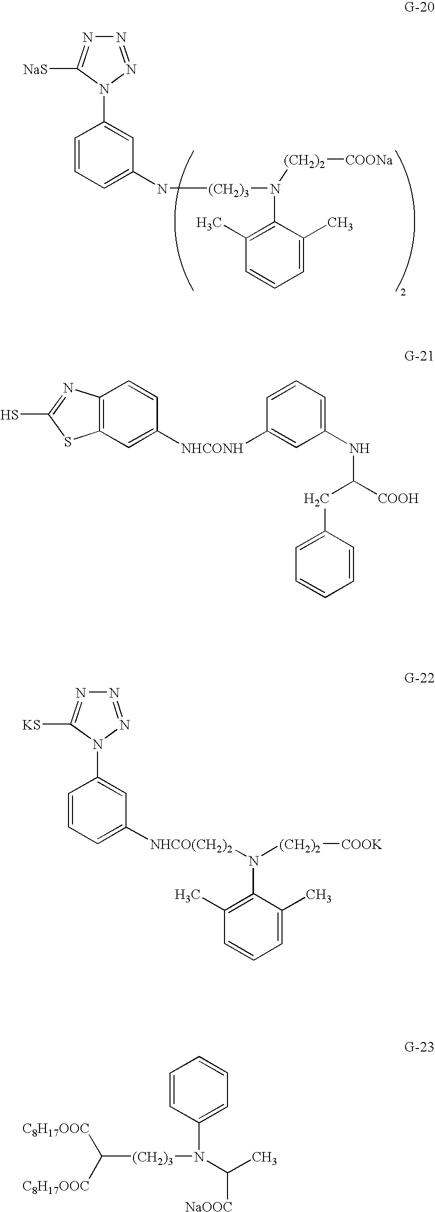

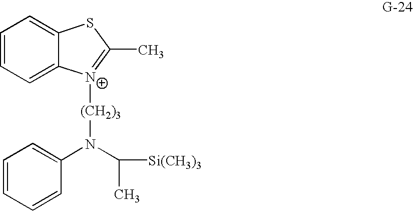

Specific examples of the compound represented by formula (G) further include equally the examples of the compound referred to as “one-photon 2-electron sensitizer” or “deprotonation electron-donating sensitizer” described in JP-A No. 9-211769 (compounds PMT-1 through S-37 described in Table E and Table F in pages 28 to 32), JP-A Nos. 9-211774 and 11-95355 (compounds INV1 through 36), JP-A No. 2001-500996 (compounds 1 through 74, 80 through 87, and 92 through 122), U.S. Pat. Nos. 5,747,235 and 5,747,236, EP No. 786692A1, (compounds INVL through 35), EP No. 893732A1, U.S. Pat. Nos. 6,054,260 and 5,994,051, and the like.

The compound of types 1 to 5 in the invention may be used at any time of preparing the photosensitive silver halide emulsion, or during the manufacture of the photothermographic material. For example, it may be used upon formation of the photosensitive silver halide particles, in the desalting step, upon the chemical sensitization, prior to the coating, or the like. Otherwise, it may be also added through dividing for the addition of more than once during these steps. Time point for the addition is preferably from finish time of forming the photosensitive silver halide particles and prior to the desalting step, upon the chemical sensitization (from just prior to commencement of the chemical sensitization until immediately after its completion), prior to the coating, and more preferably from the chemical sensitization to prior to the mixing with the nonphotosensitive organic silver salt.

It is preferred in the invention that the compound of types 1 to 5 is added after being dissolved in a water-soluble solvent such as water, methanol or ethanol, or in a mixed solvent of these.

When dissolved in water, pH is effectively selected for each of the compound so that greater solubility can be achieved by adjusting the pH to a higher or lower value, and then the solution may be added.

It is preferred in the invention that the compound of types 1 to 5 is incorporated in the image-forming layer which contains the photosensitive silver halide and nonphotosensitive organic silver salt, however, it may be added in the protective layer or the intermediate layer together with the image-forming layer, and may be dispersed upon coating.

The addition of these compounds may be conducted at any time point irrespective of before and after the addition of sensitizing dye, and each may be included in the silver halide emulsion layer preferably at the rate of 1×10⁻⁹ to 5×10⁻¹ mol, more preferably 1×10⁻⁸ to 2×10⁻² mol per 1 mol of silver halide.

11) Sensitizing Dye

The sensitizing dye which may be applied in the invention is one which enables spectral sensitization of the silver halide particles in the desired wavelength range, upon adsorption to the silver halide particle. Sensitizing dye having spectral sensitivity which is suitable for spectral sensitivity suitable for the light source to be used for exposure. It is preferred that the photothermographic material of the invention is spectrally sensitized so that it has the spectral sensitivity peak at 600 nm or greater and 900 nm or less, or 300 nm or greater and 500 nm or less, in particular. The sensitizing dye and method for the addition are described in JP-A No. 11-65021 (paragraphs 0103 to 0109), JP-A No. 10-186572 (compound represented by the general formula (II)), JP-A No. 11-119374 (dye represented by the general formula (I), and paragraph 0106), U.S. Pat. Nos. 5,510,236 and 3,871,887 (dye described in Example 5), JP-A Nos. 2-96131 and 59-48753 (dye disclosed), EP-A No. 0803764A1, page 19, line 38 to page 20, line 35, Japanese Patent Application Nos. 2000-86865, 2000-102560 and 2000-205399, and the like. These sensitizing dyes may be used alone, or may be used in combination of two or more. Timing for adding the sensitizing dye into a silver halide emulsion in the invention is preferably in the time period of after the desalting step and not later than the coating, and more preferably after desaltation and not later than the completion of chemical ripening.

The amount of the sensitizing dye to be added in the invention can be determined to a desired amount in conformity with the sensitivity or fogging performance. However, it is preferably 10⁻⁶ to 1 mol, and more preferably 10⁻⁴ to 10⁻¹ mol per mol of silver halide of the image-forming layer.

A super-sensitizer can be used in order to improve the efficiency of spectral sensitization in the invention. Examples of the super-sensitizer used in the invention include compounds described in EP-A No. 587,338, U.S. Pat. Nos. 3,877,943 and 4,873,184, JP-A Nos. 5-341432, 11-109547 and 10-111543, and the like.

12) Combined Use of Silver Halide

The photosensitive silver halide emulsion in the photothermographic material used in the invention may be single type alone, or otherwise two or more types (for example, those having different mean particle size, those having different halogen composition, those having different crystal habit, those with different conditions of chemical sensitization) may be used in combination. Tone may be controlled by using multiple types of photosensitive silver halide having different sensitivity. Examples of the relevant technique are described in JP-A Nos. 57-119341, 53-106125, 47-3929, 48-55730, 46-5187, 50-73627, 57-150841 and the like. Referring to the difference in sensitivity, it is preferred that difference of 0.2 logE or greater between respective emulsions is provided.

13) Mixing of Silver Halide into Coating Solution

Preferable timing of addition of silver halide into the coating solution for the image-forming layer in the invention may be any time from 180 minutes before throughout just prior to the coating, and preferably 60 minutes before throughout 10 seconds before the coating. However, the mixing method and conditions for the mixing are not particularly limited as long as effects of the invention are sufficiently achieved. Specific examples of the mixing method include a method of mixing in a tank which is set to give desired mean retention time which was calculated from the flow rate of addition and the amount of supplied liquid; and a method in which a static mixer or the like is used as described in N. Harnby, M. F. Edwards, A. W. Nienow (translated by Koji Takahashi), “Techniques for liquid mixing” (published by Nikkan Kogyo Shinbun, 1989), chapter 8.

2. Non-Photosensitive Organic Silver Salt

1) Composition

Although the non-photosensitive organic silver salt particles according to the invention (hereinafter, simply referred to as “organic silver salt”) is relatively stable to light, it is a silver salt which forms a silver image upon heating to 80° or higher in the presence of an exposed photocatalyst (such as a latent image of photosensitive silver halide) and a reducing agent.

The organic silver salt may be an optional organic material which includes a source capable of reducing a silver ion. Such nonphotosensitive organic silver salts are described in JP-A Nos. 06-130543, 08-314078, 09-127643 and 10-62899, paragraphs 0048 to 0049, JP-A Nos. 10-94074 and 10-94075, EP-A No. 0803764A1, page 18, line 24 to page 19, line 37, EP-A Nos. 0962812A1 and 1004930A2, JP-A Nos. 11-349591, 2000-7683, 2000-72711, 2000-112057 and 2000-155383.

As the non-photosensitive organic silver salt for use in the invention, a silver salt of an organic acid, in particular, a silver salt of a long chain aliphatic carboxylic acid (having 10 to 30 carbon atoms, preferably 15 to 28 carbon atoms) is preferred. Preferable examples of the silver salt of an organic acid include silver behenate, silver arachidinate, silver stearate, silver oleate, silver laurate, silver caproate, silver myristate, silver palmitate, mixtures thereof and the like. Among these organic silver salts, use of an organic silver salt having the content of silver behenate of 40 mol % or greater and 70 mol % or less is preferred. Remaining organic silver salt may be a silver salt of a long chain aliphatic carboxylic acid, preferably a silver salt of a long chain aliphatic carboxylic acid having 10 to 30 carbon atoms, and particularly preferably a silver salt of a long chain aliphatic carboxylic acid having 15 to 28 carbon atoms.

2) Shape

Although the shape of the organic silver salt is not particularly limited, those of needle crystal having a short axis and a long axis are preferred. Inversely proportional relationship between the size of a crystal particle of a silver salt and the covering properties thereof is well known in the field of silver halide photographic sensitive materials. This relationship is effective also for the photothermographic material in the invention, which implies that when the particles of the organic silver which serve as an image-forming part of the photothermographic material are large in size, the covering properties are lowered thereby reducing the density of resulting image. Therefore, to reduce the size of the organic silver is preferred. According to the invention, the short axis of 0.01 μm to 0.15 μm and the long axis of 0.10 μm to 5.0 μm are preferred; the short axis of 0.01 μm to 0.15 μm and the long axis of 0.10 μm to 4.0 μm are more preferred; and the short axis of 0.01 μm to 0.15 μm and the long axis of 0.10 μm to 4.0 μm are more preferred.

The particle sizes of the organic silver salt preferably have a monodispersed size distribution. In the monodispersed distribution, the standard deviation of the length of the minor axis or major axis of the particles divided by a length value of the minor axis or major axis, respectively, is preferably not more than 100%, more preferably not more than 80%, and still more preferably not more than 50%. The shape of particles of the salt can be determined from an observed image of a dispersion thereof through a transmission electron microscope.

3) Preparation

In the invention, as described for the photosensitive silver halide, it is important that the photosensitive silver halide having been prepared in advance is mixed in the step of preparing the organic silver salt to prepare a dispersion of an organic silver salt containing the silver halide. The organic silver salt is produced by preparing the metal soap of the organic acid alkali through adding an alkali metal salt (e.g., sodium hydroxide, potassium hydroxide or the like) to the organic acid, followed by mixing with a water soluble silver salt (e.g., silver nitrate).

Such a salt-forming step is entirely carried out in an aqueous solvent, and thereafter, the dehydration and drying followed by additional dispersion in a solvent such as MEK are performed. Drying is preferably executed with an airborne flash jet dryer at the oxygen partial pressure of 15 vol % or less, more preferably at 15 vol % or less and 0.01 vol % or greater, and still more preferably at 10 vol % or less and 0.01 vol % or greater.

The organic silver salt may be used in a desired amount, however, the coating amount of silver is preferably 0.1 to 5 g/m², and more preferably 1 to 3 g/m².

3. Antifoggant

Examples of antifoggant, stabilizer and stabilizer precursor which may be used in the invention include the compounds described in JP-A No.10-62899, paragraph 0070, EP-A No. 0803764A1, page 20, line 57 to page 21 line 7, JP-A Nos. 9-281637 and 9-329864, U.S. Pat. Nos. 6,083,681 and 6,083,681, EP No. 1048975. Further, the antifoggant preferably used in the invention is an organic halide, and examples thereof include those disclosed in JP-A No. 11-65021, paragraphs 0111 to 0112. In particular, organic halides represented by the formula (P) in JP-A No. 2000-284399, organic polyhalogen compounds represented by the general formula (II) in JP-A No. 10-339934, and organic polyhalogen compounds described in JP-A Nos. 2001-31644 and 2001-33911 are preferred.

(Polyhalogen Compound)

Preferred organic polyhalogen compounds for use in the invention are specifically explained below.

Preferred polyhalogen compounds are represented by the following formula (H).

Q-(Y)n-C(Z₁)(Z₂)X Formula (H)

In formula (H), Q represents an alkyl group, an aryl group or a heterocyclic group, Y represents a bivalent linking group, n represents 0 or 1, Z₁ and Z₂ represent a halogen atom, and X represents a hydrogen atom or an electron-attractive group.

In formula (H), Q is preferably an aryl group or a heterocyclic group.

In the general formula (H), when Q is a heterocyclic group, a nitrogen-containing heterocyclic group containing 1 or 2 nitrogen atoms is preferred, and a 2-pyridyl group or a 2-quinolyl group is particularly preferred.

In formula (H), when Q is an aryl group, Q preferably represents a phenyl group substituted with an electron-attractive group having Hammett substituent constant up being a positive number. With respect to Hammett substituent constant, reference can be found in the Journal of Medicinal Chemistry, 1973, Vol. 16, No. 11, 1207-1216 and the like. Examples of such an electron-attractive group include a halogen atom (fluorine atom (σp value: 0.06), chlorine atom (σp value: 0.23), bromine atom (σp value: 0.23), iodine atom (σp value: 0.18)), a trihalomethyl group (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic aryl or heterocyclic sulfonyl group (e.g., methanesulfonyl (σp value: 0.72)), an aliphatic aryl or heterocyclic acyl group (e.g., acetyl (σp value: 0.50), benzoyl (σp value: :0.43)), an alkynyl group (e.g., C≡CH (σp value: 0.23)), an aliphatic aryl or heterocyclic oxycarbonyl group (e.g., methoxycarbonyl (σp value: 0.45), phenoxycarbonyl (σp value: 0.44)), a carbamoyl group (σp value: 0.36), a sulfamoyl group (σp value: 0.57), a sulfoxide group, a heterocyclic group, a phosphoryl group and the like. The σp value is preferably in the range of from 0.2 to 2.0, and more preferably in the range of from 0.4 to 1.0. Examples of particularly preferred electron-attractive group include a carbamoyl group, an alkoxycarbonyl group, an alkylsulfonyl group and an alkylphosphoryl group. Of these, a carbamoyl group is most preferred.

X is preferably an electron-attractive group, more preferably a halogen atom, an aliphatic aryl or heterocyclic sulfonyl group, an aliphatic aryl or heterocyclic acyl group, an aliphatic aryl or heterocyclic oxycarbonyl group, a carbamoyl group, or a sulfamoyl group, and particularly preferably is a halogen atom. Among halogen atoms, preferred are a chlorine atom, a bromine atom and an iodine atom, more preferred are a chlorine atom and a bromine atom, and particularly preferred is a bromine atom.

Y represents preferably —C(═O)—, —SO— or —SO₂—, more preferably —C(═O)— or —SO₂—, and particularly preferably —SO₂—.

“n” represents 0 or 1, and preferably 1.

Specific examples of the compound represented by the general formula (H) in the invention are illustrated below.

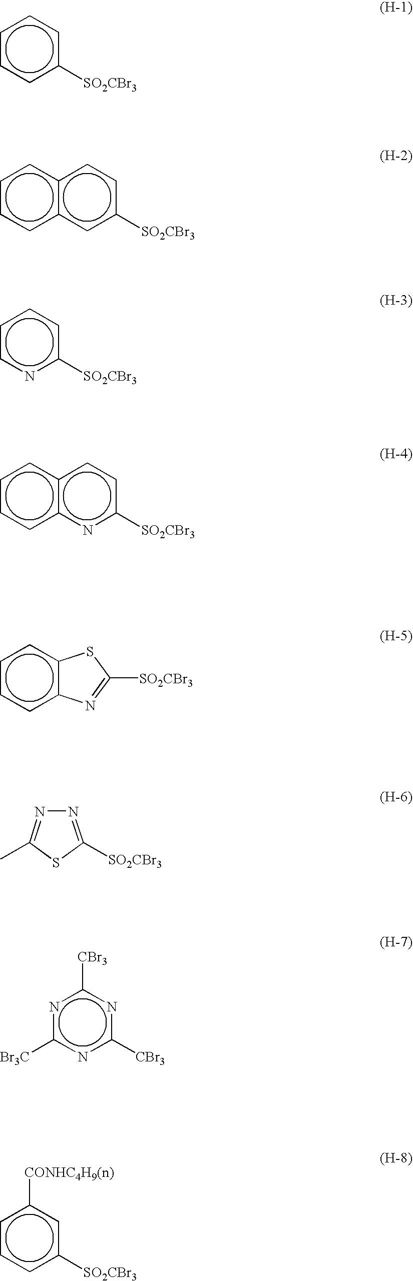

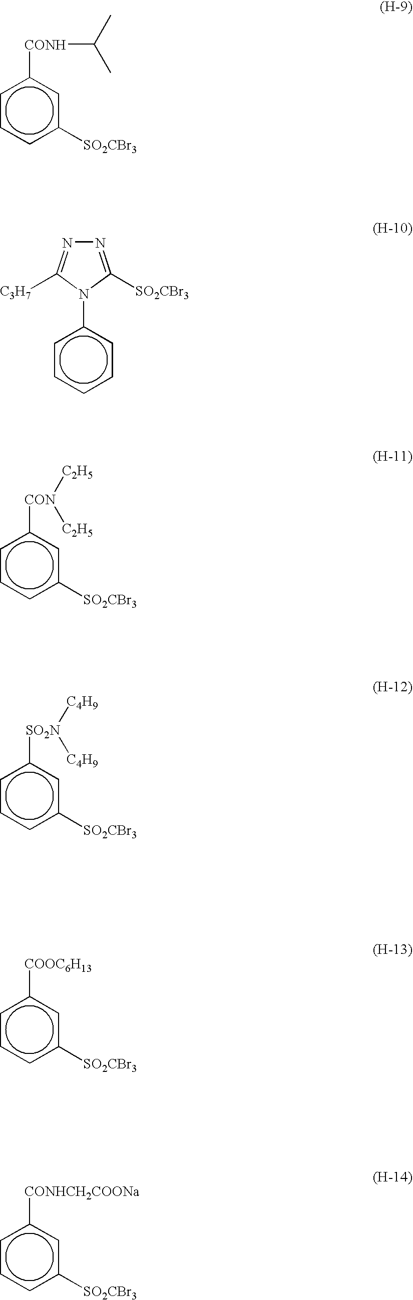

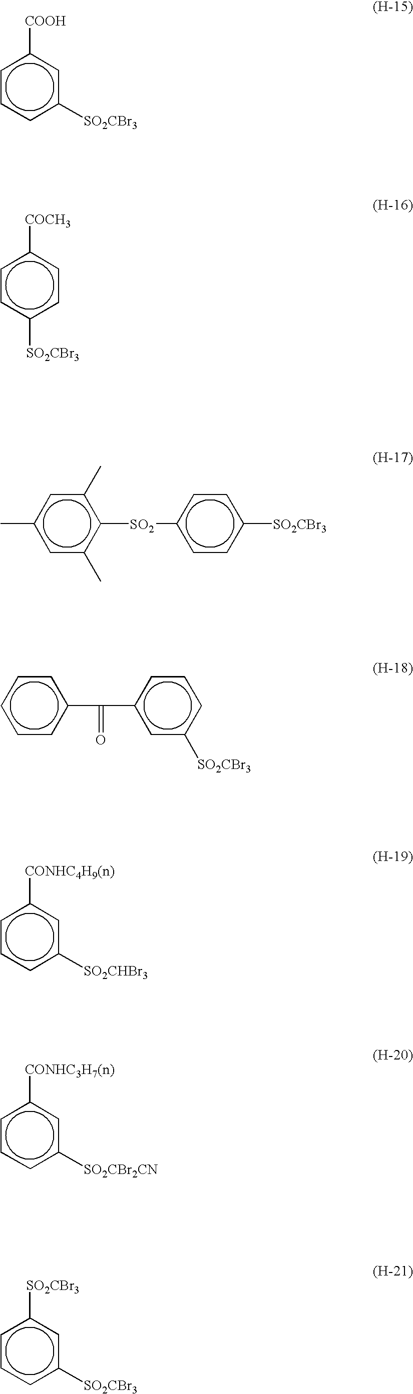

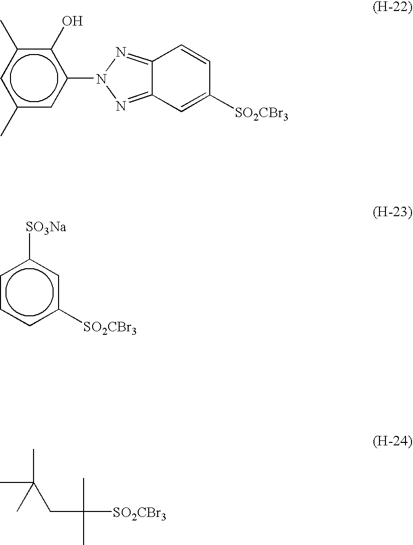

Preferred examples of the polyhalogen compound for use in the invention other than those described above include the compounds described in JP-A Nos. 2001-31644, 2001-56526 and 2001-209145.

The compound represented by formula (H) in the invention is preferably used in the range of 10⁻⁴ to 1 mol per mol of the nonphotosensitive silver salt in the image-forming layer, more preferably in the range of 10⁻³ to 0.5 mol, and even more preferably in the range of 1×10⁻² to 0.2 mol.

In the invention, examples of the method for incorporating the antifoggant in the photosensitive material include the above-described methods described as the method for incorporating the reducing agent. The organic polyhalogen compound is also preferably added in the form of a solid fine particle dispersion.

(Other Antifoggant)

Other antifoggant may include mercury (II) salts in JP-A No. 11-65021, paragraph 0113, benzoic acids in the same publication, paragraph 0114, salicylic acid derivatives in JP-A No.2000-206642, formalin scavenger compounds represented by the formula (S) in JP-A No. 2000-221634, triazine compounds in connection with claim 9 in JP-A No.11-352624, compounds represented by formula (III) in JP-A No. 6-11791, 4-hydroxy-6-methyl-1,3,3a,7-tetrazaindene, and the like.

The photothermographic material according to the invention may contain an azolium salt to prevent fogging. Examples of the azolium salt include compounds represented by formula (XI) in JP-A No. 59-193447, compounds described in JP-B No. 55-12581, compounds represented by the general formula (II) in JP-A No. 60-153039. The azolium salt may be added at any position in the photosensitive material, however, the layer to which this azolium salt is added is preferably a layer in the face having the image-forming layer, and to add to an organic silver salt-containing layer is more preferred. The azolium salt may be added at any time point during any step of preparing the coating solution. When it is added to an organic silver salt-containing layer, it may be added at any step from during preparation of the organic silver salt to during preparation of the coating solution. However, it is preferably added from the time point after preparing the organic silver salt until that immediately before the coating. Addition of the azolium salt may be carried out in any form such as a powder, solution, fine particle dispersion or the like. Furthermore, it may be added in a solution admixed with other additives such as a sensitizing dye, a reducing agent and a toning agent. In the invention, the amount of the azolium salt to be added may be any value, however, it is preferred that 1×10⁻⁵ mol or more and 2 mol or less per 1 mol of silver, and 1×10⁻³ mol or more and 0.5 mol or less per 1 mol of silver is more preferred.

4. Reducing Agent

The photothermographic material of the invention contains a reducing agent for the organic silver salt. The reducing agent may be an arbitrary substance (preferably, organic compound) which can reduce silver ions to a metal silver. Examples of the reducing agent are described in JP-A No. 11-65021, paragraphs 0043 to 0045, or EP No. 0803764, page 7, line 34 to page 18, line 12.

In the invention, so-called hindered phenol-type reducing agent having a substituent at an ortho-position of a phenolic hydroxyl group, or a bisphenol-type reducing agent is preferred, and a bisphenol-type reducing agent is more preferred. In particular, compounds represented by the following formula (R) are preferred.

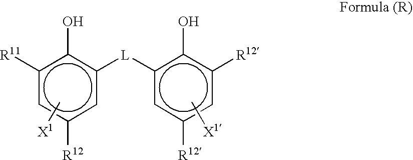

In formula (R), R¹¹ and R^{11′} each independently represent an alkyl group having 1 to 20 carbon atoms. R¹² and R^{12′} each independently represent a hydrogen atom or a substituent which can be substituted with a benzene ring. L represents an —S— group or a —CHR¹³— group. R¹³ represents a hydrogen atom or an alkyl group having 1 to 20 carbon atoms. X¹ and X^{1′} each independently represent a hydrogen atom or a group which may be substituted with a benzene ring.

Each substituent is explained in more detail below.

1) R¹ and R^{1′}

R¹¹ and R^{11′} each independently represent a substituted or unsubstituted alkyl group having 1 to 20 carbon atoms. Although the substituent of the alkyl group is not particularly limited, it is preferably an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, a halogen atom or the like.

2) R¹² and R ^{12′}, X¹ and X^{1′}

R¹² and R^{12′} each independently represent a hydrogen atom or a group which may be substituted with a benzene ring. X¹ and X^{1′} each independently represent a hydrogen atom or a group which can be substituted with a benzene ring. Preferable examples of the group which may be respectively substituted with a benzene ring include an alkyl group, an aryl group, a halogen atom, an alkoxy group and an acylamino group.

3) L

L represents an —S— group or a —CHR¹³— group. R¹³ represents a hydrogen atom or an alkyl group having 1 to 20 carbon atoms, and the alkyl group may have a substituent.

Specific examples of unsubstituted alkyl group represented by R¹³ include a methyl group, an ethyl group, a propyl group, a butyl group, a heptyl group, an undecyl group, an isopropyl group, a 1-ethylpentyl group, a 2,4,4-trimethylpentyl group and the like.

Examples of the substituent of the alkyl group include similar substituents for R¹¹, including a halogen atom, an alkoxy group, an alkylthio group, an alyloxy group, an arylthio group, an acylamino group, a sulfonamide group, a sulfonyl group, a phosphoryl group, an oxycarbonyl group, a carbamoyl group, a sulfamoyl group and the like.

4) Preferable Substituent

R¹¹ and R^{11′} are preferably a secondary or tertiary alkyl group having 3 to 15 carbon atoms, and specific examples thereof include an isopropyl group, an isobutyl group, a t-butyl group, a t-amyl group, a t-octyl group, a cyclohexyl group, a cyclopentyl group, a 1-methylcyclohexyl group, a 1-methylcyclopropyl group and the like. R¹¹ and R^{11′} are more preferably a tertiary alkyl group having 4 to 12 carbon atoms. Among these, a t-butyl group, a t-amyl group and a 1-methylcyclohexyl group are more preferred, and a t-butyl group is most preferred.

R¹² and R^{12′} are preferably an alkyl group having 1 to 20 carbon atoms, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group and the like. More preferred are a methyl group, an ethyl group, a propyl group, an isopropyl group and a t-butyl group.

X¹ and X^{1′} are preferably a hydrogen atom, a halogen atom or an alkyl group, and more preferably a hydrogen atom.

L is preferably a —CHR¹³— group.

R¹³ is preferably a hydrogen atom or an alkyl group having 1 to 15 carbon atoms. The alkyl group is preferably a methyl group, an ethyl group, a propyl group, an isopropyl group or a 2,4,4-trimethylpentyl group. R¹³ is particularly preferably a hydrogen atom, a methyl group, a propyl group or an isopropyl group.

When R¹³ is a hydrogen atom, R¹² and R^{12′} are preferably an alkyl group having 2 to 5 carbon atoms, more preferably an ethyl group or a propyl group, and most preferably an ethyl group.

When R¹³ is a primary or secondary alkyl group having 1 to 8 carbon atoms, R¹² and R^{12′} are preferably a methyl group. The primary or secondary alkyl group having 1 to 8 carbon atoms represented by R¹³ is more preferably a methyl group, an ethyl group, a propyl group or an isopropyl group, and still more preferably a methyl group, an ethyl group or a propyl group.

When all of R¹¹, R^{11′} and R¹², R^{12′} are a methyl group, R¹³ is preferably a secondary alkyl group. In this instance, the secondary alkyl group represented by R¹³ is preferably an isopropyl group, an isobutyl group or a 1-ethylpentyl group, and more preferably an isopropyl group.

The aforementioned reducing agents exert a variety of thermally developing poperties depending on the combination of R¹¹, R^{11′} and R¹², R^{12′}, and R¹³. These thermally developing properties may be adjusted using two or more reducing agents in combination at various mixing ratio, therefore, a combined use of two or more reducing agents is preferred depending on the purposes.

Specific examples of the compound represented by formula (R) in the invention are listed below, however, the invention is not limited thereto.

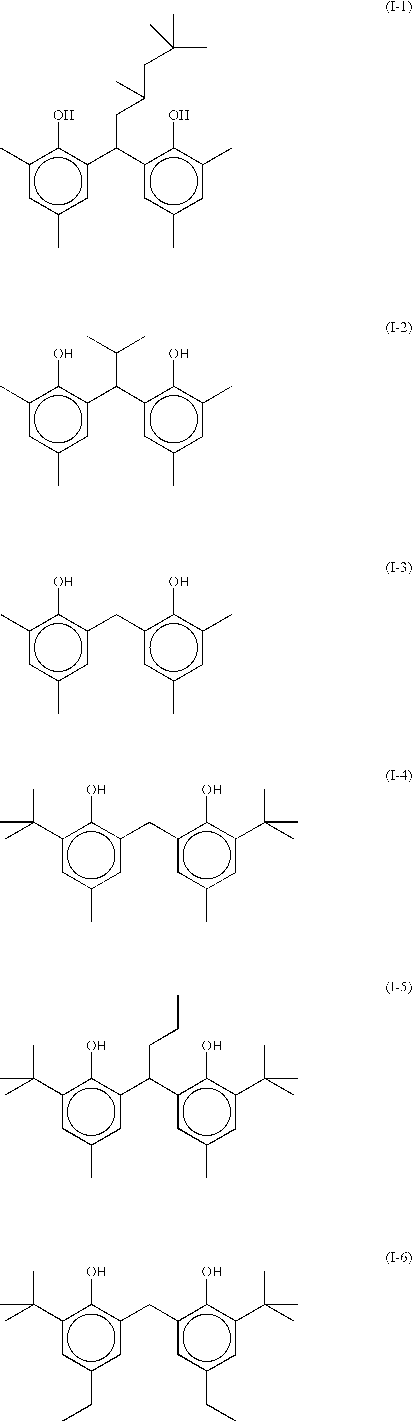

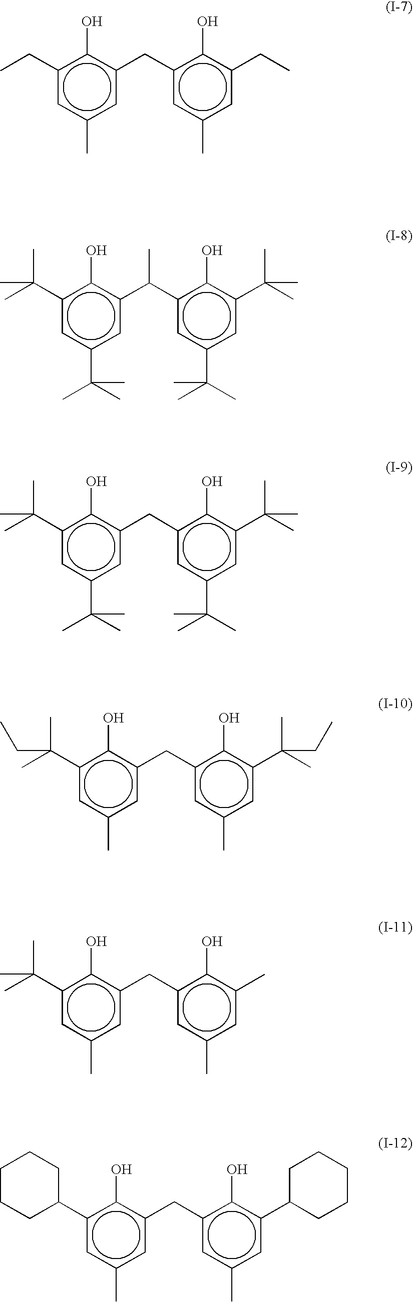

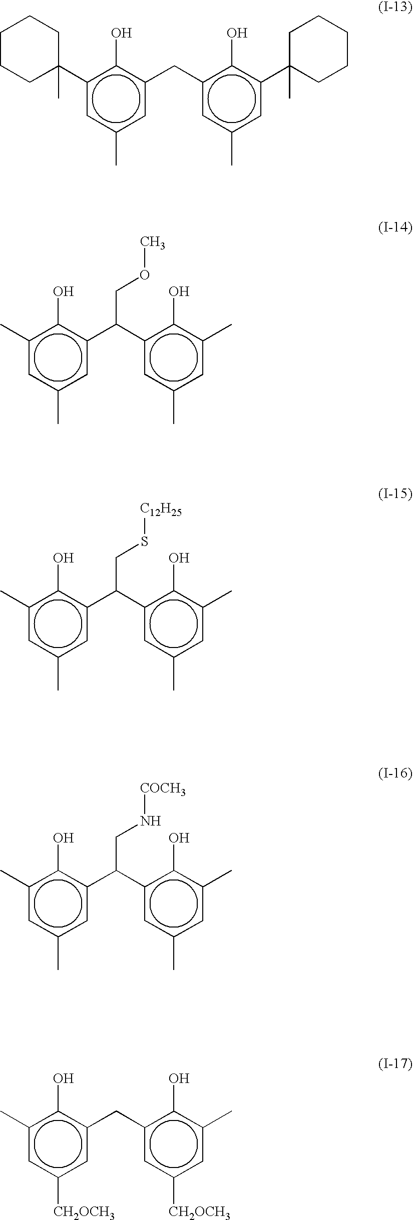

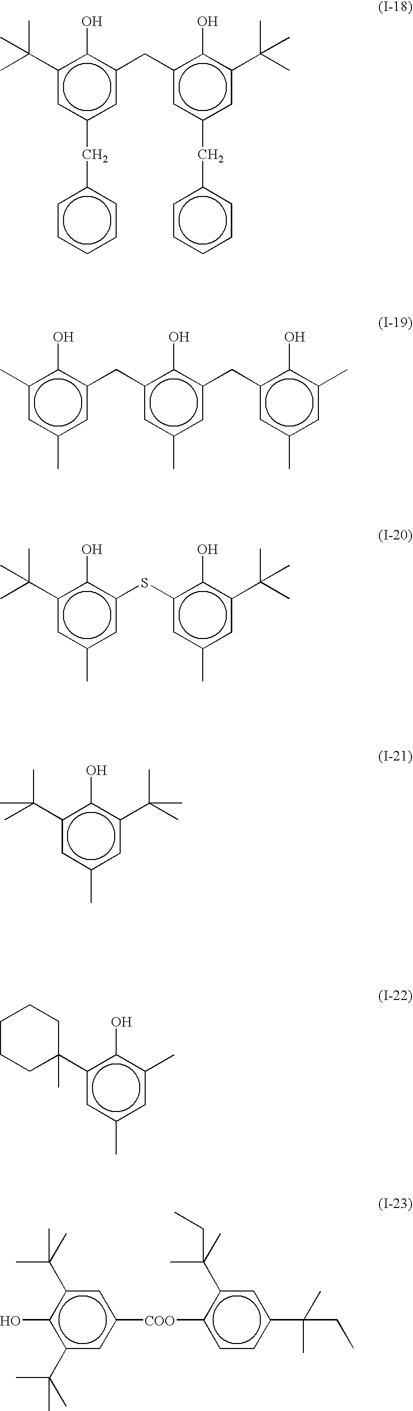

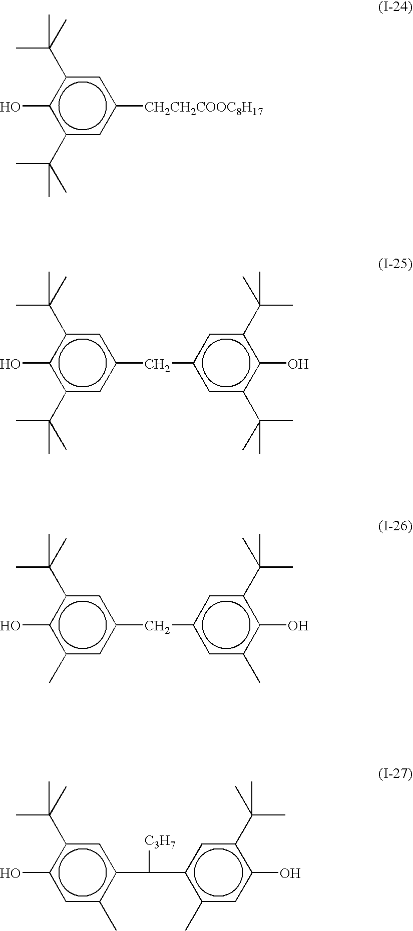

The addition amount of the reducing agent in the invention is preferably 0.01 to 5.0 g/m², and more preferably 0.1 to 3.0 g/m². The reducing agent is preferably included in an amount of preferably 5 to 50 mol %, and more preferably 10 to 40 mol % per mol of silver in the face having the image-forming layer.

The reducing agent in the invention may be contained in the image-forming layer that includes the organic silver salt and the photosensitive silver halide, as well as any adjacent layer thereto, however, it is more preferably contaained in the image-forming layer.

The reducing agent in the invention may be incorporated in the coating solution for producing the photosensitive material by any form such as a solution form, an emulsion-dispersed form or a solid fine particle dispersion form. The solution form in which the reducing agent is dissolved in a solvent for coating to produce the photosensitive material is preferred.

5. Development Accelerator

To the photothermographic material of the invention is preferably added a development accelerator. Preferable examples of the development accelerator include sulfonamide phenolic compounds represented by formula (A) described in JP-A Nos. 2000-267222, 2000-330234 and the like, hindered phenol-type compounds represented by formula (II) described in JP-A No. 2001-92075, hydrazine-based compounds represented by formula (I) described in JP-A Nos. 10-62895, 11-15116 and the like, compounds represented by formula (1) described in Japanese Patent Application No. 2001-074278, and phenolic or naphtholic compounds represented by formula (2) described in JP-A No. 2001-264929. Any of these development accelerators is used in the range of 0.1 to 20 mol % relative to the reducing agent, preferably in the range of 0.5 to 10 mol %, and more preferably in the range of 1 to 5 mol %. The method for introduction of the development accelerator into the photosensitive material may be similar to those for the reducing agent, however, addition thereof in the form of a solution is particularly preferable.

In the invention, hydrazin-based compounds represented by formula (1) described in Japanese Patent Application No. 2001-074278, and naphthol-type compounds represented by formula (2) described in JP-A No. 2001-264929 are particularly preferred among the aforementioned development accelerators.

Specific examples of the development accelerator for use in the invention are listed below, however, the invention is not limited thereto.

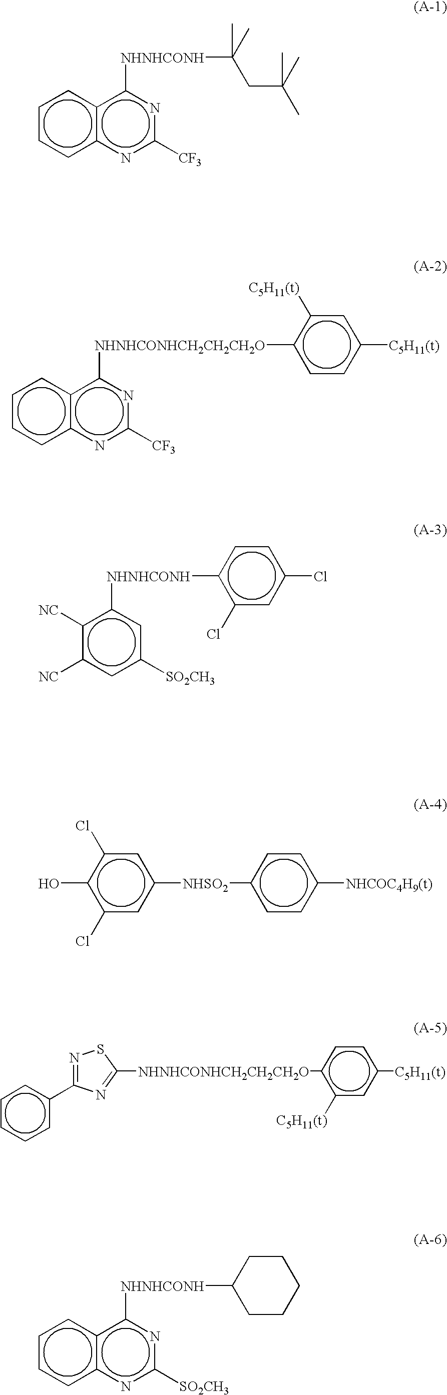

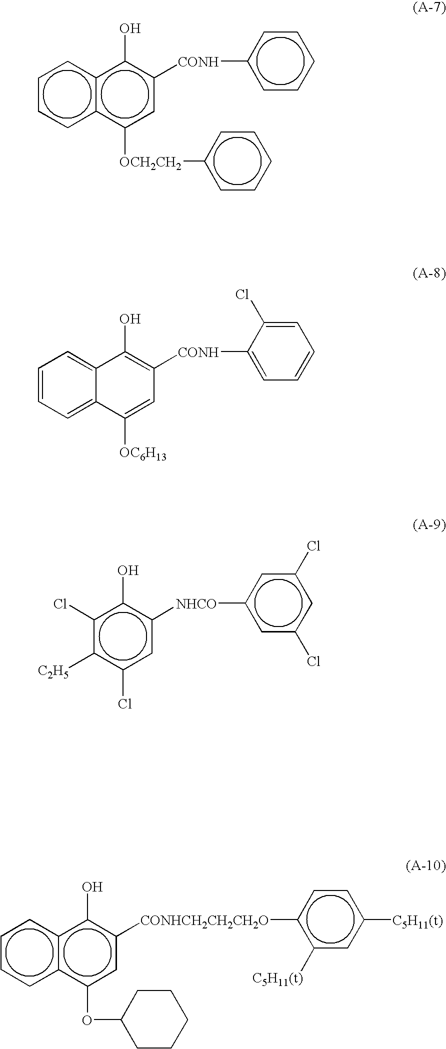

6. Hydrogen Bond-Forming Compound

In the invention, it is preferable to simultaneously use a non-reducing compound that has a group capable of forming a hydrogen bond through reacting with an aromatic hydroxyl group (—OH) of the reducing agent group. Examples of the group capable of forming a hydrogen bond with a hydroxyl group include a phosphoryl group, a sulfoxide group, a sulfonyl group, a carbonyl group, an amide group, an ester group, an urethane group, an ureido group, a tertiary amino group, a nitrogen-containing aromatic group and the like. Among them, preferred are the compounds having a phosphoryl group, a sulfoxide group, an amide group (not having >N—H group but blocked like >N—Ra, in which Ra is a substituent except H)), an urethane group (not having >N—H group but blocked like >N—Ra, in which Ra is a substituent except H)), an ureido group (not having >N—H group but blocked like >N—Ra, in which Ra is a substituent except H).

In the invention, particularly preferred hydrogen bond-forming compounds are represented by the following formula (J).

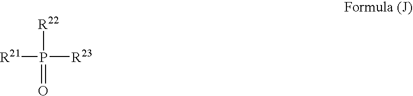

In formula (J), R²¹ to R²³ each independently represent an alkyl group, an aryl group, an alkoxy group, an aryloxy group, an amino group or a heterocyclic group, and these groups may be unsubstituted or may have a substituent. Examples of the substituent when R²¹ to R²³ have a substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, a phosphoryl group and the like. Preferable examples of the substituent include an alkyl group or an aryl group such as e.g., a methyl group, an ethyl group, an isopropyl group, a t-butyl group, a toctyl group, a phenyl group, a 4-alkoxyphenyl group, a 4-acyloxyphenyl group and the like.

Specific examples of the alkyl group of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, a 2-phenoxypropyl group and the like. Examples of the aryl group include a phenyl group, a cresyl group, a xylyl group, a naphthyl group, a 4-t-butylphenyl group, a 4-t-octylphenyl group, a 4-anisidyl group, a 3,5-dichlorophenyl group and the like. Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like. Examples of the aryloxy group include a phenoxy group, a cresyloxy group, an isopropylphenoxy group, a 4-t-butylphenoxy group, a naphthoxy group, a biphenyloxy group and the like. Examples of the amino group include a dimethylamino group, a diethylamino group, a dibutylamino group, a dioctylamino group, an N-methyl-N-hexylamino group, a dicyclohexylamino group, a diphenylamino group, an N-methyl-N-phenylamino group and the like.

R²¹ to R²³ are preferably an alkyl group, an aryl group, an alkoxy group or an aryloxy group. In light of the effects of the invention, at least one or more of R²¹ to R²³ are preferably an alkyl group or an aryl group, and it is more preferred that two or more of these are an alkyl group or an aryl group. In addition, in view of availability at a low cost, it is preferred that R²¹ to R²³ represent the same group.

Specific examples of the hydrogen bond-forming compound including the compounds of formula (J) for use in the invention are listed below, however, the invention is not limited thereto.

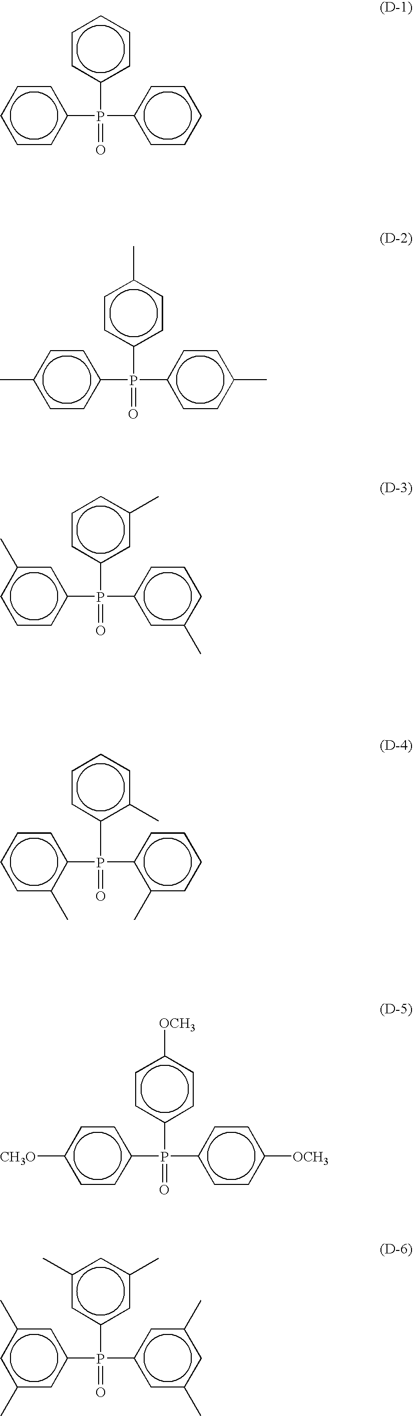

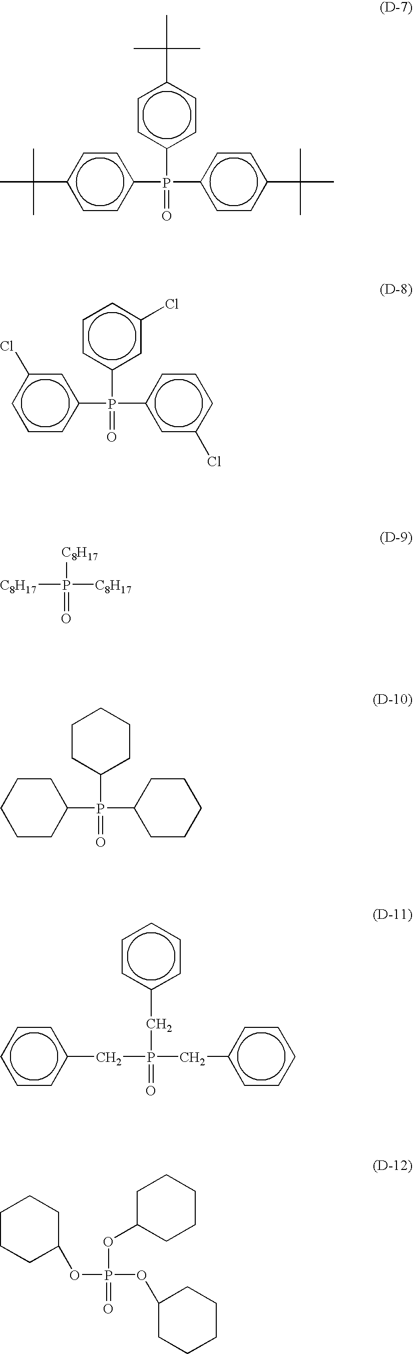

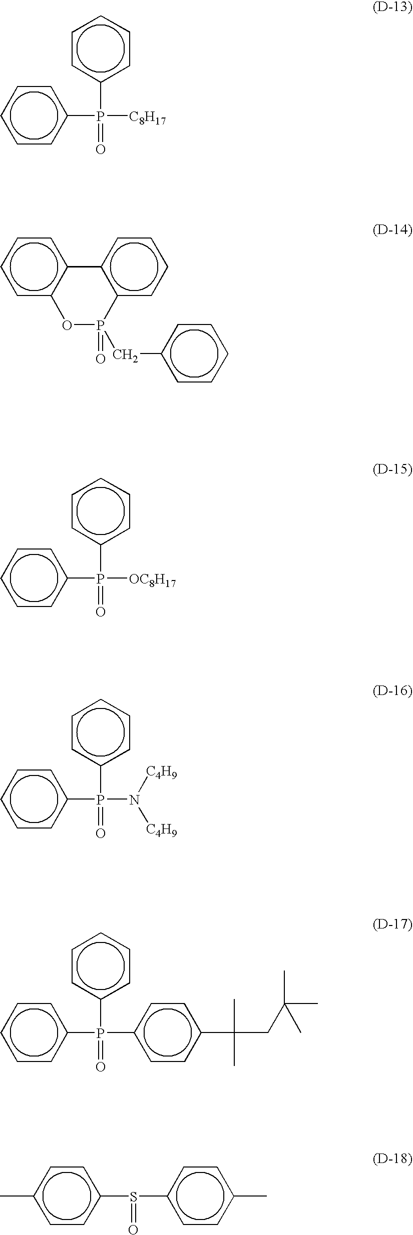

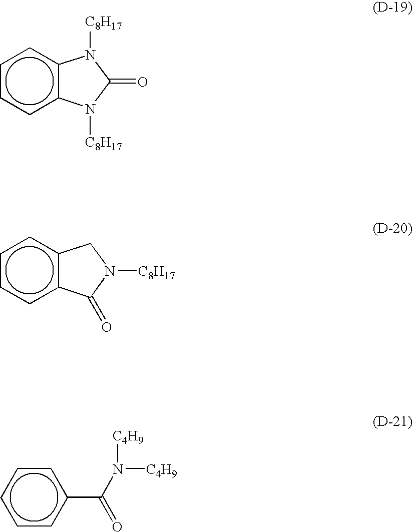

Specific examples of the hydrogen bond-forming compound include those described in EP No. 1096310, Japanese Patent Application Nos. 2000-270498 and 2001-124796 in addition to the aforementioned compounds.

The compound represented by formula (J) used in the invention may be employed in the photosensitive material by being included in a coating solution to have a solution form, an emulsion-dispersed form or a solid dispersed fine particle dispersion form, in a similar manner to the reducing agent. It is preferably used after prepared into a solution form. This compound represented by formula (J) forms a complex with a compound having a phenolic hydroxyl group in a solution form, and hence it may be isolated in the form of crystals as a hydrogen binding complex, depending on the combination of the reducing agent and the compound represented by formula (J). To use the thus isolated crystal powder in the solution form by being dissolved in a coating solvent is particularly preferred to achieve a stable performance.

This compound represented by formula (J) is preferably used in the range of 1 to 200 mol % relaative to the reducing agent, more preferably in the range of 10 to 150 mol %, and still more preferably in the range of 20 to 100 mol %.

7. Binder

Any polymer may be used as the binder for forming the image-forming layer in the photosensitive material of the invention. Suitable binder is transparent or translucent, and usually colorless, and it may include a natural resin, polymer and copolymer, a synthetic resin, polymer and copolymer, as well as a medium capable of forming a film, such as gelatins, rubbers, poly(vinyl alcohols), hydroxyethyl celluloses, cellulose acetates, cellulose acetate butyrates, poly(vinylpyrrolidones), casein, starch, poly(acrylic acids), poly(methylmethacrylic acids), poly(vinyl chlorides), poly(methacrylic acids), styrene-maleic anhydride copolymers, styrene-acrylonitrile copolymers, styrene-butadiene copolymers, poly (vinylacetals) (e.g., poly(vinylformal) and poly(vinylbutyral)), poly(esters), poly(urethanes), phenoxy resins, poly(vinylidene chlorides), poly(epoxides), poly(carbonates), poly(vinyl acetates), poly(olefins), cellulose esters and poly(amides).

The binder may be used in combination of two or more species thereof, as necessary. In such a case, two or more species of the polymer having different glass transition temperature (hereinafter referred to as Tg) may be blended for use.

As used herein, Tg is calculated according to the following equation:

1/Tg=Σ(Xi/Tgi)

Herein, the polymer whose glass transition point Tg is calculated as above comprises n's monomers copolymerized (i indicates the number of the monomers copolymerized, falling between 1 and n); Xi indicates the mass fraction of i'th monomer (ΣXi=1); Tgi indicates the glass transition point (in terms of the absolute temperature) of the homopolymer of i'th monomer alone; and Σ indicates the sum total of i falling between 1 and n. Incidentally, the value of glass transition point (Tgi) of the homopolymer of each monomer alone is adopted from the values described in “Polymer Handbook” (3rd edition) (written by J. Brandrup, E. H. Immergut (Wiley-Interscience, 1989)).

Since the binder is employed in a coating solution using the organic solvent as described below, arbitrary compounds may be used such as polyvinylacetal, polyvinyl chloride, polyvinyl acetate, cellulose acetate, polyolefin, polyester, polystyrene, polyacrylonitrile, polycarbonate, polyvinyl butyral, butylethyl cellulose, methacrylate copolymer, maleic anhydride ester copolymer, polystyrene and butadiene-styrene copolymer and the like. In particular, the image-forming layer preferably includes polyvinyl butyral as a binder. Specifically, polyvinyl butyral is used as the binder in an amount of 50% by weight or more per total components of the binder in the image-forming layer. Copolymer and terpolymer may be included, of course. Preferred total amount of polyvinyl butyral is 50% by weight or more and 100% by weight or less per total components of the binder in the image-forming layer. More preferably, the amount is 70% by weight or greater and 100% by weight or less. Tg of the binder is preferably in the range of 40 to 90° C., and more preferably 50 to 80° C. When two or more types of polymers having different Tg are blended for use, it is preferred that the weight average Tg thereof is in the range described above.

A total amount of the binder for use in the invention is, for example, a sufficient amount to retain the ingredients in the image-forming layer. In other words, it is used in an effective range to act as the binder. Effective range can be determined appropriately by the persons skilled in this art. The ratio of the binder to the organic silver salt to possibly retain the organic silver salt in the layer is preferably 15:1 to 1:3, and particularly preferably 8:1 to 1:2 by mass.

8. Solvent for Coating

Examples of the solvent include those described in New Solvent Pocketbook (Ohmsha, Ltd., published in 1994) and the like, however, the present invention is not limited thereto. Further, a boiling point of the solvent used in the invention is preferably 40° C. or greater and 180° C. or less. Specific examples of the solvent include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methylisobutylketone, cyclohexanone, butyl acetate, diethyl carbonate, chlorobenzene, dibutyl ether, anisole, ethyleneglycol diethyl ether, N,N-dimethylformamide, morpholine, propane sultone, perfluorotributylamine, water and the like. Among them, methyl ethyl ketone is preferably used due to its moderate boiling point, and may provide an homogeneous state of the surface of coated film, with small burden upon drying and lowered residual amount of the solvent.

It is preferable to reduce the amount of the residual solvent used for coating and remained in the film after coated and dried as small as possible. The residual solvent usually volatilizes to the atmospheric environment when the photosensitive material is subjected to light exposure or thermal development, which may lead to unpleasant or unfavorable physical conditions.

In the invention, the amount of residual solvent is preferably 0.1 mg/m² to 150 mg/m², more preferably 0.1 mg/m² to 80 mg/m², and still more preferably 0.1 mg/m² to 40 mg/m².

9. Surfactant

Surfactants which may be applied to the invention are described in JP-A No. 11-65021, paragraph 0132; solvents are described in the same publication, paragraph 0133; supports are described in the same publication, paragraph 0134, antistatic or conductive layers are described in the same publication, paragraph 0135; methods for obtaining color images are described in the same publication, paragraph 0136; slipping agents are described in JP-A No. 11-84573, paragraphs 0061 to 0064 and Japanese Patent Application No. 11-106881, paragraph 0049 to 0062.

In the invention, it is preferred that a fluorine-type surfactant is used. Specific examples of the fluorine-type surfactant include compounds described in JP-A Nos. 10-197985, 2000-19680, 2000-214554 and the like. In addition, fluorine-type macromolecular surfactants described in JP-A No.9-281636 may preferably be used. In the photothermographic material of the invention, use of a fluorine-type surfactant described in JP-A No. 2002-82411, Japanese Patent Application Nos. 2001-242357 and 2001-264110 is preferred. In particular, fluorine-type surfactants described in Japanese Patent Application Nos. 2001-242357 and 2001-264110 are preferred in light of charge-regulating ability, stability of the state of coated surface and slipping properties, in instances of coating and manufacture performed with an aqueous coating solution. Fluorine-type surfactants described in Japanese Patent Application No. 2001-264110 are most preferred from the standpoint of charge-regulating ability, which can provide a lowered use amount.

In the invention, the fluorine-type surfactant may be used on either side of an emulsion surface or a back surface, and to use it on both faces is preferred. Further, a combined use with the aforementioned conductive layer including the metal oxide is particularly preferred. In such a case, sufficient performances may be achieved even if the amount of the fluorine-type surfactant used in the surface having the conductive layer is decreased or obviated.

A preferable use amount of the fluorine-type surfactant is in the range of 0.1 mg/m² to 100 mg/m² for the emulsion surface and the back surface, respectively, more preferably in the range of 0.3 mg/m² to 30 mg/m², and still more preferably in the range of 1 mg/m² to 10 mg/m². In particular, the fluorine-type surfactant described in Japanese Patent Application No. 2001-264110 exerts significant effects, and the amount is preferably in the range of 0.01 to 10 mg/m², and more preferably 0.1 to 5 mg/m².

10. Toning Agent

In the photothermographic material of the invention, a toning agent is preferably incorporated. The toning agent is described in, for example, JP-A No. 10-62899, paragraphs 0054 to 0055, EP No. 0803764A1, p.21, lines 23 to 48, JP-A No. 2000-356317 and Japanese Patent Application No. 2000-187298. Particularly preferred are phthalazinones (phthalazinone, phthalazinone derivatives or metal salts; for example, 4-(1-naphthyl) phthalazinone, 6-chloro phthalazinone, 5,7-dimethoxy phthalazinone and 2,3-dihydro-1,4-phthalazinone); combination of phthalazinones and phthalic acids (e.g., phthalic acid, 4-methylphthalic acid, 4-nitrophthalic acid, diammonium phthalate, sodium phthalate, potassium phthalate and tetrachlorophthalic anhydride); phthalazines (phthalazine, phthalazine derivatives or metal salts; for example, 4-(1-naphthyl)phthalazine, 6-isopropylphthalazine, 6-t-butylphthalazine, 6-chlorophthalazine, 5,7-dimethoxyphthalazine, and 2,3-dihydrophthalazine). In particular, a combination of phthalazines and phthalic acids is preferred when combined with a silver halide having a composition of a high silver iodide content.

Preferred amount of the phthalazines to be added is 0.01 mol to 0.3 mol, more preferably 0.02 to 0.2 mol, particularly preferably 0.02 to 0.1 mol per mol of the organic silver salt. This addition amount is important to accelerate development when using a silver halide emulsion having a composition of a high silver iodide content in the invention. Accordingly, sufficient developing properties and low fogging may be both achieved by adequately selecting the addition amounts.

11. Other Additives

In the invention, a mercapto compound, a disulfide compound, or a thione compound may be included so as to control development through suppressing or accelerating development, improving spectral sensitization efficacy, improving storability before and after the development, or the like. Such compounds may be compounds represented by formula (I) in JP-A No. 10-186572, and JP-A No. 10-62899, paragraphs 0067 to 0069. Specific examples thereof include those described in paragraphs 0033 to 0052, EP-A No. 0803764A1, p.20, lines 36 to 56. Among them, mercapto-substituted heterocyclic aromatic compounds described in JP-A Nos. 9-297367, 9-304875 and 2001-100358, Japanese Patent Application Nos. 2001-104213 and 2001-104214 and the like are preferred.

Plasticizers and lubricants which may be used in the image-forming layer in the invention are described in JP-A No. 11-65021, paragraph 0117. Slipping agents are described in JP-A No. 11-84573, paragraphs 0061 to 0064, and Japanese Patent Application No. 11-106881, paragraphs 0049 to 0062.

Various types of dyes and pigments (for example, C. I. Pigment Blue 60, C. I. Pigment Blue 64 and C. I. Pigment Blue 15:6) may be used for the image-forming layer in the invention in order to improve color tone, prevent the interference fringe upon exposure of a laser light, and prevent irradiation. These are described in detail in WO98/36322, JP-A Nos. 10-268465 and 11-338098, and the like.

In order to form ultra-hard contrast images suitably for use in printing prepress, an ultra-high contrast agent is preferably incorporated in the image-forming layer. The adding method and adding amounts of the ultra-high contrast agent is described in the aforementioned publication, paragraph 0118, JP-A No. 11 -223898 and paragraphs 0136 to 0193, and compounds of the formula (H), formulae (1) to (3), formulae (A) and (B) in Japanese Patent Application No. 11-87297, as well as compounds of the general formulae (III) to (V) in Japanese Patent Application No. 11-91652 (specific examples of the compound: Formula 21 to formula 24). Agents for enhancing contrast are described in JP-A No. 11-65021, paragraph 0102 and JP-A No. 11-223898, paragraphs 0194 to 0195.

When a compound capable of generating formic acid or a formic acid salt is used as a strongly fogging substance, it is preferably included on the side having the image-forming layer that contains the photosensitive silver halide in an amount of 5 mmol or less, and more preferably 1 mmol or less per mole of silver.

When an ultra-high contrast agent is used in the photothermographic material of the invention, an acid formed by hydration of diphosphorus pentoxide, or a salt thereof is preferably used in combination. Examples of the acid formed by hydration of diphosphorus pentoxide or a salt thereof include metaphosphoric acid (salt), pyrophosphoric acid (salt), orthophosphoric acid (salt), triphosphoric acid (salt), tetraphosphoric acid (salt), hexametaphosphoric acid (salt) and the like. Particularly preferably used acid formed by hydration of diphosphorus pentoxide or a salt thereof is orthophosphoric acid (salt) or hexametaphosphoric acid (salt). Specific examples of the salt are sodium orthophosphate, sodium dihydrogen orthophosphate, sodium hexametaphosphate, ammonium hexametaphosphate and the like.

The acid formed by hydration of diphosphorus pentoxide or a salt thereof may be used in a desired amount (coated amount per m² of the photosensitive material) depending on the desired performances including sensitivity and fog. However, it is preferably used in an amount of 0.1 to 500 mg/m², more preferably 0.5 to 100 mg/m².

12. Layer Construction and Other Components

The photothermographic material of the invention can include a non-photosensitive layer, in addition to the image-forming layer. The non-photosensitive layer may be divided according to the configuration into: (a) a surface protective layer disposed on the image-forming layer (farther side than the support); (b) an intermediate layer disposed between multiple image-forming layers or between the image-forming layer and the protective layer; (C) an undercoat layer disposed between the image-forming layer and the support; and (d) a back layer disposed to the opposite side of the image-forming layer.

Further, a layer capable of serving as an optical filter may be disposed, however, it is provided as the aforementioned layer (a) or (b). An antihalation layer is disposed in the photosensitive material as the aforementioned layer (c) or (d).

1) Surface Protective Layer

A surface protective layer may be disposed in the photothermographic material of the invention to prevent adhesion to the image-forming layer. The surface protective layer may be either a single layer or a multiple layer. The surface protective layer is described in JP-A No. 11-65021, paragraphs 0119 to 0120 and Japanese Patent Application No. 2000-171936.

As the binder for use in the surface protective layer, any polymer may be used. Examples of the binder include polyester, gelatin, polyvinylalcohol, cellulose derivatives and the like, however, cellulose derivatives are preferred. Examples of the cellulose derivatives are listed below, which are not limited thereto. Examples of the cellulose derivative include cellulose acetate, cellulose acetate butyrate, cellulose propionate, hydroxypropyl cellulose, hydroxypropylmethyl cellulose, methyl cellulose, hydroxyethyl cellulose, carboxymethyl cellulose, and any mixtures thereof. Thickness of the surface protective layer is preferably 0.1 to 10 μm, and particularly preferably 1 to 5 μm.

For the surface protective layer, any agent for preventing adhesion may be used. Examples of the agent for preventing adhesion include wax, liquid paraffin, silica particle, styrene-containing elastomeric block copolymer (e.g., styrene-butadiene-styrene, styrene-isoprene-styrene), cellulose acetate, cellulose acetate butyrate, cellulose propionate and any mixtures thereof.

2) Antihalation Layer

In the photothermographic material of the invention, an antihalation layer may be disposed to a side remote from the light source for exposure with respect to the image-forming layer. The antihalation layer is described in JP-A No. 11-65021, paragraphs 0123 to 0124, JP-A Nos. 11-223898, 9-230531, 10-36695, 10-104779, 11-231457, 11-352625, 11-352626 and the like.

The antihalation layer contains an antihalation dye capable of absorbing light in a range of wavelengths of light used for exposure. When the wavelength of the light for exposure falls in the infrared region, IR-absorbing dyes may be used, preferably the dyes which do not absorb visible light.

In the case where prevention of halation is carried out using a dye having absorption in the visible range, it is preferred that color of the dye does not substantially remain after image formation. Preferably, a means is used in which decoloring is executed by heat in the thermal development, and it is particularly preferred that a thermal decolorable dye and a basic precursor are added to the non-photosensitive layer so that it functions as an antihalation layer. These techniques are described in JP-A No. 11-231457 and the like.

The amount of the decolorable dye to be added is determined on the basis of intended use of the dye. In general, it is used in an amount to provide an optical density (absorbance) of greater than 0.1 when measured at prescribed wavelength. It is preferred that the optical density is 0.2 to 2. The amount of the dye to give such an optical density is generally about 0.001 to 1 g/m².

When the dye is decolored in such a manner, optical density post the thermal development can be lowered to 0.1 or less. Two or more decolorable dyes may be used in combination in a thermal decoloring type recording material or a photothermographic material. Similarly, two or more kinds of base precursors may be used in combination.

When thermal decoloring is conducted using such a decolorable dye and a base precursor, it is preferred that a substance which lowers the melting point by 3° C. or greater upon admixing with the base precursor (e.g., diphenylsulfone, 4-chlorophenyl(phenyl)sulfone) as described in JP-A No. 11-352626 is used in combination with respect to thermal decoloring properties.

3) Back Layer

The back layer which may be applied in the invention is described in JP-A No. 11-65021, paragraphs 0128 to 0130.

Binder for use in the back layer is transparent or translucent, and generally colorless, which may include a natural polymer, a synthetic resin as well as polymer and copolymer, and other medium which forms a film such as e.g., gelatin, gum arabic, poly(vinyl alcohol), hydroxyethyl cellulose, cellulose acetate, cellulose acetate butyrate, poly(vinylpyrrolidones), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinylacetals) (e.g., poly(vinylformal) and poly(vinylbutyral)), poly(esters), poly(urethanes), phenoxy resins, poly(vinylidene chloride), poly(epoxides), poly(carbonates), poly(vinyl acetate), cellulose esters and poly(amides). The binder may be coated and formed from water or an organic solvent or an emulsion.

In the invention, a coloring agent having absorption maximum in the range of 300 to 450 nm may be added for the purpose of improving the silver tone and the image stability with the passing of time. Examples of the coloring agent are described in JP-A Nos. 62-210458, 63-104046, 63-103235, 63-208846, 63-306436, 63-314535 and 01-61745, Japanese Patent Application No. 11-276751 and the like. Such a coloring agent is usually added in the range of 0.1 mg/m² to 1 g/m², and the layer to which the agent is added is preferably a back layer disposed to opposite side of the image-forming layer.

4) Antistatic Layer

Moreover, in accordance with the invention, an antistatic layer may be provided which contains any of known various metal oxides, electric conductive polymers or the like. The antistatic layer may be layered with the aforementioned undercoat layer, back layer surface protective layer and the like, or alternatively, it may be separately provided. In connection with the antistatic layer, techniques described in JP-A No. 11-65021, paragraph 0135, JP-A Nos. 56-143430, 56-143431, 58-62646 and 56-120519, JP-A No. 11-84573, paragraphs 0040 to 0051, U.S. Pat. No. 5,575,957, JP-A No. 11-223898, paragraphs 0078 to 0084 may be applied.

5) Additives

5-1). Matting Agent

It is preferred that a matting agent is added to the surface protective layer, and back layer in order to improve conveying properwies of the material. Matting agent is described in JP-A No. 11-65021, paragraphs 0126 to 0127.

When shown by the coated amount per m² of the photosensitive material, the matting agent is preferably applied in an amount of 1 to 400 mg/m², and more preferably 5 to 300 mg/m².

Matte degree of the emulsion surface may be any value insofar as a so-called stardust failure does not occur in which a small white out is generated in the image part to result leak of the light. However, Beck's smoothness is preferably 200 seconds or greater and 10000 seconds or less, and particularly preferably 300 seconds or greater and 8000 seconds or less. Beck's smoothness can be easily determined according to Japanese Industrial Standard (JIS) P8119, “Test Method for Smoothness of Paper and Paperboard by Beck Test Device” and TAPPI Standard Method T479.

For the matte degree of the back layer in the invention, Beck's smoothness is preferably 250 seconds or less and 10 seconds or greater, and more preferably 180 seconds or less and 50 seconds or less.

In the invention, the matting agent is preferably included into the outermost surface layer or a layer which serves as an outermost layer in the photosensitive material, or a layer in the vicinity of the outermost surface, and is preferably included in a layer which serves as a so-called protective layer.

The matting agent which may be used in the invention is an organic or inorganic fine particle which is insoluble in the solvent for preparing a coating solution. For example, any one well known in the art may be used such as organic matting agents described in each specification of U.S. Pat Nos. 1,939,213, 2,701,245, 2,322,037, 3,262,782, 3,539,344 and 3,767,448; and inorganic matting agents described in each specification of U.S. Pat. Nos. 1,260,772, 2,192,241, 3,257,206, 3,370,951, 3,523,022 and 3,769,020; or the like. Specific examples of the organic compound which may be preferably used as the matting agent include for example, polymethyl acrylate, polymethyl methacrylate, polyacrylonitrile, acrylonitrile-α-methylstyrene copolymer, polystyrene, styrene-divinylbenzene copolymer, polyvinyl acetate, polyethylene carbonate, polytetrafluoroethylene and the like which may be examples of water-dispersible vinyl polymer; methyl cellulose, cellulose acetate, cellulose acetate propionate and the like which may be examples of cellulose derivative; carboxy starch, carboxynitrophenyl starch, urea-formaldehyde-starch reaction product and the like which may be examples of starch derivative; gelatin hardened with any known hardening agent, and hardened gelatin which was made to give fine capsule hollow particles by coacervate hardening. Examples of inorganic compound for preferably use include silicon dioxide, titanium dioxide, magnesium dioxide, aluminum oxide, barium sulfate, calcium carbonate, as well as silver chloride desensitized with any known process, similarly desensitized silver bromide (glass, diatomaceous earth and the like). The matting agent described herein above can be used by mixing with a different kind of substance as needed. Size and shape of the matting agent are not particularly limited, and those having an arbitrary particle diameter can be used. When the invention is practiced, use of the matting agent having the particle diameter of 0.1 μm to 30 μm is preferred. In addition, particle-size distribution of the matting agent may be either narrow or broad. On the other hand, the matting agent greatly influences upon haze and surface gloss of the photosensitive material, therefore, it is preferred that particle diameter, shape and particle-size distribution are adjusted to the state according to need, upon manufacturing the matting agent, or by mixing multiple matting agents.

5-2). Hardening Agent

A hardening agent may be used in the respective layers of the image-forming layer, the protective layer, the back layer and the like in the invention.

Examples of the hardening agent involve each method as described in T. H. James, ‘THE THEORY OF THE PHOTOGRAPHIC PROCESS FOURTH EDITION’ (Macmillan Publishing Co., Inc., published in 1977), pages 77 to 87, and chrome alum, 2,4-dichloro-6-hydroxy-s-triazine sodium salt, N,N-ethylenebis(vinylsulfone acetamide), N,N-propylenebis(vinylsulfone acetamide), as well as polyvalent metal ion described in the same literature, page 78 and the like, polyisocyanates in U.S. Pat. No. 4,281,060, JP-A No. 6-208193 and the like, epoxy compounds in U.S. Pat. No.4,791,042 and the like, vinylsulfonic compounds in JP-A No. 62-89048 and the like are preferably used. In particular, vinylsulfonic compounds are preferred, with nondiffusing vinylsulfonic compounds being more preferred.

The hardening agent is included in a solution, and the time point of adding this solution to a coating solution for the protective layer may be any time from 180 minutes before throughout just prior to the coating, and preferably 60 minutes before throughout 10 seconds before the coating. The method and conditions for mixing are not particularly limited so long as the effects of the invention are sufficiently achieved.

Specific examples of the mixing method include a method of mixing in a tank which is set to give desired mean retention time which was calculated from the flow rate of addition and the amount of supplied liquid; and a method in which a static mixer or the like is used as described in N. Harnby, M. F. Edwards, A. W. Nienow (translated by Koji Takahashi), “Techniques for liquid mixing” (published by Nikkan Kogyo Shinbun, 1989), chapter 8.

5-3). Surfactant

A surfactant may be used in the photothermographic material of the invention to improve coating characteristics, charge and the like. Examples of the surfactant include nonionic, anionic, cationic, fluorine-type surfactants, any of which may be arbitrarily used. Specific examples of the surfactant include fluorine-type macromolecular surfactants described in JP-A No. 62-170950, U.S. Pat. No. 5,380,644 and the like, fluorine-type surfactants described in JP-A Nos. 60-244945, 63-188135 and the like, polysiloxane surfactants described in U.S. Pat. No. 3,885,965 and the like, anionic surfactants, polyalkylene oxides described in JP-A No. 6-301140, and the like.

According to the invention, use of a fluorine-type surfactant is particularly preferred. Specific examples of preferred fluorine-type surfactant include compounds described in JP-A Nos. 10-197985, 2000-19680, 2000-214554 and the like. Additionally, fluorine-type macromolecular surfactants described in JP-A No. 9-281636 are also preferably used. In the invention, to use fluorine-type surfactants described in Japanese Patent Application No. 2000-206560 is particularly preferred.

5-4). Other Additives

To the photothermographic material may be further added an antioxidant, a stabilizer, a plasticizer, a UV absorbent or a coating auxiliary, depending on the characteristics of the respective layers. Solvent described in JP-A No. 11-65021, paragraph 0133 may also be added. Various types of additives are added either of the image-forming layer or the non-photosensitive layer. In respect of those additives, references may be made in WO98/36322, EP No. 803764A, JP-A Nos. 10-186567, 10-186568 and the like.

6) Film Surface pH

In the photothermographic material of the invention, the film surface prior to the thermal development has the pH of preferably 7.0 or less, and more preferably 6.6 or less. Although the lower limit is not particularly limited, it is approximately 3. Most preferable, a pH range is from 4 to 6.2.

The film surface pH is preferably controlled using an organic acid such as a phthalic acid derivative, a nonvolatile acid such as sulfuric acid, or a volatile base such as ammonia, in light of lowering of the pH of the film surface. In particular, ammonia is preferred in light of achieving a low pH of the film surface, because it is liable to volatilize, and thus can be removed during the coating step or before the thermal development. Furthermore, to use ammonia in combination with a nonvolatile base such as sodium hydroxide, potassium hydroxide or lithium hydroxide is also preferably employed. A method for measuring the pH of the film surface is described in Japanese Patent Application No. 11-87297, paragraph 0123.

7) Support

Examples of the support for use in the invention include a polyester film, an undercoated polyester film, a poly(ethylene terephthalate) film, a polyethylene naphthalate film, a cellulose nitrate film, a cellulose ester film, a poly(vinylacetal) film, a polycarbonate film, and relevant or resinoid materials, as well as glass, paper, metal and the like. Moreover, flexible bases, in particular, paper supports coated with partially acetylated, or baryta and/or a-olefin polymer, particularly α-olefin polymer having 2 to 10 carbon atoms such as polyethylene, polypropylene (ethylene-butene copolymer) may be also used. The support may be either transparent or opaque, however, it is preferably transparent.

As the support, polyester is preferably used which has been subjected to a heat treatment in the temperature range of 130 to 185° C. so as to alleviate internal distortion that remains in the film during the biaxial orientated stretching, and to avoid distortion by thermal contraction generated during the thermal development process. In particular, polyethylene terephthalate subjected to such a heat treatment is preferably used.

When the photothermographic material is used for medical use, a transparent support may be colorized with a blue dye (e.g., dye-1 described in JP-A No. 8-240877, Example), or may be colorless. Specific examples of the support are described in JP-A No. 11-65021, paragraph 0134.

To the support may be preferably applied an undercoating technique using water-soluble polyester described in JP-A No. 11-84574, styrene-butadiene copolymer as described in JP-A No. 10-186565, vinylidene chloride copolymer described in JP-A No. 2000-39684 and Japanese Patent Application No. 11-106881, paragraphs 0063 to 0080.

8) Coating Process

The photothermographic material in the invention may be coated by any method. Specifically, any of various coating manipulations may be employed including extrusion coating, slide coating, curtain coating, dip coating, knife coating, flow coating, or extrusion coating in which a hopper of the type described in U.S. Pat. No. 2,681,294 is used. Extrusion coating or slide coating described in Stephen F. Kistler, Petert M. Schweizer, ‘LIQUID FILM COATING’ (CHAPMAN & HALL Corporation, published in 1997) pages 399 to 536 is preferably used, and the extrusion coating is particularly preferably used.

9) Packaging Material

The photothermographic material of the invention is preferably hermetically packed with a packaging material having low oxygen permeability and/or moisture permeability in order to prevent the material from qualitative alteration in photographic performances during storage prior to use, or to prevent curling or following its shape as is rolled, when the product is in the form of a rolled state. The oxygen permeability is preferably 50 ml/atm/m²·day or less, more preferably 10 ml/atm/m²·day or less, and still more preferably 1.0 ml/atm/m²·day or less, at 25° C. Moisture permeability is preferably 10 g/atm/m²·day or less, more preferably 5 g/atm/m²·day or less, and still more preferably 1 g/atm/m²·day or less. Specific examples of packaging material having low oxygen permeability and/or moisture permeability are described in for example, JP-A Nos. 8-254793 and 2000-206653, which may be utilized.

10) Other Applicable Techniques

Techniques which may be applicable to the photothermographic material of the invention include those in EP Nos. 803764A1 and 883022A1, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099 and 11-343420, and Japanese Patent Application Nos. 2000-187298, 2000-10229, 2000-47345, 2000-206642, 2000-98530, 2000-98531, 2000-112059, 2000-112060, 2000-112104, 2000-112064 and 2000-171936.

11) Formation of Color Image

A multi-color photothermographic material may have a construction of these two layers for each color. Alternatively, all ingredients may be included within a single layer as described in U.S. Pat. No. 4,708,928.

In case of multi-color photothermographic materials, each image-forming layer is usually separated with each other using a functional or nonfunctional barrier layer between respective image-forming layers as described in U.S. Pat. No. 4,460,681.

13. Image-Forming Method

1) Light Exposure

Although the photothermographic material of the invention may be subjected to light exposure by any methods, laser light is preferred as an exposure light source. A silver halide emulsion having a high silver iodide content like the present invention involved problems of low sensitivity. However, the problems of low sensitivity were solved through writing in at high illumination intensity with a light source such as laser light, and additionally, it was revealed that images can be recorded with less energy. Desired sensitivity may be obtained by wiring in using such a strong light in a short time period.

When light is irradiated in a sufficient amount to provide a maximum density (Dmax), a preferred amount of light on the surface of the photosensitive material is 0.1 W/mm² to 100 W/mm². More preferably, such an amount of light is 0.5 W/mm² to 50 W/mm², and most preferably 1 W/mm² to 50 W/mm².

It is preferred that the laser light according to the invention is gas laser (Ar⁺, He—Ne and He—Cd), YAG laser, pigment laser, semiconductor laser or the like. In addition, semiconductor laser and second harmonic generating chip or the like may be used. Laser suitable for use in the invention is determined corresponding to a peak absorption wavelength of spectral sensitizing pigment or the like in the photothermographic material, but examples of the laser include He—Ne laser of red through infrared emission, red color semiconductor laser, or Ar⁺, He—Ne, He—Cd laser of blue through green emission, and blue color semiconductor laser. In recent years, modules having SHG (Second Hermonic Generator) chip and semiconductor laser which are integrated, or blue color semiconductor laser have been developed, and thus laser output devices for short wavelength region have attracted the attention. Blue color semiconductor laser has been expected as a light source with increasing demand hereafter because image recording with high definition is possible, and increased recording density, as well as stable output with longer operating life are enabled.

Laser light which oscillates in a longitudinal multi mode by a method such as high frequency superposition is also preferably employed.

2) Thermal Development

The photothermographic material according to the invention may be developed by any method. Ordinarily, a temperature of the photothermographic material which has been exposed image-wise is elevated to allow it to be developed. A development temperature is preferably rangingf from 80 to 250° C., more preferably from 100 to 140° C., and most preferably from 110 to 130° C. The development time period is from 1 to 60 seconds, preferably from 3 to 30 seconds, still preferably from 5 to 25 seconds, and most preferably from 7 to 15 seconds.

As to a thermal development system, a plate heater system is preferably used. As to the thermal development system utilizing the plate heater system, methods described in JP-A No. 11-133572 are preferable, in which there is provided a thermal development apparatus that obtains a visible image by allowing a photothermographic material in which a latent image has been formed to contact with a heating unit in a thermal development part thereof wherein the thermal development apparatus is characterized in that the heating unit comprises a plate heater, a plurality of pressure rolls are provided along one surface of the plate heater such that the pressure rolls face to the plate heater and the thermal development is performed by allowing the photothermographic material to pass through between the pressure rolls and the plate heater. It is preferable that the plate heater is divided into 2 to 6 steps and that the top step has a temperature lowered by approximately 1° C. to 10° C. For example, a manner in which the temperature for “four sets of plate heaters” controlled to be 112° C., 119° C., 121° C. and 120° C., respectively, is employed.

Such methods as described above are also described in JP-A No. 54-30032; according to these methods, moisture and an organic solvent contained in the photothermographic material can be removed out of a system and, also, deformation of the support of the photothermographic material caused by rapid heating can be suppressed.

14. System

As a laser imager equipped with a light exposure part and a thermal development part for the medical use, Fuji Medical Dry Imager FM-DPL is mentioned. The system is detailed in Fuji Medical Review No. 8, pp. 39 to 55 and the techniques set forth therein are applicable. Further, the photothermographic material according to the invention can also be applied as a photothermographic material for the laser imager in “AD network”, proposed by Fujifilm Medical Co., Ltd., a network system which meets the DICOM Standards.

15. Application of the Present Invention

The photothermographic material of the present invention forms a monochromatic silver image, and hence is preferably used in medical diagnosis, industrial photography, printing and COM (computer output microfilm).

### EXAMPLES

The invention will now be illustrated by the following Examples, but it is to be understood that the invention is not limited to the Examples.

### Example 1

1. Preparation of PET Support, and Undercoat

1-1. Film Formation

From terephthalic acid and ethylene glycol, PET was produced in an ordinary manner. PET thus produced had an intrinsic viscosity, IV, of 0.66, as measured in a phenol/tetrachloroethane ratio (6/4 by weight) at 25° C. After pelletized, the PET was dried at 130° C. for 4 hours, and melted at 300° C., followed by extrusion through a T-die. After rapid cooling, a non-oriented film was obtained which had a thickness of 175 μm after thermal fixation.

The resultant film was stretched 3.3 times in MD (machine direction) using a roll at different rotating speeds, then stretched 4.5 times in CD (cross direction) using a tenter. The temperatures for MD and CD stretchings were 110° C. and 130° C., respectively. Then, the film was thermally fixed at 240° C. for 20 seconds, and relaxed by 4% in CD at the same temperature. Subsequently, the chuck of the tenter was released, the both edges of the film was knurled, and the film was rolled up under 4 kg/cm² (4×104 Pa) to give a rolled film having a thickness of 175 μm.

1-2. Corona Discharge Surface Treatment

Both surfaces of the support were subjected to corona discharge treatment at room temperature at a speed of 20 m/min, using a solid-state corona discharge system MODEL 6KVA manufactured by Pillar Technologies. From the data of the current and the voltage read from the system, the support was found to be processed at 0.375 kV·A·min/m². The frequency for the treatment was 9.6 kHz, and the gap clearance between an electrode and a dielectric roll was 1.6 mm.

2. Back Layer

2-1. Preparation of Coating Solution for Back Layer

To 830 g of MEK were added 84.2 g of cellulose acetate butyrate (Eastman Chemical, CAB381-20) and 4.5 g of a polyester resin (Bostic Co., Vitel PE2200B) with stirring, and dissolved. To this dissolved solution was added 0.30 g of dye 1, and thereto were added 4.5 g of a fluorine-based surfactant (Asahi Glass Co., Ltd., Surflon KH40) which had been dissolved in 43.2 g of methanol, and 2.3 g of a fluorine-based surfactant (Dai-Nippon Ink & Chemicals, Inc., Megafac F120K). The mixture was thoroughly stirred until completing the dissolution. Finally, 75 g of silica (W. R. Grace Co., Siloid 64X6000) dispersed in methyl ethyl ketone at a concentration of 1% by weight using a dissolver-type homogenizer was added thereto followed by stirring to prepare a coating solution for a back layer.

2-2. Coating of Back Layer

The thus prepared coating solution for the back surface protective layer was coated on the support using an extrusion coater so that the dry film thickness became 3.5 μm and then dried. Drying was executed using dry wind employing a drying temperature of 100° C., and a dew point of 10° C. over 5 minutes.

3. Image-Forming Layer and Surface Protective Layer

3-1. Preparation of Materials for Coating

1) Preparation of Organic Silver Salt Including Silver Halide According to the Invention

(Preparation of Silver Halide Emulsion -1)

To 1420 mL of distilled water was added 4.3 mL of a 1% by weight potassium iodide solution. Further, a liquid added with 3.5 mL of sulfuric acid having the concentration of 0.5 mol/L and 36.7 g of phthalated gelatin was kept at the liquid temperature of 42° C. while stirring in a stainless steel reaction pot, and thereto were added a total amount of: solution A prepared through diluting 22.22 g of silver nitrate with distilled water to give a volume of 195.6 mL; and solution B prepared through diluting 21.8 g of potassium iodide with distilled water to give a volume of 218 mL, over 9 minutes at a constant flow rate. Thereafter, 10 mL of a 3.5% by weight aqueous solution of hydrogen peroxide was added thereto, followed by further addition of 10.8 mL of a 10% by weight aqueous solution of benzoimidazole. Moreover, a solution C prepared through diluting 51.86 g of silver nitrate by adding distilled water to give the volume of 317.5 mL and a solution D prepared through diluting 60 g of potassium iodide with distilled water to give a volume of 600 mL were added. A control double jet method was carried out by adding a total amount of the solution C at a constant flow rate over 120 minutes, accompanied by addition of the solution D while maintaining the pAg at 8.1.

Hexachloroiridium (III) potassium salt was added to give 1×10⁻⁴ mol per mol of silver in its entirety at 10 minutes after commencement of adding the solution C and the solution D. Moreover, at 5 seconds after completing the addition of the solution C, an aqueous solution of potassium iron (II) hexacyanide was added at a total amount of 3×10⁻⁴ mol per 1 mol of silver. The mixture was adjusted to the pH of 3.8 with sulfuric acid having the concentration of 0.5 mol/L. After stirring was halted, the mixture was subjected to precipitation/desalting/water washing steps. The mixture was adjusted to a pH of 5.9 with sodium hydroxide having the concentration of 1 mol/L to produce a silver halide dispersion having the pAg of 8.0.

The silver halide dispersion was kept at 38° C. with stirring, and thereto was added 5 mL of a 0.34% by weight methanol solution of 1,2-benzoisothiazoline-3-one, followed by elevating the temperature to 47° C. At 20 minutes after elevating the temperature, sodium benzene thiosulfonate in a methanol solution was added at 7.6×10⁻⁵ mol per mol of silver followed by adjusting the pAg of 5.5. At additional 5 minutes later, a tellurium sensitizer C in a methanol solution was added at 2.9×10⁻⁴ mol per mol of silver and subjected to ripening for 91 minutes. After adjusting the pAg of the emulsion to 7.5, 1.3 mL of a 0.8% by weight methanol solution of N,N′-dihydroxy-N″-diethylmelamine was added thereto, and at additional 4 minutes thereafter, 5-methyl-2-mercaptobenzimidazole in a methanol solution at 4.8×10⁻³ mol per mol of silver, and 1-phenyl-2-heptyl-5-mercapto-1,3,4-triazole in a methanol solution at 5.4×10⁻³ mol per mol of silver were added to produce a silver halide emulsion. This emulsion had mean particle size of 40 nm, with a coefficient of variation of the particle size being 12%. Mean particle size was determined from the average of 1,000 particles using a transmission electron microscope (TEM).

(Preparation of Silver Salt of Fatty Acid-1)

In 13 L of water was dissolved 688 g of a fatty acid having a composition of 42 mol % behenic acid, 34 mol % arachidic acid and 24 mol % stearic acid at 80° C., followed by mixing for 15 minutes. Then, to the resultant mixture was added a solution of 89.18 g of NaOH dissolved in 1.5 L of water at 80° C., followed by mixing for 5 minutes to form a fluid dispersion. A solution of 19 mL of concentrated nitric acid diluted with 50 mL of water was added to this dispersion at 80° C., and then the dispersion was cooled to 55° C. and stirred for 25 minutes. Thereafter, while keeping the temperature at 55° C., a diluted emulsion obtained by dissolving 700 g of the iridium doped silver halide emulsion (containing 1 mol of silver halide) described above in 1.25 L of water at 42° C. in an amount equivalent to 0.10 mol of silver halide was added to the dispersion and mixed for 5 minutes. Further, thereto was added a solution of 336.5 g of silver nitrate dissolved in 2.5 L of water over 10 minutes at 55° C. The thus obtained organic silver salt dispersion was thereafter transferred to a vessel for washing with water, and thereto was added deionized water followed by stirring. The mixture was allowed to stand so that supernatant of the organic silver salt dispersion was separated, and thus water-soluble salts present in the bottom part were removed. Then, washing with deionized water and drainage of the waste water was repeated until the electric conductivity of the waste water became 2 μS/cm. After performing centrifugal dewater, drying in a circulating dryer was performed with hot air having the oxygen partial pressure of 10% by volume at 45° C. until weight loss did not take place.

(Preparation of Organic Silver Salt Redispersion-1)

The aforementioned silver salt of fatty acid powder-1 in an amount of 209 g and 11 g of polyvinyl butyral powder (Monsanto Co., Butvar B-79) were dissolved in 780 g of methyl ethyl ketone (MEK), and the mixture was stirred using Dissolver DISPERMAT CA-40M type manufactured by VMA-GETZMANN Co., and allowed to stand at 7° C. overnight to yield a slurry.

The slurry was subjected to two-path dispersing operation using a GM-2 pressure type homogenizer (manufactured by SMT Limited) to prepare an organic silver salt redispersion-1.

2) Preparation of Organic Silver Salt Containing Comparative Silver Halide

(Preparation of Comparative Organic Silver Salt Redispersion-2)

The following solutions were prepared.

Solution A: 766 g of a fatty acid having the composition of: behenic acid content of 42 mol %, arachidic acid of 34 mol % and stearic acid of 24 mol %, dissolved in distilled water at 85° C. for 15 min., 13 L

Solution B: NaOH 89 g, distilled water 1500 ml

Solution C: conc. HNO₃ 19 ml, distilled water 50 ml

Solution D: AgNO₃ 365 g, distilled water 2500 ml

Solution E: polyvinyl butyral 86 g, ethyl acetate 4300 ml

Solution F: polyvinyl butyral 290 g, MEK 3580 ml

Solution G: N-iodosuccinimide in an amount of 0.05 mol per 1 mol of organic silver salt, acetone 690 ml

To Solution A which was maintained at a temperature of 85° C. was added Solution B with vigorously stirring over 5 minutes, and thereafter was added Solution C over 25 minutes. After stirring for 20 minutes as it stands, the temperature of the mixture was lowered to 35° C. To the mixture was added Solution D at 35° C. while stirring more vigorously over 5 minutes and was kept stirring as it is for additional 90 minutes. Thereafter, Solution E was added to the mixture and then stirring was halted. The mixture was allowed to stand, and an aqueous phase having salts contained therein was removed. Thus, the oil phase was obtained and a trace amount of water was removed through eliminating the solvent. Thereafter to the oil phase was added Solution F followed by stirring vigorously at 50° C., and then Solution G was added thereto over 20 minutes. The mixture was stirred for 105 minutes to achieve iodation of a part of the organic silver salt. When the product was observed by an electron micrograph with 50,000 magnifications, the thus produced crystal of silver iodide was present on the surface of fatty silver.

(Preparation of Comparative Organic Silver Salt Redispersion-3)

<Preparation of Silver Salt of Fatty Acid-3>

A fatty acid having a composition of behenic acid content of 42 mol %, arachidic acid of 34 mol % and stearic acid of 24 mol % in an amount of 87.6 kg, 423 L of distilled water, 49.2 L of an aqueous solution of NaOH having a concentration of 5 mol/L, 120 L of t-butyl alcohol were admixed, and a reaction was allowed at 75° C. for 1 hour with stirring to give a sodium behenate solution A. An aqueous solution of 40.4 kg of silver nitrate (pH 4.0) was separately prepared in an amount of 206.2 L, and kept at a temperature of 10° C. A reaction vessel charged with 635 L of distilled water and 30 L of t-butyl alcohol was kept at a temperature of 30° C., and thereto were added the total amount of the sodium behenate solution A and a total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. Then addition of the sodium behenate solution A was tarted, and during 14 minutes and 15 seconds following the completion of adding the aqueous silver nitrate solution, the added material was restricted to the sodium behenate solution A alone. The temperature inside of the reaction vessel was then set to be 30° C., and the temperature outside was controlled so that the liquid temperature could be kept constant. In addition, the temperature of a pipeline for the addition system of the sodium behenate solution A was kept constant by circulating warm water in outer side of a double wall pipe, so that the temperature of the liquid at an outlet in the leading edge of the nozzle for addition was adjusted to be 75° C. Further, the temperature of a pipeline for the system adding the aqueous silver nitrate solution was kept constant by circulation of cool water in outer side of a double wall pipe. Position at which the sodium behenate solution A was added and the position at which the aqueous silver nitrate solution was added were arranged symmetrically with a shaft for stirring being located at a center. Moreover, both of the positions were adjusted to avoid contact with the reaction liquid.

After completing the addition of the sodium behenate solution A, the mixture was left to stand at the temperature as it is for 20 minutes. The temperature of the mixture was then elevated to 35° C. over 30 minutes followed by ripening for 210 minutes. Thereafter, the resulting organic silver salt dispersion was transferred to a vessel for washing with water, and thereto was added deionized water followed by stirring. The mixture was allowed to stand so that the supernatant of the organic silver salt dispersion was separated, and hence water soluble salts present in the bottom part were removed. Then, washing with deionized water and drainage of the waste water was repeated until the electric conductivity of the waste water became 2 μS/cm. After performing centrifugal dewater, drying in a circulating dryer was performed with hot air having the oxygen partial pressure of 10% by volume at 45° C. until weight loss did not take place.

<Preparation of Organic Silver Salt Redispersion-3>

The aforementioned fatty silver-3 in an amount of 209 g and 11 g of polyvinyl butyral powder (Monsanto Co., Butvar B-79) were dissolved in 780 g of methyl ethyl ketone (MEK). Then, the aforementioned silver halide emulsion-1 was added thereto in an amount equivalent to 0.023 mol of silver halide, and the mixture was stirred using Dissolver DISPERMAT CA-40M Type (manufactured by VMA-GETZMANN Co.), and allowed to stand at 7° C. overnight to yield a slurry.

The slurry was subjected to two-path dispersing operation using a GM-2 pressure type homogenizer (manufactured by SMT Limited) to prepare an organic silver salt redispersion-3.

TABLE 1

| Organic | | Fatty Acid | | |
|---|---|---|---|---|
| Silver | Silver Halide | Composition | | |
| Salt | AgI Content | Behenic Acid | Method for | |
| Redispersion | (mol %) | (mol %) | Preparation | Remarks |
| 1 | 100 | 42 | Method of | Present |
| | | | Present | Invention |
| | | | Invention | |
| 2 | 100 | 42 | Conversion | Comparative |
| | | | | Example |
| 3 | 100 | 42 | Added | Comparative |
| | | | separately | Example |

3-2. Preparation of Coating Solution

1) Preparation of Coating Solution for Image-Forming Layer-1 to Layer-3

One of the organic silver salt redispersions-1 to 3 described above in an amount of 507 g was stirred at 13° C. for 15 minutes, and thereto was added 3.9 mL of a 10% by weight methanol solution of pyridinium hydrobromide perbromide (PHP). After stirring for 2 hours, 5.2 mL of a 11% by weight methanol solution of calcium bromide was added thereto. After stirring was continued for 30 minutes, 117 g of Butvar B-79 was added thereto. After stirring for additional 30 minutes, 27.3 g of the reducing agent-1 (the aforementioned specific example, compound I-2) was added thereto, followed by additional stirring for 15 minutes. Thereafter, the sensitizing dye-1 was added to the mixture in an amount of 1×10⁻³ mol per mol of silver halide, and the mixture was stirred for 15 minutes. Subsequently, 1.39 g of Desmodur N3300 (Mobay, aliphatic isocyanate) dissolved in 12.3 g of MEK was also added thereto, and the mixture was further stirred for 15 minutes followed by heating at 21° C. for 15 minutes.

To 100 g of this fluid dispersion were added the polyhalogen compound-1 (the aforementioned specific example, compound H-2) in an amount of 0.03 mol per mol of silver amount coated, the compound-1 of types 1 to 5 (the aforementioned specific example, compound 24) in an amount of 5×10⁻³ mol per mol of silver halide, the hydrogen bond-forming compound-1 (the aforementioned specific example, compound D-7) in an amount of equimolar to the reducing agent-1, the development accelerator-1 (the aforementioned specific example, compound A-1) and the development accelerator-2 (the aforementioned specific example, compound A-8) in an amount of 5×10⁻³ mol per mol of silver in the fatty silver, respectively, 0.47 g of 4-chlorobenzophenone2-carboxylic acid, 0.47 g of 2-chlorobenzoic acid and 0.043 g of 5-methyl-2-mercaptobenzimidazole, and thus resulting mixture was stirred at 21° C. for 1 hour. Then, thereto were added 0.368 g of phthalazine, 0.123 g of tetrachlorophthalic acid, and 2 g of dye-1 to perfect a coating solution for the image-forming layer.

2) Preparation of Coating Solution for Surface Protective Layer

To 512 g of MEK were admixed 61 g of methanol, 48 g of cellulose acetate butyrate (Eastman Chemical, CAB171-15), 2.08 g of 4-methylphthalic acid, 3.3 g of a 16% by weight MEK solution of a fluorochemical polymer surfactant C, 1.9 g of polymethyl methacrylic acid (Rohm and Haas [residing in Pa., Philadelphia], Acryloid A-21), 2.5 mL of a 1% by weight methanol solution of benzotriazole, and 0.5 g of vinylsulfone VS-1 (described in EP-A No. 0600589A2) at room temperature to prepare a coating solution for the surface protective layer.

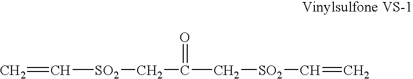

3-3. Preparation of Photothermographic Materials-1 to 3

Photothermographic materials-1 to 3 were prepared by simultaneously coating of both of the coating solutions for image-forming layer and the coating solution for the surface protective layer prepared as described above using a dual knife coater, on a reverse surface to the back layer of the support that had been coated with the back layer. The coating was performed so that the image-forming layer had the thickness after drying of 18.3 μm, and that the surface protective layer had the dry film thickness of 3.4 μm. This coating device had two knife coating blades which were laid side by side. After cutting the support to the length so that it meets with the volume of the solution used, knives equipped with a hinge were elevated to put them in a position on the coater floor. Then, the knives were brought down and fixed onto a predetermined position. The height of the knives was regulated using a wedge which was measured with an ammeter and which was controlled by a screw knob. Knife #1 was elevated up to an aperture corresponding to the thickness which was coordinated with a total thickness of the substrate thickness and the desired wet thickness of the image-forming layer (layer #1). Knife #2 was elevated up to the height equal to the total thickness of: support thickness+wet thickness of the image-forming layer (layer #1)+desired thickness of the surface protective layer (layer #2). Thereafter, drying was performed for 15 minutes with drying air providing the drying temperature of 75° C. and having the dew point temperature of 10° C.

Chemical structures of the compounds used in Examples of the invention are shown below.

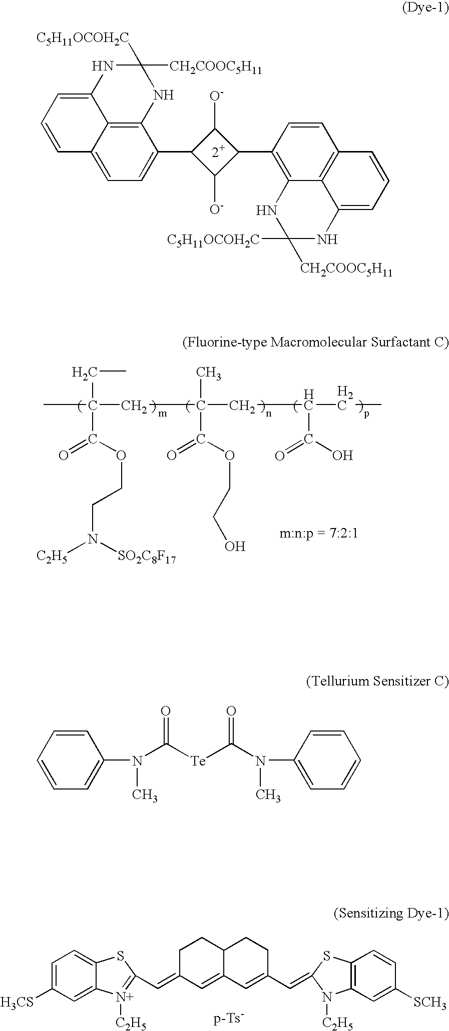

3-4. Measurement of Amount of Residual Solvent

The amount of the solvent present in the resulting photothermographic material determined with respect to an MEK content was determined through the following conditions. The photothermographic material having a film area of 46.3 cm² was obtained by cutting, and this was cut into fine pieces to approximately 5 mm, which were put in a glass bottle for exclusive use. The bottle was sealed with a septum and an aluminium cap, and then was set into a head space sampler type HP7694 in a gas chromatography (GC) Type 5971 (manufactured by Hewlett Packard Co.). Detector of GC employed was a hydrogen flame ionization detector (FID), while the used column was DB-624 (manufactured by J&W). Principal conditions for measurement involved heating condition of the head space sampler being 120° C. for 20 minutes, GC introduction temperature being 150° C., elevation of the temperature being at 8° C./min from 45° C. for 3 minutes to 100° C. Calibration curve was made with a peak area of the chromatogram obtained by the measurement of a predetermined amount of a diluted solution of MEK in butanol which was put into the bottle for exclusive use, similarly to the above-described manner. No great difference was found depending on the prepared samples, and the contents of the solvent were within a range of 10 to 12 mg/m².

4. Evaluation of Photographic Performance

(Preparation)

The resulting sample was cut into a half size, wrapped with the following packaging material under an environment of 25° C. and 50%, and stored for 2 weeks at an ambient temperature.

(Packaging Material)

PET 10 μm/PE 12 μm/aluminum foil 9 μm/Ny 15 μm/polyethylene 50 μm containing carbon at 3% by weight, oxygen permeability: 0.02 mL/atm·m²·25° C.·day, moisture permeability: 0.10 g/atm·m²·25° C.·day.

Evaluations for the photosensitive materials described above were carried out as follows.

(Light Exposure and Development of Photosensitive Material)

A light exposure machine was manufactured by way of trial, with semiconductor laser, which was made to give a longitudinal multi mode of the wavelength of 800 nm through 820 nm with high frequency superposition, as an exposure light source. Light exposure was provided by laser scanning using this light exposure machine from the image-forming layer surface side of the samples No. 1 to No. 25 prepared as described hereinabove. Upon the exposure, images were recorded with an incident angle of the scanning laser light on the light exposure surface of the photosensitive material set to be 75°. Thereafter, thermal development was conducted at 124° C. for 15 seconds using an automatic developing machine having a heat drum so that the protective layer of the photosensitive material was brought into contact with the drum surface. Thus resulting image was evaluated using a densitometer.

(Evaluation of Photographic Performance)

1. Evaluation of Fog

Evaluation of the formed images was carried out using Macbeth TD904 densitometer (visible density). The images were evaluated for the minimal density, Dmin (fog).

2. Evaluation of Sensitivity

The sensitivity was determined through representing with a reciprocal number of the amount of the exposed light amount which gives blackening density of fog being +1.0. The evaluation was made with relative sensitivity (ΔS) of each sample on the basis of the value for the photothermographic material-1 which was assumed as 100.

3. Evaluation of Print-Out

Image samples obtained by thermal development of the photothermographic materials-1 to 3 of the invention were exposed to light for 3 days under a fluorescent lamp at 1,000 lux, and thereafter unexposed areas were measured for the optical density. The optical density in this occasion was determined as Dmin2, and the difference between Dmin which is the value prior to the exposure to the fluorescent lamp (ΔDmin) was calculated.

ΔDmin=Dmin2−Dmin

Results of the evaluation are shown in Table 2.

TABLE 2

| Sample | Silver Halide | Behenic Acid | | Sensitizing | Fog | Print-out | Method for | |
|---|---|---|---|---|---|---|---|---|
| No. | (AgI Content) | Content | Sensitivity | Dye | Dmin | ΔDmin | Preparation | Remarks |
| 1 | 100 mol % | 42 mol % | 100 | −1 | 0.19 | 0.00 | Method of | P.I. |
| | | | | | | | P.I. | |
| 2 | 100 mol % | 42 mol % | 65 | −1 | 0.25 | 0.03 | Conversion | C.E. |
| 3 | 100 mol % | 42 mol % | 75 | −1 | 0.26 | 0.02 | Added | C.E. |
| | | | | | | | separately | |

P.I.: Present Invention
C.E.: Comparative Example

As is clear from Table 2, a photothermographic material having high sensitivity, less fog (low Dmin value) and extremely less print-out could be achieved according to the photothermographic material-1 in which previously prepared silver halide having the silver iodide content of 40 mol % or greater and 100 mol % or less, and the particle size of 5 to 80 nm was mixed in the step of preparing an organic silver salt, and the mixture was used as an organic silver salt dispersion containing silver halide.

### Example 2

(Preparation of Comparative Organic Silver Salt Redispersion-4)

(Preparation of Silver Halide Emulsion-2)

Silver halide emulsion-2 was prepared in a similar manner to preparation of the silver halide emulsion-1 described above through controlling the temperature for charging.

Emulsion 1: Silver iodide 100 mol %, AgI₁₀₀, particle size 40 nm

Emulsion 2: Silver iodide 100 mol %, AgI₁₀₀, particle size 100 nm

(Preparation of Fatty Silver-4)

Preparation of fatty silver-4 was performed in a completely similar manner to the process of preparing the fatty silver-1 as described above, except that use of 700 g of the silver halide emulsion-1 was changed to 1400 g of the silver halide emulsion-2.

(Preparation of Organic Silver Salt Redispersion-4)

Preparation of organic silver salt redispersion-4 was performed in a completely similar manner to the process of preparing the organic silver salt redispersion-1 as described above, except that silver salt of fatty acid-1 used in preparation of the organic silver salt redispersion-1 was changed to silver salt of fatty acid-4.

TABLE 3

| | | Fatty Acid | | | |
|---|---|---|---|---|---|
| Organic Silver | Silver Halide | Composition | Silver Halide | | |
| Salt | AgI Content | Behenic | Particle | Method for | |
| Redispersion | (mol %) | Acid (mol %) | Diameter (nm) | Preparation | Remarks |
| 1 | 100 | 42 | 40 | Method of P.I. | P.I. |
| 4 | 100 | 42 | 100 | Method of P.I. | C.E. |

Preparation of coating solution for image-forming layer-4 was performed in a similar manner to the process of preparing the solution for image-forming layer-1, except that use of the organic silver salt redispersion-1 was changed to the organic silver salt redispersion-4. Furthermore, production of the photothermographic material, light exposure, development and evaluation were carried out similarly to those in Example 1. The results are shown in Table 4.

TABLE 4

| | Silver | | | | | | | | |
|---|---|---|---|---|---|---|---|---|---|
| | Halide | Behenic | | | | | Print- | | |
| Sample | (AgI | Acid | Particle | Sensi- | Sensitizing | Fog | out | Method for | |
| No. | Content) | Content | Size (nm) | tivity | Dye | Dmin | ΔDmin | Preparation | Remarks |
| 1 | 100 mol % | 42 mol % | 40 | 100 | −1 | 0.19 | 0.00 | Method of | P.I. |
| | | | | | | | | P.I. | |
| 4 | 100 mol % | 42 mol % | 100 | 52 | −1 | 0.30 | 0.03 | Method of | C.E. |
| | | | | | | | | P.I. | |

P.I.: Present Invention
C.E.: Comparative Example

As is clear from Table 4, a photothermographic material having high sensitivity, less fog (low Dmin value) and extremely less print-out could be achieved through using a silver halide having the particle size of 5 to 80 nm, because a required addition amount of silver halide is reduced.

### Example 3

Photothermographic materials-5 through -15 were produced in a completely similar manner to the photothermographic material-1 in Examples 1, except that used compound represented by types 1 to 5 was altered as shown in Table 5. Furthermore, light exposure, development and evaluation of these materials were performed similarly to those in Example 1.

TABLE 5

| | Compound of | | | | | | |
|---|---|---|---|---|---|---|---|
| | Types 1-5 | | | | | | |
| | | Amount added | | | | | |
| | | (mole number | | | Print- | | |
| Sample | | per mol of | Sensi- | Fog | out | Method for | |
| No. | Kind | Silver Halide) | tivity | Dmin | ΔDmin | Preparation | Remarks |
| 1 | 24 | 5 × 10⁻³ | 100 | 0.19 | 0.00 | Method of | P.I. |
| | | | | | | P.I. | |
| 5 | None | — | 22 | 0.18 | 0.02 | Method of | P.I. |
| | | | | | | P.I. | |
| 6 | 6 | 5 × 10⁻³ | 95 | 0.20 | 0.00 | Method of | P.I. |
| | | | | | | P.I. | |
| 7 | 60 | 5 × 10⁻³ | 96 | 0.18 | 0.00 | Method of | P.I. |
| | | | | | | P.I. | |
| 8 | 61 | 5 × 10⁻³ | 99 | 0.20 | 0.00 | Method of | P.I. |
| | | | | | | P.I. | |
| 9 | G-1 | 5 × 10⁻³ | 94 | 0.19 | 0.00 | Method of | P.I. |
| | | | | | | P.I. | |
| 10 | 8 | 5 × 10⁻³ | 108 | 0.18 | 0.00 | Method of | P.I. |
| | | | | | | P.I. | |
| 11 | 34 | 5 × 10⁻³ | 106 | 0.19 | 0.00 | Method of | P.I. |
| | | | | | | P.I. | |
| 12 | 41 | 5 × 10⁻³ | 113 | 0.20 | 0.00 | Method of | P.I. |
| | | | | | | P.I. | |
| 13 | 8 | 2 × 10⁻³ | 113 | 0.18 | 0.00 | Method of | P.I. |
| | 34 | 2 × 10⁻³ | | | | P.I. | |
| | 41 | 2 × 10⁻³ | | | | | |
| 14 | 8 | 2 × 10⁻³ | 110 | 0.19 | 0.00 | Method of | P.I. |
| | 24 | 2 × 10⁻³ | | | | P.I. | |
| | G-1 | 2 × 10⁻³ | | | | | |
| 15 | 34 | 2 × 10⁻³ | 112 | 0.19 | 0.00 | Method of | P.I. |
| | 41 | 2 × 10⁻³ | | | | P.I. | |
| | G-1 | 2 × 10⁻³ | | | | | |

As is clear from Table 5, similar effects, i.e., high sensitivity, less fog (low Dmin value) and extremely less printing-out, could be achieved even though kinds of the compounds of types 1 to 5 were changed.

### Example 4

Photothermographic materials-16 through 17 were produced in a completely similar manner to the photothermographic material-1 in Examples 1, except that used development accelerator-1 was changed to the development accelerator shown in Table 4. Furthermore, light exposure, development and evaluation of these materials were performed similarly to those in Example 1.

TABLE 6

| | Develop- | | | | | |
|---|---|---|---|---|---|---|
| Sam- | ment | | | | | |
| ple | Accel- | Sensi- | Fog | Print-out | Method for | Re- |
| No. | erator | tivity | Dmin | ΔDmin | Preparation | marks |
| 1 | A-1 | 100 | 0.19 | 0 | Method of P.I. | P.I. |
| 16 | None | 52 | 0.18 | 0 | Method of P.I. | P.I. |
| 17 | A-8 | 95 | 0.20 | 0 | Method of P.I. | P.I. |

As is clear from Table 6, similar effects, i.e., high sensitivity, less fog (low Dmin value) and extremely less print-out, could be achieved even though kind of the development accelerator was changed. In particular, favorable effects could be achieved in the case of hydrazine-based or naphthol-based compounds.

### Example 5

Photothermographic materials-18 through 19 were produced in a completely similar manner to the photothermographic material-1 in Examples 1, except that used reducing agent-1 was changed to the reducing agent shown in Table 5. Furthermore, light exposure, development and evaluation of these materials were performed similarly to those in Example 1.

TABLE 7

| Sample | Reducing | Sensi- | Fog | Print-out | Method for | Re- |
|---|---|---|---|---|---|---|
| No. | Agent | tivity | Dmin | ΔDmin | Preparation | marks |
| 1 | I-2 | 100 | 0.19 | 0 | Method of | P.I. |
| | | | | | P.I. | |
| 18 | I-5 | 95 | 0.20 | 0 | Method of | P.I. |
| | | | | | P.I. | |
| 19 | I-6 | 98 | 0.19 | 0 | Method of | P.I. |
| | | | | | P.I. | |

As is clear from Table 7, similar effects, i.e., high sensitivity, less fog (low Dmin value) and extremely less print-out, could be achieved even though kind of the reducing agent was changed. In particular, favorable effects could be achieved when the compound represented by formula (H) was used.

### Example 6

Solutions for image-forming layer-20 through 22 were produced in a completely similar manner to the solutions for image-forming layer-1 through 3 in Examples 1, except that the sensitizing dye-1 was changed to the sensitizing dye-2. Moreover, coating, development and the like were performed in a similar manner to those in Example 1 using the solutions for image-forming layer-20 through -22 to produce photothermographic materials-20 through -22.

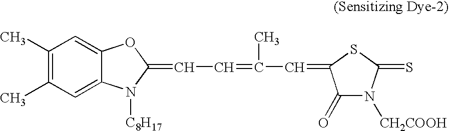

(Light Exposure, Development of Photosensitive Material)

Light exposure and thermal development (24 seconds in total with 4 panel heaters set to be 112° C.-119° C.-121° C.-121° C.) of the photothermographic materials-15 through 20 which were obtained as described above were performed with Fuji Medical Dry Laser Imager FM-DP L (equipped with 660 nm semiconductor laser having the maximum output of 60 mW (IIIB)).

(Evaluation of Photographic Performance)

Evaluations of performance were performed similarly to Example 1. The evaluation of the sensitivity herein was made with relative sensitivity (ΔS) of each sample on the basis of the value for the photothermographic material-2 which was assumed as 100. The results are shown in Table 8.

TABLE 8

| | | Behenic | | | | | | |
|---|---|---|---|---|---|---|---|---|
| Sample | Silver Halide | Acid | | Sensitizing | Fog | Print-out | Method for | |
| No. | (AgI Content) | Content | Sensitivity | Dye | Dmin | ΔDmin | Preparation | Remarks |
| 20 | 100 mol % | 42 mol % | 100 | −2 | 0.19 | 0.00 | Method of | P.I. |
| | | | | | | | P.I. | |
| 21 | 100 mol % | 42 mol % | 52 | −2 | 0.25 | 0.03 | Conversion | C.E. |
| 22 | 100 mol % | 42 mol % | 62 | −2 | 0.26 | 0.02 | Added | C.E. |
| | | | | | | | separately | |

As is clear from Table 8, a photothermographic material having high sensitivity, less fog (low Dmin value) and extremely less print-out could be achieved according to the photothermographic material-20 in which previously prepared silver halide having the silver iodide content of 40 mol % or greater and 100 mol % or less, and the particle size of 5 to 80 nm was mixed in the step of preparing an organic silver salt, and the mixture was used as an organic silver salt dispersion containing silver halide, similarly to Example 1, even though the sensitizing dye was changed to the sensitizing dye-2, which should be used for red color laser, followed by light exposure with red color laser.

### Example 7

Coating solutions for image-forming layer-23 through -25 were prepared in a completely similar manner to those in Example 1, except that preparation was conducted without adding the sensitizing dye-1 which was added in the preparation of the coating solutions for image-forming layer-1 through -3 in Example 1. Thereafter, similar processing was carried out to that in Example 1 except that 405 nm blue color laser light was used. Accordingly, results shown in Table 9 were obtained.

TABLE 9

| | | Behenic | | | | Print- | | |
|---|---|---|---|---|---|---|---|---|
| Sample | Silver Halide | Acid | | Sensitizing | Fog | out | Method for | |
| No. | (AgI Content) | Content | Sensitivity | dye | Dmin | ΔDmin | Preparation | Remarks |
| 23 | 100 mol % | 42 mol % | 100 | −1 | 0.19 | 0.00 | Method of | P.I. |
| | | | | | | | P.I. | |
| 24 | 100 mol % | 42 mol % | 65 | −1 | 0.25 | 0.03 | Conversion | C.E. |
| 25 | 100 mol % | 42 mol % | 75 | −1 | 0.26 | 0.02 | Added | C.E. |
| | | | | | | | separately | |

As is clear from Table 9, a photothermographic material having high sensitivity, less fog (low Dmin value) and extremely less print-out could be achieved according to the photothermographic material-23 in which previously prepared silver halide having the silver iodide content of 40 mol % or greater and 100 mol % or less, and the particle size of 5 to 80 nm was mixed in the step of preparing an organic silver salt, and the mixture was used as an organic silver salt dispersion containing silver halide, similarly to Example 1, even though the sensitizing dye was changed to the sensitizing dye-2, which should be used for blue color laser, followed by light exposure with blue color laser.

### Example 8

1) Redispersion of Organic Silver Salt into Organic Solvent

Upon redispersion of the organic silver salt into the organic solvent-1 through -3 in Example 1, slurry was dispersed using a media type dispersing machine packed with 80% of 1 mm Zr beads (manufactured by Toray Industries, Inc.) at a circumferential velocity of 13 m and residence time of 0.5 minute in the mill, instead of two-path dispersion with a GM-2 pressure type homogenizer manufactured by SMT Limited. Accordingly, an organic silver salt dispersion containing a photosensitive silver halide was obtained.

2) Preparation of Coating Solutions for Image-Forming Layer-26 through 28

To 500 g of the aforementioned organic solver salt dispersion containing the photosensitive silver halide was added 100 g of MEK while stirring under a nitrogen gas stream, and incubated at 24° C. A 10% methanol solution of the antifoggant-1 as described below in an amount of 2.5 mL was added thereto followed by stirring for 15 minutes. Thereto was added 1.8 mL of a solution including 20% by weight of the pigment adsorption aid described below with a mixing ratio by weight of 1:5 for the pigment adsorption aid and potassium acetate, followed by stirring for 15 minutes. Next, the sensitizing dye-3 was added thereto in an amount of 1×10⁻³ mol per mol of silver halide, followed by addition of: 4-chloro-2-benzoylbenzoic acid in an amount of 250 times by weight of the sensitizing dye-3; 5-methyl-2-mercaptobenzimidazole, a super-sensitizer, in an amount of 20 times by weight of the sensitizing dye-3; the polyhalogen compound-2 (aforementioned specific example, compound H-1) in an amount of 0.03 mol per mol of the coated amount of silver; the compound of types 1 to 5 in an amount of 5×10⁻³ mol per mol of silver halide; the hydrogen bond-forming compound-1 in an equimolar amount to the reducing agent-2; and the development accelerators-1 and -2, each in an amount of 5×10⁻³ mol per mol of silver in the fatty silver. After stirring the mixture for 1 hour, the temperature thereof was lowered to 13° C. followed by stirring for additional 30 minutes. While keeping the temperature of 13° C., 48 g of polyvinyl butyral was added thereto. Following sufficient dissolution, additives as described below were added.

All of these operations were performed under a nitrogen gas stream.

| | | |
|---|---|---|
| Phthalazine | 1.5 | g |
| Tetrachlorophthalic acid | 0.5 | g |
| 4-Methylphthalic acid | 0.5 | g |
| Dye-2 | 2.0 | g |
| Reducing agent-2 (above specific Example, compound I-1) | 15 | g |
| Desmodur N3300 (Mobay Inc., aliphatic isocyanate) | 1.10 | g |
| Antifoggant-2 | 0.9 | g |

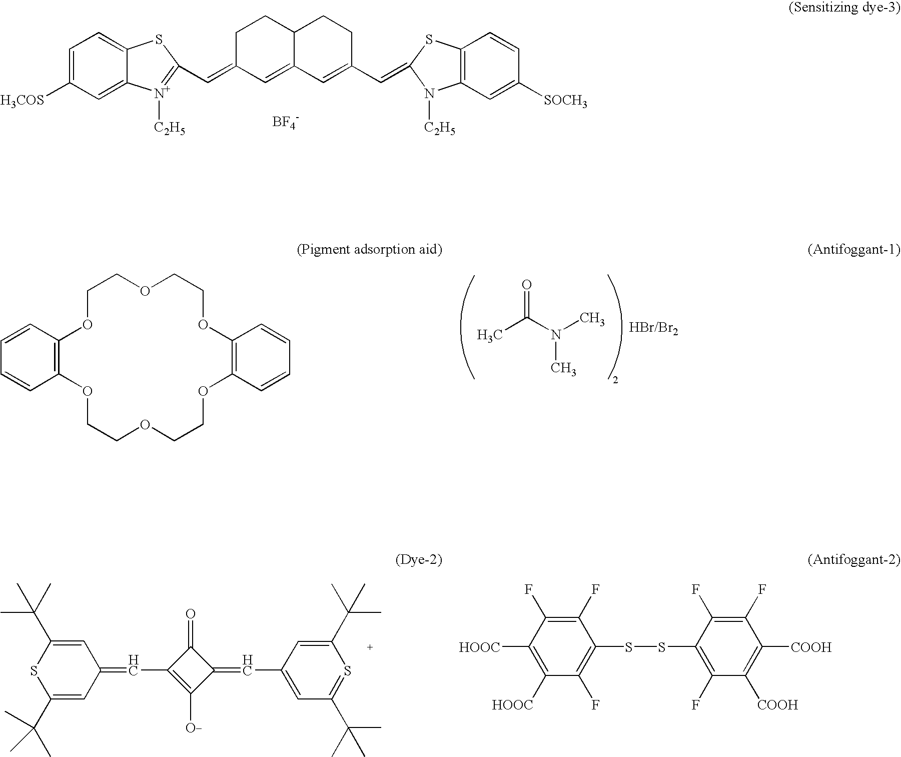

Other process for producing the photothermographic material was carried out similarly to Example 1, followed by light exposure and development. Similar methods of evaluation were thereafter performed. Accordingly, the results shown in Table 10 were obtained. The evaluation of the sensitivity herein was made with relative sensitivity (ΔS) of each sample on the basis of the value for the photothermographic material-26 which was assumed as 100.

TABLE 10

| | | Behenic | | | | | | |
|---|---|---|---|---|---|---|---|---|
| Sample | Silver Halide | Acid | | Sensitizing | Fog | Print-out | Method for | |
| No. | (AgI Content) | Content | Sensitivity | Dye | Dmin | ΔDmin | Preparation | Remarks |
| 26 | 100 mol % | 42 mol % | 100 | −3 | 0.22 | 0.00 | Method of P.I. | P.I. |
| 27 | 100 mol % | 42 mol % | 55 | −3 | 0.30 | 0.04 | Conversion | C.E. |
| 28 | 100 mol % | 42 mol % | 65 | −3 | 0.31 | 0.03 | Added | C.E. |
| | | | | | | | separately | |

Similarly to Example 1, a photothermographic material having high sensitivity, less fog (low Dmin value) and extremely less print-out could be achieved according to the photothermographic material-26 in which previously prepared silver halide having the silver iodide content of 40 mol % or greater and 100 mol % or less, and the particle size of 5 to 80 nm was mixed in the step of preparing an organic silver salt, and the mixture was used as an organic silver salt dispersion containing silver halide.

As detailed above, the present invention can provide the photothermographic materials which has high sensitivity, and is excellent in print-out property, with less fog at non-image areas.

What is claimed is:

1. A photothermographic material comprising a photosensitive silver halide, a reducing agent for reducing silver ions, a binder and a non-photosensitive organic silver salt, wherein the photosensitive silver halide has a silver iodide content ranging from 40 mol % to 100 mol %, and has a particle size ranging from 5 nm to 80 nm, and wherein the non-photosensitive organic silver salt is prepared in the presence of the photosensitive silver halide which has been preformed, such that the non-photosensitive organic silver salt includes the photosensitive silver halide.

2. The photothermographic material according to claim 1, wherein the non-photosensitive organic silver salt including the photosensitive silver halide is produced by adding an alkali metal salt to an organic acid to prepare an alkali metal soap of at least a part of the organic acid, mixing the prepared alkali metal soap with the photosensitive silver halide, and thereafter admixing therewith a water-soluble silver salt.

3. The photothermographic material according to claim 1, wherein the non-photosensitive organic silver salt has a silver behenate content ranging from 40 mol % to 70 mol %.

4. The photothermographic material according to claim 2, wherein the non-photosensitive organic silver salt has a silver behenate content ranging from 40 mol % to 70 mol %.

5. The photothermographic material according to claim 1, wherein the binder is polyvinyl butyral.

6. The photothermographic material according to claim 1, wherein methyl ethyl ketone is used as a solvent for a coating solution, and a residual amount of the methyl ethyl ketone ranges from 0.1 mg/m² to 150 mg/M².

7. The photothermographic material according to claim 1, wherein the photosensitive silver halide has a particle size ranging from 5 nm to 50 nm.

8. The photothermographic material according to claim 1, further comprising a compound selected from compounds of the following types 1 to 5:
(Type 1)
a compound that can be one-electron oxidized to produce a one-electron oxidation product, which releases two or more electrons through a bond cleaving reaction;
(Type 2)
a compound that has two or more adsorptive groups to the silver halide in the same molecular structure and can be one-electron oxidized to produce a one-electron oxidation product which further releases one electron through a bond cleaving reaction;
(Type 3)
a compound that can be one-electron oxidized to produce a one-electron oxidation product, which releases additional one or more electrons after a bond forming process;
(Type 4)
a compound that can be one-electron oxidized to produce a one-electron oxidation product, which releases additional one or more electrons after an intra-molecular ring opening reaction; and
(Type 5)
a compound represented by X-Y, in which X represents a reducing group and Y represents a leaving group, wherein the reducing group X can be one-electron oxidized to produce a one-electron oxidation product, which leaves Y to produce X radical through an X-Y bond cleaving reaction, followed by releasing one more electrons from the X radical.

9. The photothermographic material according to claim 2, further comprising a compound selected from compounds of the following types 1 to 5:
(Type 1)
a compound that can be one-electron oxidized to produce a one-electron oxidation product, which releases two or more electrons through a bond cleaving reaction;
(Type 2)
a compound that has two or more adsorptive groups to the silver halide in the same molecular structure and can be one-electron oxidized to produce a one-electron oxidation product which further releases one electron through a bond cleaving reaction;
(Type 3)
a compound that can be one-electron oxidized to produce a one-electron oxidation product, which releases additional one or more electrons after a bond forming process;
(Type 4)
a compound that can be one-electron oxidized to produce a one-electron oxidation product, which releases additional one or more electrons after an intra-molecular ring opening reaction; and
(Type 5)
a compound represented by X-Y, in which X represents a reducing group and Y represents a leaving group, wherein the reducing group X can be one-electron oxidized to produce a one-electron oxidation product, which leaves Y to produce X radical through an X-Y bond cleaving reaction, followed by releasing one more electrons from the X radical.

10. The photothermographic material according to claim 1, further comprising a compound represented by formula (H):
Q-(Y)n-C(Z₁)(Z₂)X Formula (H)
wherein Q represents an alkyl group, an aryl group or a heterocyclic group; Y represents a bivalent linking group; n represents 0 or 1; Z₁ and Z₂ represent a halogen atom; and X represents a hydrogen atom or an electron attractive group.

11. The photothermographic material according to claim 2, further contaaining a compound represented by formula (H):
Q-(Y)n-C(Z₁)(Z₂)X Formula (H)
wherein Q represents an alkyl group, an aryl group or a heterocyclic group; Y represents a bivalent linking group; n represents 0 or 1; Z₁ and Z₂ represent a halogen atom; and X represents a hydrogen atom or an electron attractive group.

12. The photothermographic material according to claim 1, wherein the reducing agent is a bisphenol-type reducing agent.

13. The photothermographic material according to claim 1, further comprising a compound represented by formula (J): 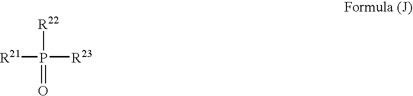
wherein R²¹ to R²³ each independently represent an alkyl group, an aryl group, an alkoxy group, an aryloxy group, an amino group or a heterocyclic group.

14. The photothermographic material according to claim 2, further comprising a compound represented by formula (J): 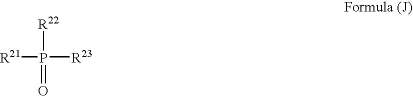
wherein R²¹ to R²³ each independently represent an alkyl group, an aryl group, an alkoxy group, an aryloxy group, an amino group or a heterocyclic group.

15. The photothermographic material according to claim 1, further comprising a development accelerator.

16. The photothermographic material according to claim 2, further comprising a development accelerator.

17. The photothermographic material according to claim 15, wherein the development accelerator is a hydrazine-based or naphthol-based compound.

18. The photothermographic material according to claim 1, wherein the photosensitive silver halide has a silver iodide content ranging from 80 mol % to 100 mol %.

19. The photothermographic material according to claim 1, wherein the photosensitive silver halide has a silver iodide content ranging from 85 mol % to 100 mol %.

20. The photothermographic material according to claim 1, wherein the photosensitive silver halide has a silver iodide content ranging from 90 mol % to 100 mol %.
